(19) United States
(12) Patent Application Publication
(10) Pub. No.: US 2016/0327717 A1
(43) Pub. Date: Nov. 10, 2016

(54) LIGHT-EMITTING APPARATUS INCLUDING PHOTOLUMINESCENT LAYER

(71) Applicant: Panasonic Intellectual Property Management Co., Ltd., Osaka (JP)

(72) Inventors: AKIRA HASHIYA, Osaka (JP); TAKU HIRASAWA, Kyoto (JP); YASUHISA INADA, Osaka (JP); YOSHITAKA NAKAMURA, Osaka (JP); MITSURU NITTA, Kyoto (JP); TAKEYUKI YAMAKI, Nara (JP); MASAHIRO NAKAMURA, Osaka (JP)

(21) Appl. No.: 15/215,599

(22) Filed: Jul. 21, 2016

Related U.S. Application Data
(63) Continuation of application No. PCT/JP2015/000814, filed on Feb. 20, 2015.

(30) Foreign Application Priority Data
Feb. 28, 2014 (JP) 2014-037992
Jul. 29, 2014 (JP) 2014-154138

(51) Int. Cl. F21V 8/00

(52) U.S. Cl. CPC G02B 6/0003; G02B 6/0038; G02B 6/0025; G02B 6/0055; G02B 6/0056

(57) ABSTRACT

A light-emitting device includes a photoluminescent layer emitting light in response to excitation light, a light-transmissive layer located on the photoluminescent layer, and a light guide guiding the excitation light to the photoluminescent layer. At least one of the photoluminescent layer and the light-transmissive layer has a submicron structure having at least projections or recesses arranged perpendicular to the thickness direction of the photoluminescent layer. The light emitted from the photoluminescent layer includes first light having a wavelength λₐ in air. The distance Dᵢₙₜ between adjacent projections or recesses and the refractive index n_{wav-a} of the photoluminescent layer for the first light satisfy λₐ/n_{wav-a}<Dᵢₙₜ<λₐ. A thickness of the photoluminescent layer, the refractive index n_{wav-a}, and the distance Dᵢₙₜ are set to limit a directional angle of the first light emitted from the light emitting surface.

### BACKGROUND

1. Technical Field

The present disclosure relates to a light-emitting apparatus including a photoluminescent layer.

2. Description of the Related Art

Optical devices, such as lighting fixtures, displays, and projectors, that output light in the necessary direction are required for many applications. Photoluminescent materials, such as those used for fluorescent lamps and white light-emitting diodes (LEDs), emit light in all directions. Thus, those materials are used in combination with optical elements such as reflectors and lenses to output light only in a particular direction. For example, Japanese Unexamined Patent Application Publication No. 2010-231941 discloses an illumination system including a light distributor and an auxiliary reflector to provide sufficient directionality.

### SUMMARY

In one general aspect, the techniques disclosed here feature a light-emitting apparatus that includes: a photoluminescent layer that has a first surface perpendicular to a thickness direction thereof and emits light in response to excitation light; a light-transmissive layer located on the photoluminescent layer; and a light guide guiding the excitation light to the photoluminescent layer. An area of the first surface is larger than a sectional area of the photoluminescent layer perpendicular to the first surface. At least one of the photoluminescent layer and the light-transmissive layer has a submicron structure having at least projections or recesses arranged perpendicular to the thickness direction of the photoluminescent layer. The light emitted from the photoluminescent layer includes first light having a wavelength λₐ in air. At least one of the photoluminescent layer and the light-transmissive layer has a light emitting surface perpendicular to the thickness direction of the photoluminescent layer, the first light being emitted from the light emitting surface. A distance Dᵢₙₜ between adjacent projections or recesses and a refractive index n_{wav-a} of the photoluminescent layer for the first light satisfy λₐ/n_{wav-a}<Dᵢₙₜ<λₐ. A thickness of the photoluminescent layer, the refractive index n_{wav-a}, and the distance Dᵢₙₜ are set to limit a directional angle of the first light emitted from the light emitting surface.

It should be noted that general or specific embodiments may be implemented as a device, an apparatus, a system, a method, or any elective combination thereof.

### BRIEF DESCRIPTION OF THE DRAWINGS

FIG. 1A is a perspective view of the structure of a light-emitting device according to an embodiment;

FIG. 1B is a fragmentary cross-sectional view of the light-emitting device illustrated in FIG. 1A;

FIG. 1C is a perspective view of the structure of a light-emitting device according to another embodiment;

FIG. 1D is a fragmentary cross-sectional view of the light-emitting device illustrated in FIG. 1C;

FIG. 2 is a graph showing the calculation results of the enhancement of light output in the front direction with varying emission wavelengths and varying a period of a periodic structure;

FIG. 3 is a graph illustrating the conditions for m=1 and m=3 in the inequality (10);

FIG. 4 is a graph showing the calculation results of the enhancement of light output in the front direction with varying emission wavelengths and varying thicknesses t of a photoluminescent layer;

FIG. 5A is a graph showing the calculation results of the electric field distribution of a mode to guide light in the x direction for a thickness t of 238 nm;

FIG. 5B is a graph showing the calculation results of the electric field distribution of a mode to guide light in the x direction for a thickness t of 539 nm;

FIG. 5C is a graph showing the calculation results of the electric field distribution of a mode to guide light in the x direction for a thickness t of 300 nm;

FIG. 6 is a graph showing the calculation results of the enhancement of light performed under the same conditions as in FIG. 2 except that the polarization of the light was assumed to be the TE mode, which has an electric field component perpendicular to the y direction;

FIG. 7A is a plan view of a two-dimensional periodic structure;

FIG. 7B is a graph showing the results of calculations performed as in FIG. 2 for the two-dimensional periodic structure;

FIG. 8 is a graph showing the calculation results of the enhancement of light output in the front direction with varying emission wavelengths and varying refractive indices of the periodic structure;

FIG. 9 is a graph showing the results obtained under the same conditions as in FIG. 8 except that the photoluminescent layer was assumed to have a thickness of 1,000 nm;

FIG. 10 is a graph showing the calculation results of the enhancement of light output in the front direction with varying emission wavelengths and varying heights of the periodic structure;

FIG. 11 is a graph showing the results of calculations performed under the same conditions as in FIG. 10 except that the periodic structure was assumed to have a refractive index nₚ of 2.0;

FIG. 12 is a graph showing the results of calculations performed under the same conditions as in FIG. 9 except that the polarization of the light was assumed to be the TE mode; which has an electric field component perpendicular to the y direction;

FIG. 13 is a graph showing the results of calculations performed under the same conditions as in FIG. 9 except that the photoluminescent layer was assumed to have a refractive index n_{wav} of 1.5;

FIG. 14 is a graph showing the results of calculations performed under the same conditions as in FIG. 2 except that the photoluminescent layer and the periodic structure were assumed to be located on a transparent substrate having a refractive index of 1.5;

FIG. 15 is a graph illustrating the condition represented by the inequality (15);

FIG. 16 is a schematic view of a light-emitting apparatus including a light-emitting device illustrated in FIGS. 1A and 1B and a light source that directs excitation light into a photoluminescent layer;

FIGS. 17A to 17D illustrate structures in which excitation light is coupled into a quasi-guided mode to efficiently output light: FIG. 17A illustrates a one-dimensional periodic structure having a period pₓ in the x direction, FIG. 17B illustrates a two-dimensional periodic structure having a period pₓ in the x direction and a period p_{y} in the y direction, FIG. 17C shows the wavelength dependence of light absorptivity in the structure in FIG. 17A, and FIG. 17D shows the wavelength dependence of light absorptivity in the structure in FIG. 17B;

FIG. 18A is a schematic view of a two-dimensional periodic structure;

FIG. 18B is a schematic view of another two-dimensional periodic structure;

FIG. 19A is a schematic view of a modified example in which the periodic structure is formed on the transparent substrate;

FIG. 19B is a schematic view of another modified example in which the periodic structure is formed on the transparent substrate;

FIG. 19C is a graph showing the calculation results of the enhancement of light output from the structure in FIG. 19A in the front direction with varying emission wavelengths and varying periods of the periodic structure;

FIG. 20 is a schematic view of a mixture of light-emitting devices in powder form;

FIG. 21 is a plan view of a two-dimensional array of periodic structures having different periods on the photoluminescent layer;

FIG. 22 is a schematic view of a light-emitting device including photoluminescent layers each having a textured surface;

FIG. 23 is a cross-sectional view of a structure including a protective layer between a photoluminescent layer and a periodic structure;

FIG. 24 is a cross-sectional view of a structure including a periodic structure formed by processing only a portion of a photoluminescent layer;

FIG. 25 is a cross-sectional transmission electron microscopy (TEM) image of a photoluminescent layer formed on a glass substrate having a periodic structure;

FIG. 26 is a graph showing the results of measurements of the spectrum of light output from a sample light-emitting device in the front direction;

FIG. 27A is a schematic view of a light-emitting device that can emit linearly polarized light of the TM mode, rotated about an axis parallel to the line direction of the one-dimensional periodic structure;

FIG. 27B is a graph showing the results of measurements of the angular dependence of light output from the sample light-emitting device rotated as illustrated in FIG. 27A;

FIG. 27C is a graph showing the results of calculations of the angular dependence of light output from the sample light-emitting device rotated as illustrated in FIG. 27A;

FIG. 27D is a schematic view of a light-emitting device that can emit linearly polarized light of the TE mode, rotated about an axis parallel to the line direction of the one-dimensional periodic structure;

FIG. 27E is a graph showing the results of measurements of the angular dependence of light output from the sample light-emitting device rotated as illustrated in FIG. 27D;

FIG. 27F is a graph showing the results of calculations of the angular dependence of light output from the sample light-emitting device rotated as illustrated in FIG. 270;

FIG. 28A is a schematic view of a light-emitting device that can emit linearly polarized light of the TE mode, rotated about an axis perpendicular to the line direction of the one-dimensional periodic structure;

FIG. 28B is a graph showing the results of measurements of the angular dependence of light output from the sample light-emitting device rotated as illustrated in FIG. 28A;

FIG. 28C is a graph showing the results of calculations of the angular dependence of light output from the sample light-emitting device rotated as illustrated in FIG. 28A;

FIG. 28D is a schematic view of a light-emitting device that can emit linearly polarized light of the TM mode, rotated about an axis perpendicular to the line direction of the one-dimensional periodic structure;

FIG. 28E is a graph showing the results of measurements of the angular dependence of light output from the sample light-emitting device rotated as illustrated in FIG. 28D;

FIG. 28F is a graph showing the results of calculations of the angular dependence of light output from the sample light-emitting device rotated as illustrated in FIG. 28D;

FIG. 29 is a graph showing the results of measurements of the angular dependence of light (wavelength: 610 nm) output from the sample light-emitting device;

FIG. 30 is a schematic perspective view of a slab waveguide;

FIG. 31 is a schematic fragmentary cross-sectional view of a light-emitting apparatus according to a first embodiment that has improved absorption efficiency of excitation light;

FIG. 32 is a schematic perspective view of a portion of the light-emitting apparatus according to the first embodiment that has improved absorption efficiency of excitation light;

FIG. 33 is an explanatory view of the conditions for confinement of excitation light by total reflection;

FIG. 34 is a schematic fragmentary cross-sectional view of another example of a light guide;

FIG. 35 is a schematic fragmentary cross-sectional view of still another example of the light guide;

FIG. 36 is a schematic fragmentary cross-sectional view of still another example of the light guide;

FIG. 37 is a schematic fragmentary cross-sectional view of still another example of the light guide;

FIG. 38 is a schematic fragmentary cross-sectional view of still another example of the light guide;

FIG. 39 is a perspective view of an example of the light guide composed of light-transmissive members;

FIG. 40 is a perspective view of another example of the light guide composed of light-transmissive members;

FIG. 41 is a perspective view of still another example of the light guide composed of light-transmissive members;

FIG. 42 is an explanatory view of a first example of the position of the light guide;

FIG. 43 is an explanatory view of a second example of the position of the light guide;

FIG. 44 is an explanatory view of a third example of the position of the light guide;

FIG. 45 is a schematic fragmentary cross-sectional view of a light-emitting apparatus according to a second embodiment that includes the light guide;

FIG. 46 is an explanatory view of the incident angle of excitation light;

FIG. 47 is a detailed explanatory view of the output direction of excitation light from a light source;

FIG. 48 is a schematic cross-sectional view illustrating light from a photoluminescent layer coupled into a quasi-guided mode and output;

FIG. 49 is a schematic cross-sectional view of a portion of a light-emitting apparatus according to a third embodiment that has improved absorption efficiency of excitation light;

FIG. 50A is a schematic view of a light-emitting device that can emit linearly polarized light of the TM mode, rotated about an axis parallel to the line direction of the one-dimensional periodic structure;

FIG. 50B is a fragmentary cross-sectional view of a light-emitting device used for calculation;

FIG. 51 is a graph of the wavelength and angular dependence of the absorptivity of incident light;

FIG. 52 is a schematic vie of a light-emitting apparatus that includes an optical fiber as a light guide;

FIG. 53A is a schematic view of a light-emitting device that can emit linearly polarized light of the TM mode, rotated about an axis perpendicular to the line direction of the one-dimensional periodic structure;

FIG. 53B is a schematic view of a structure for improving absorption efficiency by setting the incident angle on a photoluminescent layer in such a manner as to cause resonance absorption while excitation light is confined in a transparent substrate;

FIG. 54A is a schematic view of a light-emitting device that can emit linearly polarized light of the TE mode, rotated about an axis parallel to the line direction of the one-dimensional periodic structure;

FIG. 54B is a schematic cross-sectional view of a structure in which the incident angle θ is the rotation angle of a periodic structure rotated about an axis parallel to the line direction of the periodic structure;

FIG. 55 is a graph of the calculation results with respect to the dependence of the absorptivity of excitation light on the incident angle θ and wavelength λ in air in the structure illustrated in FIG. 54B;

FIG. 56 is a graph of the wavelength and angular dependence of the absorptivity of incident light in the structure illustrated in FIG. 53B;

FIG. 57 is a schematic view of a light-emitting apparatus that includes a light guide extending in the direction perpendicular to the line direction of a periodic structure;

FIG. 58 is a cross-sectional view of a light-emitting device including a photoluminescent layer from which directional light is emitted in opposite directions by the effect of a periodic structure;

FIG. 59 is a cross-sectional view of a light-emitting device that includes a photoluminescent layer and a reflective layer;

FIG. 60 is a cross-sectional view of a projection of the reflective layer on the back side of the photoluminescent layer in which light is totally reflected;

FIGS. 61A to 61D are cross-sectional views of light-emitting apparatuses including different reflective layers according to various embodiments;

FIGS. 62A to 62C are schematic views illustrating the angle of light beams having different wavelengths emitted from a light-emitting device, FIG. 62A is a cross-sectional view illustrating light beams having different wavelengths emitted in different directions, and FIGS. 62B and 62C are cross-sectional views illustrating that light beams having different wavelengths are emitted in the same direction due to a reflective layer on the back side of the light-emitting device;

FIG. 63 is a cross-sectional view of a light-emitting apparatus that includes a reflective layer according to another embodiment; and

FIGS. 64A and 64B are schematic views of tiled light-emitting devices, FIG. 64A is a plan view, and FIG. 64B is a cross-sectional view.

### DETAILED DESCRIPTION

Optical devices including optical elements such as reflectors and lenses need to be larger to ensure sufficient space for these optical elements. Accordingly, it is desirable to eliminate or reduce the size of these optical elements.

The present disclosure includes the following light-emitting devices and light-emitting apparatuses:

[Item 1] A light-emitting device including

a photoluminescent layer,

a light-transmissive layer located on or near the photoluminescent layer, and

a submicron structure that is formed on at least one of the photoluminescent layer and the light-transmissive layer and that extends in a plane of the photoluminescent layer or the light-transmissive layer,

wherein the submicron structure has projections or recesses,

light emitted from the photoluminescent layer includes first light having a wavelength λₐ in air, and

the distance Dᵢₙₜ between adjacent projections or recesses and the refractive index n_{wav-a} of the photoluminescent layer for the first light satisfy λₐ/n_{wav-a}<Dᵢₙₜ<λₐ.

[Item 2] The light-emitting device according to Item 1, wherein the submicron structure includes at least one periodic structure having at least the projections or recesses, and the at least one periodic structure includes a first periodic structure having a period pₐ that satisfies λₐ/n_{wav-a}<pₐ<λₐ.
[Item 3] The light-emitting device according to Item 1 or 2, wherein the refractive index nₜ₋ₐ of the light-transmissive layer for the first light is lower than the refractive index n_{wav-a} of the photoluminescent layer for the first light.
[Item 4] The light-emitting device according to any one of Items 1 to 3, wherein the first light has the maximum intensity in a first direction determined in advance by the submicron structure.
[Item 5] The light-emitting device according to Item 4, wherein the first direction is normal to the photoluminescent layer.
[Item 6] The light-emitting device according to Item 4 or 5, wherein the first light emitted in the first direction is linearly polarized light.
[Item 7] The light-emitting device according to any one of Items 4 to 6, wherein the directional angle of the first light with respect to the first direction is less than 15 degrees.
[Item 8] The light-emitting device according to any one of Items 4 to 7, wherein second light having a wavelength λ_{b} different from the wavelength λₐ of the first light has the maximum intensity in a second direction different from the first direction.
[Item 9] The light-emitting device according to any one of Items 1 to 8, wherein the light-transmissive layer has the submicron structure.
[Item 10] The light-emitting device according to any one of Items 1 to 9, wherein the photoluminescent layer has the submicron structure.
[Item 11] The light-emitting device according to any one of Items 1 to 8, wherein

the photoluminescent layer has a flat main surface, and

the light-transmissive layer is located on the flat main surface of the photoluminescent layer and has the submicron structure.

[Item 12] The light-emitting device according to Item 11, wherein the photoluminescent layer is supported by a transparent substrate.
[Item 13] The light-emitting device according to any one of Items 1 to 8, wherein

the light-transmissive layer is a transparent substrate having the submicron structure on a main surface thereof, and

the photoluminescent layer is located on the submicron structure.

[Item 14] The light-emitting device according to Item 1 or 2, wherein the refractive index nₜ₋ₐ of the light-transmissive layer for the first light is higher than or equal to the refractive index n_{wav-a} of the photoluminescent layer for the first light, and each of the projections or recesses in the submicron structure has a height or depth of 150 nm or less.
[Item 15] The light-emitting device according to any one of Items 1 and 3 to 14, wherein

the submicron structure includes at least one periodic structure having at least the projections or recesses, and the at least one periodic structure includes a first periodic structure having a period pₐ that satisfies λₐ/n_{wav-a}<pₐ<λₐ, and

the first periodic structure is a one-dimensional periodic structure.

[Item 16] The light-emitting device according to Item 15, wherein

light emitted from the photoluminescent layer includes second light having a wavelength λ_{b} different from the wavelength λₐ in air,

the at least one periodic structure further includes a second periodic structure having a period p_{b} that satisfies λ_{b}/n_{wav-a}<p_{b}<λ_{b}, wherein n_{wav-b} denotes a refractive index of the photoluminescent layer for the second light, and

the second periodic structure is a one-dimensional periodic structure.

[Item 17] The light-emitting device according to any one of Items 1 and 3 to 14, wherein the submicron structure includes at least two periodic structures having at least the projections or recesses, and the at least two periodic structures include a two-dimensional periodic structure having periodicity in different directions.
[Item 18] The light-emitting device according to any one of Items 1 and 3 to 14, wherein

the submicron structure includes periodic structures having at least the projections or recesses, and

the periodic structures include periodic structures arranged in a matrix.

[Item 19] The light-emitting device according to any one of Items 1 and 3 to 14, wherein

the submicron structure includes periodic structures having at least the projections or recesses, and

the periodic structures include a periodic structure having a period pₑₓ that satisfies λₑₓ/n_{wav-ex}<pₑₓ<λₑₓ, wherein λₑₓ denotes the wavelength of excitation light in air for a photoluminescent material contained in the photoluminescent layer, and n_{wav-ex} denotes the refractive index of the photoluminescent layer for the excitation light.

[Item 20] A light-emitting device including

photoluminescent layers and light-transmissive layers,

wherein at least two of the photoluminescent layers are independently the photoluminescent layer according to any one of Items 1 to 19, and at least two of the light-transmissive layers are independently the light-transmissive layer according to any one of Items 1 to 19.

[Item 21] The light-emitting device according to Item 20, wherein the photoluminescent layers and the light-transmissive layers are stacked on top of each other.
[Item 22] A light-emitting device including

a photoluminescent layer,

a light-transmissive layer located on or near the photoluminescent layer, and

a submicron structure that is formed on at least one of the photoluminescent layer and the light-transmissive layer and that extends in a plane of the photoluminescent layer or the light-transmissive layer,

wherein light for forming a quasi-guided mode in the photoluminescent layer and the light-transmissive layer is emitted.

[Item 23] Alight-emitting device including

a waveguide layer capable of guiding light, and

a periodic structure located on or near the waveguide layer,

wherein the waveguide layer contains a photoluminescent material, and

the waveguide layer includes a quasi-guided mode in which light from the photoluminescent material is guided while interacting with the periodic structure.

[Item 24] Alight-emitting device including

a photoluminescent layer,

a light-transmissive layer located on or near the photoluminescent layer, and

a submicron structure that is formed on at least one of the photoluminescent layer and the light-transmissive layer and that extends in a plane of the photoluminescent layer or the light-transmissive layer,

wherein the submicron structure has projections or recesses, and

the distance Dᵢₙₜ between adjacent projections or recesses, the wavelength λₑₓ of excitation light in air for a photoluminescent material contained in the photoluminescent layer, and the refractive index n_{wav-ex} of a medium having the highest refractive index for the excitation light out of media present in an optical path to the photoluminescent layer or the light-transmissive layer satisfy λₑₓ/n_{wav-ex}<Dᵢₙₜ<λₑₓ.

[Item 25] The light-emitting device according to Item 24, wherein the submicron structure includes at least one periodic structure having at least the projections or recesses, and the at least one periodic structure includes a first periodic structure having a period pₑₓ that satisfies λₑₓ/n_{wav-ex}<pₑₓ<λₑₓ.
[Item 26] A light-emitting device including

a light-transmissive layer,

a submicron structure that is formed in the light-transmissive layer and extends in a plane of the light-transmissive layer, and

a photoluminescent layer located on or near the submicron structure,

wherein the submicron structure has projections or recesses,

light emitted from the photoluminescent layer includes first light having a wavelength λₐ in air,

the submicron structure includes at least one periodic structure having at least the projections or recesses, and

the refractive index n_{wav-a} of the photoluminescent layer for the first light and the period pₐ of the at least one periodic structure satisfy λₐ/n_{wav-a}<pₐ<λₐ.

[Item 27] A light-emitting device including

a photoluminescent layer,

a light-transmissive layer having a higher refractive index than the photoluminescent layer, and

a submicron structure that is formed in the light-transmissive layer and extends in a plane of the light-transmissive layer,

wherein the submicron structure has projections or recesses,

light emitted from the photoluminescent layer includes first light having a wavelength λₐ in air,

the submicron structure includes at least one periodic structure having at least the projections or recesses, and

the refractive index n_{wav-a} of the photoluminescent layer for the first light and the period pₐ of the at least one periodic structure satisfy λₐ/n_{wav-a}<pₐ<λₐ.

[Item 28] A light-emitting device including

a photoluminescent layer, and

a submicron structure that is formed in the photoluminescent layer and extends in a plane of the photoluminescent layer,

wherein the submicron structure has projections or recesses,

light emitted from the photoluminescent layer includes first light having a wavelength λₐ in air,

the submicron structure includes at least one periodic structure having at least the projections or recesses, and

the refractive index n_{wav-a} of the photoluminescent layer for the first light and the period pₐ of the at least one periodic structure satisfy λₐ/n_{wav-a}<pₐ<λₐ.

[Item 29] The light-emitting device according to any one of Items 1 to 21 and 24 to 28, wherein the submicron structure has both the projections and the recesses.
[Item 30] The light-emitting device according to any one of Items 1 to 22 and 24 to 27, wherein the photoluminescent layer is in contact with the light-transmissive layer.
[Item 31] The light-emitting device according to Item 23, wherein the waveguide layer is in contact with the periodic structure.
[Item 32] A light-emitting apparatus including

the light-emitting device according to any one of Items 1 to 31, and

an excitation light source for irradiating the photoluminescent layer with excitation light.

[Item 33] A light-emitting apparatus including:

a photoluminescent layer that has a first surface perpendicular to a thickness direction thereof and emits light in response to excitation light, an area of the first surface being larger than a sectional area of the photoluminescent layer perpendicular to the first surface;

a light-transmissive layer located on the photoluminescent layer; and

a light guide guiding the excitation light to the photoluminescent layer, wherein

at least one of the photoluminescent layer and the light-transmissive layer has a submicron structure having at least projections or recesses arranged perpendicular to the thickness direction of the photoluminescent layer,

the light emitted from the photoluminescent layer includes first light having a wavelength λₐ in air,

at least one of the photoluminescent layer and the light-transmissive layer has a light emitting surface perpendicular to the thickness direction of the photoluminescent layer, the first light being emitted from the light emitting surface,

a distance Dᵢₙₜ between adjacent projections or recesses and a refractive index n_{wav-a} of the photoluminescent layer for the first light satisfy λₐ/n_{wav-a}<Dᵢₙₜ<λₐ, and

a thickness of the photoluminescent layer, the refractive index n_{wav-a}, and the distance Dᵢₙₜ are set to limit a directional angle of the first light emitted from the light emitting surface.
[Item 34] The light-emitting apparatus according to Item 33, wherein the light guide is located on a surface of the photoluminescent layer on which the submicron structure is located.
[Item 35] The light-emitting apparatus according to Item 33, wherein the light guide is located on a surface of the photoluminescent layer opposite the submicron structure.
[Item 36] The light-emitting apparatus according to Item 34 or 35, further including

a light source for emitting the excitation light toward the light guide,

wherein an incident angle λₛₜ of the excitation light incident on the photoluminescent layer through the light guide and a refractive index nₛₜ of the light guide satisfy nₛₜ sin(θₛₜ)>1.

[Item 37] The light-emitting apparatus according to Item 33, further including

a transparent substrate for supporting the photoluminescent layer,

wherein the light guide is located on a surface of the transparent substrate opposite the photoluminescent layer.

[Item 38] The light-emitting apparatus according to Item 37, further including

a light source for emitting the excitation light toward the light guide,

wherein an incident angle θₛₜ of the excitation light incident on the transparent substrate through the light guide and a refractive index nₛₜ of the light guide satisfy nₛₜ sin(λₛₜ)>1.

[Item 39] The light-emitting apparatus according to any one of Items 1 to 6, wherein the light guide includes at least one prismatic light-transmissive member.
[Item 40] The light-emitting apparatus according to any one of Items 33 to 38, wherein the light guide includes at least one hemispherical light-transmissive member.
[Item 41] The light-emitting apparatus according to any one of Items 33 to 38, wherein the light guide includes at least one pyramidal light-transmissive member.
[Item 42] The light-emitting apparatus according to any one of Items to 41, wherein

the excitation light has a wavelength λₑₓ in air,

the submicron structure is formed such that the first light is most strongly emitted in a direction normal to the photoluminescent layer and such that second light having a wavelength λₑₓ propagating through the photoluminescent layer is most strongly emitted at an angle θₒᵤₜ with respect to the direction normal to the photoluminescent layer, and

the light guide allows the excitation light to enter the photoluminescent layer at an incident angle θₒᵤₜ.

[Item 43] The light-emitting apparatus according to any one of Items 33 to 42, wherein

the submicron structure has a one-dimensional periodic structure, and

the light guide extends perpendicularly to a line direction of the one-dimensional periodic structure and to a thickness direction of the photoluminescent layer.

[Item 44] Alight-emitting apparatus including:

a photoluminescent layer that has a first surface perpendicular to a thickness direction thereof and emits light in response to excitation light having a wavelength λₑₓ in air, an area of the first surface being larger than a sectional area of the photoluminescent layer perpendicular to the first surface;

a light-transmissive layer located on the photoluminescent layer; and

a light source emitting the excitation light, wherein

at least one of the photoluminescent layer and the light-transmissive layer has a submicron structure having at least projections or recesses arranged perpendicular to the thickness direction of the photoluminescent layer,

the light emitted from the photoluminescent layer includes first light having a wavelength λₐ in air,

at least one of the photoluminescent layer and the light-transmissive layer has a light emitting surface perpendicular to the thickness direction of the photoluminescent layer, the first light being emitted from the light emitting surface,

a distance Dᵢₙₜ between adjacent projections or recesses and a refractive index n_{wav-a} of the photoluminescent layer for the first light satisfy λₐ/n_{wav-a}<Dᵢₙₜ<λₐ,

the submicron structure causes the first light to be most strongly emitted in a direction normal to the photoluminescent layer and causes second light having a wavelength λₑₓ propagating through the photoluminescent layer to be most strongly emitted at an angle θₒᵤₜ with respect to the direction normal to the photoluminescent layer, and

the light source allows the excitation light to enter the photoluminescent layer at an incident angle θₒᵤₜ.

[Item 45] A light-emitting apparatus including:

a light-transmissive layer having a submicron structure;

a photoluminescent layer that is located on the submicron structure and emits light in response to excitation light; and

a light guide guiding the excitation light to the photoluminescent layer, wherein

the submicron structure includes at least one periodic structure having at least projections or recesses arranged perpendicular to the thickness direction of the photoluminescent layer,

the light emitted from the photoluminescent layer includes first light having a wavelength λₐ in air,

at least one of the photoluminescent layer and the light-transmissive layer has a light emitting surface perpendicular to the thickness direction of the photoluminescent layer, the first light being emitted from the light emitting surface,

a refractive index n_{wav-a} of the photoluminescent layer for the first light and a period pₐ of the at least one periodic structure satisfy λₐ/n_{wav-a}<pₐ<λₐ, and a thickness of the photoluminescent layer, the refractive index n_{wav-a}, and the period pₐ are set to limit a directional angle of the first light emitted from the light emitting surface.

[Item 46] A light-emitting apparatus including:

a photoluminescent layer that has a first surface perpendicular to a thickness direction thereof and emits light in response to excitation light;

a light-transmissive layer that has a higher refractive index than the photoluminescent layer and has a submicron structure; and

a light guide guiding the excitation light to the photoluminescent layer, wherein

the submicron structure includes at least one periodic structure having at least projections or recesses arranged perpendicular to the thickness direction of the photoluminescent layer,

the light emitted from the photoluminescent layer includes first light having a wavelength λₐ in air,

at least one of the photoluminescent layer and the light-transmissive layer has a light emitting surface perpendicular to the thickness direction of the photoluminescent layer, the first light being emitted from the light emitting surface,

a refractive index n_{wav-a} of the photoluminescent layer for the first light and a period pₐ of the at least one periodic structure satisfy λₐ/n_{wav-a}<pₐ<λₐ, and a thickness of the photoluminescent layer, the refractive index and the period pₐ are set to limit a directional angle of the first light emitted from the light emitting surface.

[Item 47] The light-emitting apparatus according to any one of Items 33 to 46, wherein the photoluminescent layer is in contact with the light-transmissive layer.
[Item 48] A light-emitting apparatus including:

a photoluminescent layer that has a first surface perpendicular to a thickness direction thereof and emits light in response to excitation light; and

a light guide guiding the excitation light to the photoluminescent layer, wherein

the photoluminescent layer has a submicron structure,

the light emitted from the photoluminescent layer includes first light having a wavelength λₐ in air,

the photoluminescent layer has a light emitting surface perpendicular to the thickness direction of the photoluminescent layer, the first light being emitted from the light emitting surface,

the submicron structure includes at least one periodic structure having at least projections or the recesses arranged perpendicular to the thickness direction of the photoluminescent layer,

a refractive index n_{wav-a} of the photoluminescent layer for the first light and a period pₐ of the at least one periodic structure satisfy λₐ/n_{wav-a}<pₐ<λₐ, and a thickness of the photoluminescent layer, the refractive index n_{wav-a}, and the period pₐ are set to limit a directional angle of the first light emitted from the light emitting surface.

[Item 49] The light-emitting apparatus according to any one of Items 33 to 48, wherein the submicron structure has both the projections and the recesses.
[Item 50] A light-emitting apparatus including

a light-emitting device that includes a photoluminescent layer, a light-transmissive layer located on or near the photoluminescent layer, and a submicron structure that is formed on at least one of the photoluminescent layer and the light-transmissive layer and that extends in a plane of the photoluminescent layer or the light-transmissive layer, and

a reflective layer facing a light output side of the light-emitting device,

wherein the submicron structure has projections or recesses, light emitted from the photoluminescent layer includes first light having a wavelength λₐ in air, and the distance Dᵢₙₜ between adjacent projections or recesses and the refractive index n_{wav-a} of the photoluminescent layer for the first light satisfy λₐ/n_{wav-a}<Dᵢₙₜ<λₐ.

[Item 51] The light-emitting apparatus according to Item 50, wherein the reflective layer has a light-transmissive texture, and total reflection occurs on a surface of the texture.
[Item 52] The light-emitting apparatus according to Item 51, wherein the texture includes one of a prismatic structure, a pyramidal structure, a microlens array, a lenticular lens, and a corner cube array.
[Item 53] The light-emitting apparatus according to Item 50, wherein the reflective layer includes a reflective metal film or a dielectric multilayer film.
[Item 54] The light-emitting apparatus according to Item 53, wherein the dielectric multilayer film constitutes a dichroic mirror.
[Item 55] The light-emitting apparatus according to Item 50, wherein the reflective layer includes a diffuse reflective film.
[Item 56] The light-emitting apparatus according to any one of Items 50 to 55, wherein the reflective layer has a reflective surface inclined at an angle θ of more than 0 degrees with respect to a surface of the photoluminescent layer.
[Item 57] The light-emitting apparatus according to Item 56, wherein

light emitted from the photoluminescent layer includes light having a first wavelength and light having a second wavelength, the light having the first wavelength being emitted in the direction normal to the surface of the photoluminescent layer due to the diffraction effect of the periodic structure, the light having the second wavelength being emitted in a direction different from the direction normal to the surface of the photoluminescent layer due to the diffraction effect of the periodic structure,

the light having the second wavelength reaches the reflective surface in a direction different by an angle of 2θ from the direction normal to the surface of the photoluminescent layer, and

the angle θ of the reflective surface is half the angle 2θ.

[Item 58] The light-emitting apparatus according to Item 56 or 57, wherein the reflective layer includes an air layer between the reflective surface inclined at the angle θ and the light-emitting device.
[Item 59] The light-emitting apparatus according to any one of Items 50 to 58, further including

the light-emitting devices adjacent to each other on the same plane,

wherein the light-emitting devices include at least a first light-emitting device and a second light-emitting device, and

the period of a periodic structure of a submicron structure of the first light-emitting device is different from the period of a periodic structure of a submicron structure of the second light-emitting device.

A light-emitting device according to an embodiment of the present disclosure includes a photoluminescent layer, a light-transmissive layer located on or near the photoluminescent layer, and a submicron structure that is formed on at least one of the photoluminescent layer and the light-transmissive layer and that extends in a plane of the photoluminescent layer or the light-transmissive layer. The submicron structure has projections or recesses, light emitted from the photoluminescent layer includes first light having a wavelength λₐ in air, and the distance Dᵢₙₜ between adjacent projections or recesses and the refractive index n_{wav-a} of the photoluminescent layer for the first light satisfy λₐ/n_{wav-a}<Dᵢₙₜ<λₐ. The wavelength λₐ is, for example, within the visible wavelength range (for example, 380 to 780 nm).

The photoluminescent layer contains a photoluminescent material. The term “photoluminescent material” refers to a material that emits light in response to excitation light. The term “photoluminescent material” encompasses fluorescent materials and phosphorescent materials in a narrow sense, encompasses inorganic materials and organic materials (for example, dyes), and encompasses quantum dots (that is, tiny semiconductor particles). The photoluminescent layer may contain a matrix material (host material) in addition to the photoluminescent material. Examples of matrix materials include resins and inorganic materials such as glasses and oxides.

The light-transmissive layer located on or near the photoluminescent layer is made of a material with high transmittance to the light emitted from the photoluminescent layer, for example, inorganic materials or resins. For example, the light-transmissive layer is desirably formed of a dielectric material (particularly, an insulator having low light absorptivity). For example, the light-transmissive layer may be a substrate that supports the photoluminescent layer. If the surface of the photoluminescent layer facing air has the submicron structure, the air layer can serve as the light-transmissive layer.

In a light-emitting device according to an embodiment of the present disclosure, a submicron structure (for example, a periodic structure) on at least one of the photoluminescent layer and the light-transmissive layer forms a unique electric field distribution inside the photoluminescent layer and the light-transmissive layer, as described in detail later with reference to the results of calculations and experiments. This electric field distribution is formed by an interaction between guided light and the submicron structure and may also be referred to as a “quasi-guided mode”.

The quasi-guided mode can be utilized to improve the luminous efficiency, directionality, and polarization selectivity of photoluminescence, as described later. The term “quasi-guided mode” may be used in the following description to describe novel structures and/or mechanisms contemplated by the inventors. However, such a description is for illustrative purposes only and is not intended to limit the present disclosure in any way.

For example, the submicron structure has projections, and the distance (the center-to-center distance) Dᵢₙₜ between adjacent projections satisfies λₐ/n_{wav-a}<Dᵢₙₜ<λₐ. Instead of the projections, the submicron structure may have recesses. For simplicity, the following description will be directed to a submicron structure having projections. The symbol λ denotes the wavelength of light, and the symbol λₐ denotes the wavelength of light in air. The symbol n_{wav} denotes the refractive index of the photoluminescent layer. If the photoluminescent layer is a medium containing materials, the refractive index n_{wav} denotes the average refractive index of the materials weighted by their respective volume fractions.

Although it is desirable to use the symbol n_{wav-a} to refer to the refractive index for light having a wavelength λₐ because the refractive index n generally depends on the wavelength, it may be abbreviated for simplicity. The symbol n_{wav} basically denotes the refractive index of the photoluminescent layer; however, if a layer having a higher refractive index than the photoluminescent layer is adjacent to the photoluminescent layer, the refractive index n_{wav} denotes the average refractive index of the layer having a higher refractive index and the photoluminescent layer weighted by their respective volume fractions. This is optically equivalent to a photoluminescent layer composed of layers of different materials.

The effective refractive index n_{eff} of the medium for light in the quasi-guided mode satisfies nₐ<n_{eff}<n_{wav}, wherein nₐ denotes the refractive index of air. If light in the quasi-guided mode is assumed to be light propagating through the photoluminescent layer while being totally reflected at an angle of incidence θ, the effective refractive index n_{eff} can be written as n_{eff}=n_{wav} sin θ. The effective refractive index n_{eff} is determined by the refractive index of the medium present in the region where the electric field of the quasi-guided mode is distributed.

For example, if the submicron structure is formed in the light-transmissive layer, the effective refractive index n_{eff} depends not only on the refractive index of the photoluminescent layer but also on the refractive index of the light-transmissive layer. Because the electric field distribution also varies depending on the polarization direction of the quasi-guided mode (that is, the TE mode or the TM mode), the effective refractive index n_{eff} can differ between the TE mode and the TM mode.

The submicron structure is formed on at least one of the photoluminescent layer and the light-transmissive layer. If the photoluminescent layer and the light-transmissive layer are in contact with each other, the submicron structure may be formed on the interface between the photoluminescent layer and the light-transmissive layer. In such a case, the photoluminescent layer and the light-transmissive layer have the submicron structure. The photoluminescent layer may have no submicron structure. In such a case, a light-transmissive layer having a submicron structure is located on or near the photoluminescent layer. A phrase like “a light-transmissive layer (or its submicron structure) located on or near the photoluminescent layer”, as used herein, typically means that the distance between these layers is less than half the wavelength λₐ. This allows the electric field of a guided mode to reach the submicron structure, thus forming a quasi-guided mode. However, the distance between the submicron structure of the light-transmissive layer and the photoluminescent layer may exceed half the wavelength λₐ if the light-transmissive layer has a higher refractive index than the photoluminescent layer. If the light-transmissive layer has a higher refractive index than the photoluminescent layer, light reaches the light-transmissive layer even if the above relationship is not satisfied. In the present specification, if the photoluminescent layer and the light-transmissive layer have a positional relationship that allows the electric field of a guided mode to reach the submicron structure and form a quasi-guided mode, they may be associated with each other.

The submicron structure, which satisfies λₐ/n_{wav-a}<Dᵢₙₜ<λₐ, as described above, is characterized by a submicron size. For example, the submicron structure includes at least one periodic structure, as in the light-emitting devices according to the embodiments described in detail later. The at least one periodic structure has a period pₐ that satisfies λₐ<n_{wav-a}<pₐ<λₐ. Thus, the submicron structure includes a periodic structure in which the distance Dᵢₙₜ between adjacent projections is constant at pₐ. If the submicron structure includes a periodic structure, light in the quasi-guided mode propagates while repeatedly interacting with the periodic structure so that the light is diffracted by the submicron structure. Unlike the phenomenon in which light propagating through free space is diffracted by a periodic structure, this is the phenomenon in which light is guided (that is, repeatedly totally reflected) while interacting with the periodic structure. This can efficiently diffract light even if the periodic structure causes a small phase shift (that is, even if the periodic structure has a small height).

The above mechanism can be utilized to improve the luminous efficiency of photoluminescence by the enhancement of the electric field due to the quasi-guided mode and also to couple the emitted light into the quasi-guided mode. The angle of travel of the light in the quasi-guided mode is varied by the angle of diffraction determined by the periodic structure. This can be utilized to output light of a particular wavelength in a particular direction (that is, significantly improve the directionality). Furthermore, high polarization selectivity can be simultaneously achieved because the effective refractive index n_{eff} (=n_{wav} sin θ) differs between the TE mode and the TM mode. For example, as demonstrated by the experimental examples below, a light-emitting device can be provided that outputs intense linearly polarized light (for example, the TM mode) of a particular wavelength (for example, 610 nm) in the front direction. The directional angle of the light output in the front direction is, for example, less than 15 degrees. The term “directional angle” refers to the angle of one side with respect to the front direction, which is assumed to be 0 degrees.

Conversely, a submicron structure having a lower periodicity results in a lower directionality, luminous efficiency, polarization, and wavelength selectivity. The periodicity of the submicron structure may be adjusted depending on the need. The periodic structure may be a one-dimensional periodic structure, which has a higher polarization selectivity, or a two-dimensional periodic structure, which allows for a lower polarization.

The submicron structure may include periodic structures. For example, these periodic structures may have different periods or different periodic directions (axes). The periodic structures may be formed on the same plane or may be stacked on top of each other. The light-emitting device may include photoluminescent layers and light-transmissive layers, and each of the layers may have submicron structures.

The submicron structure can be used not only to control the light emitted from the photoluminescent layer but also to efficiently guide excitation light into the photoluminescent layer. That is, the excitation light can be diffracted and coupled into the quasi-guided mode to guide light in the photoluminescent layer and the light-transmissive layer by the submicron structure to efficiently excite the photoluminescent layer. A submicron structure may be used that satisfies λₑₓ/n_{wav-ex}<Dᵢₙₜ<λₑₓ, wherein λₑₓ denotes the wavelength in air of the light that excites the photoluminescent material, and n_{wav-ex} denotes the refractive index of the photoluminescent layer for the excitation light. The symbol n_{wav-ex} denotes the refractive index of the photoluminescent layer for the emission wavelength of the photoluminescent material. Alternatively, a submicron structure may be used that includes a periodic structure having a period pₑₓ that satisfies λₑₓ/n_{wav-ex}<pₑₓ<λₑₓ. The excitation light has a wavelength λₑₓ of 450 nm, for example, but may have a shorter wavelength than visible light. If the excitation light has a wavelength within the visible range, it may be output together with the light emitted from the photoluminescent layer.

### 1. Underlying Knowledge Forming Basis of the Present Disclosure

The underlying knowledge forming the basis for the present disclosure will be described before describing specific embodiments of the present disclosure. As described above, photoluminescent materials such as those used for fluorescent lamps and white LEDs emit light in all directions and thus require optical elements such as reflectors and lenses to emit light in a particular direction. These optical elements, however, can be eliminated (or the size thereof can be reduced) if the photoluminescent layer itself emits directional light. This results in a significant reduction in the size of optical devices and equipment. With this idea in mind, the inventors have conducted a detailed study on the photoluminescent layer to achieve directional light emission.

The inventors have investigated the possibility of inducing light emission with particular directionality so that the light emitted from the photoluminescent layer is localized in a particular direction. Based on Fermi's golden rule, the emission rate Γ, which is a measure characterizing light emission, is represented by the equation (1):

$$Γ ( r ) = \frac{2 π}{ℏ} {〈 ( d \cdot E ( r ) ) 〉}^{2} ρ ( λ ) \qquad ( 1 )$$

In the equation (1), r is the vector indicating the position, λ is the wavelength of light, d is the dipole vector, E is the electric field vector, and ρ is the density of states. For many substances other than some crystalline substances, the dipole vector d is randomly oriented. The magnitude of the electric field E is substantially constant irrespective of the direction if the size and thickness of the photoluminescent layer are sufficiently larger than the wavelength of light. Hence, in most cases, the value of <(d·E(r))>² does not depend on the direction. Accordingly, the emission rate Γ is constant irrespective of the direction. Thus, in most cases, the photoluminescent layer emits light in all directions.

As can be seen from the equation (1), to achieve anisotropic light emission, it is necessary to align the dipole vector d in a particular direction or to enhance the component of the electric field vector in a particular direction. One of these approaches can be employed to achieve directional light emission. In the present disclosure, the results of a detailed study and analysis on structures for utilizing a quasi-guided mode in which the electric field component in a particular direction is enhanced by the confinement of light in the photoluminescent layer will be described below.

### 2 Structure for Enhancing Electric Field Only in Particular Direction

The inventors have investigated the possibility of controlling light emission using a guided mode with an intense electric field. Light can be coupled into a guided mode using a waveguide that itself contains a photoluminescent material. However, a waveguide simply formed using a photoluminescent material outputs little or no light in the front direction because the emitted light is coupled into a guided mode. Accordingly, the inventors have investigated the possibility of combining a waveguide containing a photoluminescent material with a periodic structure (including projections or recesses or both). When the electric field of light is guided in a waveguide while overlapping with a periodic structure located on or near the waveguide, a quasi-guided mode is formed by the effect of the periodic structure. That is, the quasi-guided mode is a guided mode restricted by the periodic structure and is characterized in that the antinodes of the amplitude of the electric field have the same period as the periodic structure. Light in this mode is confined in the waveguide to enhance the electric field in a particular direction. This mode also interacts with the periodic structure to undergo diffraction so that the light in this mode is converted into light propagating in a particular direction and can thus be output from the waveguide. The electric field of light other than the quasi-guided mode is not enhanced because little or no such light is confined in the waveguide. Thus, most light is coupled into a quasi-guided mode with a large electric field component.

That is, the inventors have investigated the possibility of using a photoluminescent layer containing a photoluminescent material as a waveguide (or a waveguide layer including a photoluminescent layer) in combination with a periodic structure located on or near the waveguide to couple light into a quasi-guided mode in which the light is converted into light propagating in a particular direction, thereby providing a directional light source.

As a simple waveguide, the inventors have studied slab waveguides. A slab waveguide has a planar structure in which light is guided. FIG. 30 is a schematic perspective view of a slab waveguide 110S. There is a mode of light propagating through the waveguide 110S if the waveguide 110S has a higher refractive index than a transparent substrate 140 that supports the waveguide 110S. If such a slab waveguide includes a photoluminescent layer, the electric field of light emitted from an emission point overlaps largely with the electric field of a guided mode. This allows most of the light emitted from the photoluminescent layer to be coupled into the guided mode. If the photoluminescent layer has a thickness close to the wavelength of the light, a situation can be created where there is only a guided mode with a large electric field amplitude.

If a periodic structure is located on or near the photoluminescent layer, the electric field of the guided mode interacts with the periodic structure to form a quasi-guided mode. Even if the photoluminescent layer is composed of a plurality of layers, a quasi-guided mode is formed as long as the electric field of the guided mode reaches the periodic structure. Not all parts of the photoluminescent layer needs to be formed of a photoluminescent material, provided that at least a portion of the photoluminescent layer functions to emit light.

If the periodic structure is made of a metal, a mode due to the guided mode and plasmon resonance is formed. This mode has different properties from the quasi-guided mode. This mode is less effective in enhancing emission because a large loss occurs due to high absorption by the metal. Thus, it is desirable to form the periodic structure using a dielectric material having low absorptivity.

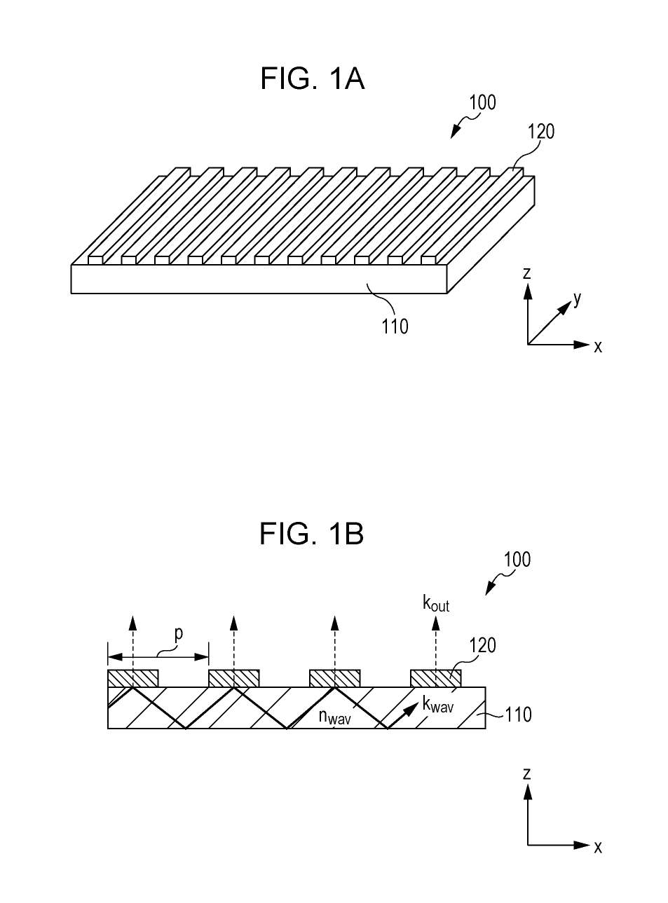

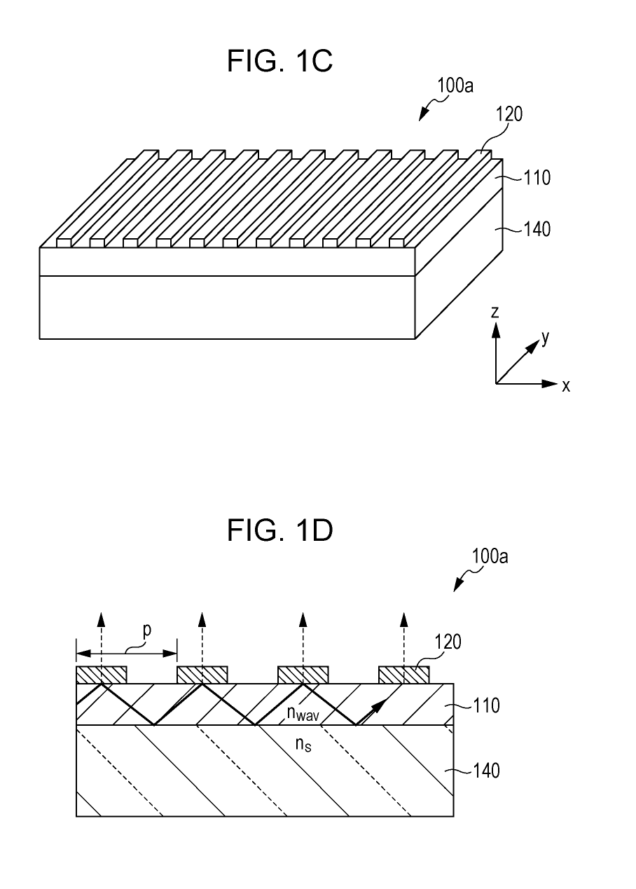

The inventors have studied the coupling of light into a quasi-guided mode that can be output as light propagating in a particular angular direction using a periodic structure formed on a waveguide (for example, a photoluminescent layer). FIG. 1A is a schematic perspective view of a light-emitting device 100 including a waveguide (for example, a photoluminescent layer) 110 and a periodic structure (for example, a light-transmissive layer) 120. The light-transmissive layer 120 is hereinafter also referred to as a periodic structure 120 if the light-transmissive layer 120 forms a periodic structure (that is, if a periodic submicron structure is formed on the light-transmissive layer 120). In this example, the periodic structure 120 is a one-dimensional periodic structure in which stripe-shaped projections extending in the y direction are arranged at regular intervals in the x direction. FIG. 1B is a cross-sectional view of the light-emitting device 100 taken along a plane parallel to the xz plane. If a periodic structure 120 having a period p is provided in contact with the waveguide 110, a quasi-guided mode having a wave number k_{wav} in the in-plane direction is converted into light propagating outside the waveguide 110. The wave number kₒᵤₜ of the light can be represented by the equation (2):

$${k}_{out} = {k}_{wav} - m \frac{2 π}{p} \qquad ( 2 )$$

wherein m is an integer indicating the diffraction order.

For simplicity, the light guided in the waveguide 110 is assumed to be a ray of light propagating at an angle θ_{wav}. This approximation gives the equations (3) and (4):

$$\begin{matrix}\frac{{k}_{wav} {λ}_{0}}{2 π} = {n}_{wav} sin {θ}_{wav} & ( 3 ) \\ \frac{{k}_{out} {λ}_{0}}{2 π} = {n}_{out} sin {θ}_{out} & ( 4 )\end{matrix}$$

In these equations, λ₀ denotes the wavelength of the light in air, n_{wav} denotes the refractive index of the waveguide 110, nₒᵤₜ denotes the refractive index of the medium on the light output side, and θₒᵤₜ denotes the angle at which the light is output from the waveguide 110 to a substrate or air. From the equations (2) to (4), the output angle θₒᵤₜ can be represented by the equation (5):

nₒᵤₜ sin θₒᵤₜ=n_{wav} sin θ_{wav}−mλ₀/p (5)

If n_{wav} sin θ_{wav}=mλ₀/p in the equation (5), this results in θₒᵤₜ=0, meaning that the light can be emitted in the direction perpendicular to the plane of the waveguide 110 (that is, in the front direction).

Based on this principle, light can be coupled into a particular quasi-guided mode and be converted into light having a particular output angle using the periodic structure to output intense light in that direction.

There are some constraints to achieving the above situation. To form a quasi-guided mode, the light propagating through the waveguide 110 has to be totally reflected. The conditions therefor are represented by the inequality (6):

nₒᵤₜ<n_{wav} sin θ_{wav} (6)

To diffract the quasi-guided mode using the periodic structure and thereby output the light from the waveguide 110, −1<sin θₒᵤₜ<1 has to be satisfied in the equation (5). Hence, the inequality (7) has to be satisfied:

$$- 1 < \frac{{n}_{wav}}{{n}_{out}} sin {θ}_{wav} - \frac{m {λ}_{0}}{{n}_{out} p} < 1 \qquad ( 7 )$$

Taking into account the inequality (6), the inequality (8) may be satisfied:

$$\frac{m {λ}_{0}}{2 {n}_{out}} < p \qquad ( 8 )$$

To output the light from the waveguide 110 in the front direction (θₒᵤₜ=0), as can be seen from the equation (5), the equation (9) has to be satisfied:

p=mλ₀/(n_{wav} sin θ_{wav}) (9)

As can be seen from the equation (9) and the inequality (6), the required conditions are represented by the inequality (10):

$$\frac{m {λ}_{0}}{{n}_{wav}} < p < \frac{m {λ}_{0}}{{n}_{out}} \qquad ( 10 )$$

If the periodic structure 120 as illustrated in FIGS. 1A and 1B is provided, it may be designed based on first-order diffracted light (that is, m=1) because higher-order diffracted light having m of 2 or more has low diffraction efficiency. In this embodiment, the period p of the periodic structure 120 is determined so as to satisfy the inequality (11), which is given by substituting m=1 into the inequality (10):

$$\frac{{λ}_{0}}{{n}_{wav}} < p < \frac{{λ}_{0}}{{n}_{out}} \qquad ( 11 )$$

If the waveguide (photoluminescent layer) 110 is not in contact with a transparent substrate, as illustrated in FIGS. 1A and 1B, nₒᵤₜ is equal to the refractive index of air (approximately 1.0). Thus, the period p may be determined so as to satisfy the inequality (12):

$$\frac{{λ}_{0}}{{n}_{wav}} < p < {λ}_{0} \qquad ( 12 )$$

Alternatively, a structure as illustrated in FIGS. 10 and 1D may be employed in which the photoluminescent layer 110 and the periodic structure 120 are formed on a transparent substrate 140. The refractive index nₛ of the transparent substrate 140 is higher than the refractive index of air. Thus, the period p may be determined so as to satisfy the inequality (13), which is given by substituting nₒᵤₜ=nₛ into the inequality (11):

$$\frac{{λ}_{0}}{{n}_{wav}} < p < \frac{{λ}_{0}}{{n}_{s}} \qquad ( 13 )$$

Although m=1 is assumed in the inequality (10) to give the inequalities (12) and (13), m≧2 may be assumed. That is, if both surfaces of the light-emitting device 100 are in contact with air layers, as illustrated in FIGS. 1A and 1B, the period p may be determined so as to satisfy the inequality (14):

$$\frac{m {λ}_{0}}{{n}_{wav}} < p < m {λ}_{0} \qquad ( 14 )$$

wherein m is an integer of 1 or more.

Similarly, if the photoluminescent layer 110 is formed on the transparent substrate 140, as in the light-emitting device 100a illustrated in FIGS. 1C and 1D, the period p may be determined so as to satisfy the inequality (15):

$$\frac{m {λ}_{0}}{{n}_{wav}} < p < \frac{m {λ}_{0}}{{n}_{s}} \qquad ( 15 )$$

By determining the period p of the periodic structure so as to satisfy the above inequalities, the light emitted from the photoluminescent layer 110 can be output in the front direction, thus providing a directional light-emitting device.

### 3. Verification by Calculations

### 3-1. Period and Wavelength Dependence

The inventors verified, by optical analysis, whether the output of light in a particular direction as described above is actually possible. The optical analysis was performed by calculations using DiffractMOD available from Cybernet Systems Co., Ltd. In these calculations, the change in the absorption of external light incident perpendicular to a light-emitting device by a photoluminescent layer was calculated to determine the enhancement of light output perpendicular to the light-emitting device. The calculation of the process by which external incident light is coupled into a quasi-guided mode and is absorbed by the photoluminescent layer corresponds to the calculation of a process opposite to the process by which light emitted from the photoluminescent layer is coupled into a quasi-guided mode and is converted into propagating light output perpendicular to the light-emitting device. Similarly, the electric field distribution of a quasi-guided mode was calculated from the electric field of external incident light.

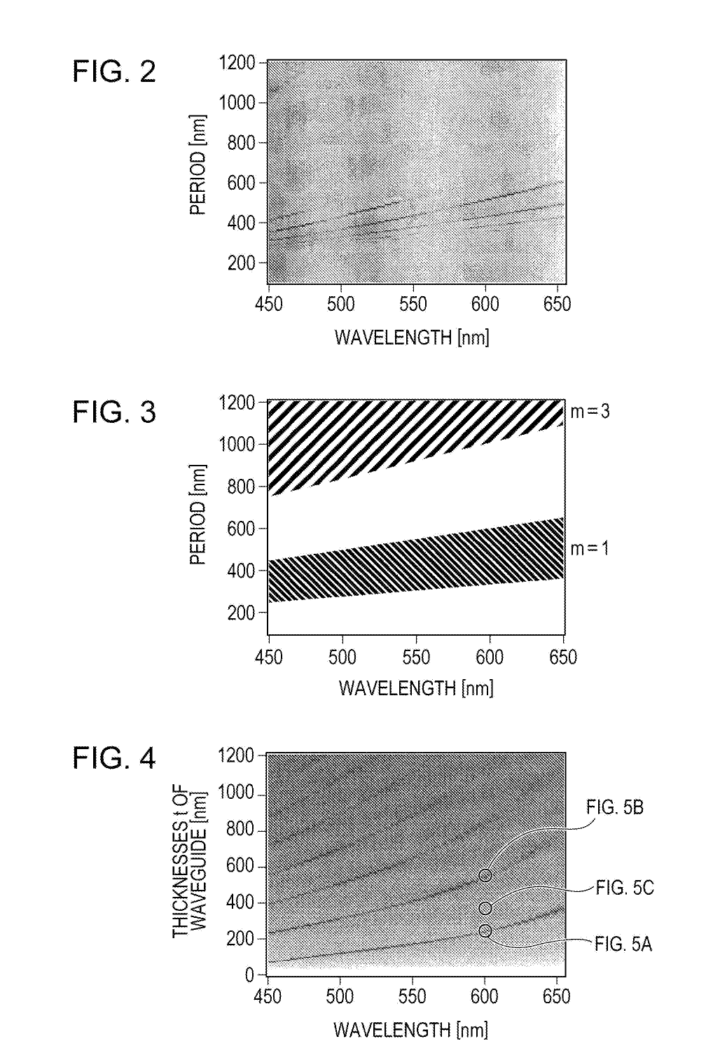

FIG. 2 shows the calculation results of the enhancement of light output in the front direction with varying emission wavelengths and varying periods of the periodic structure, where the photoluminescent layer was assumed to have a thickness of 1 and a refractive index n_{wav} of 1.8, and the periodic structure was assumed to have a height of 50 nm and a refractive index of 1.5. In these calculations, the periodic structure was assumed to be a one-dimensional periodic structure uniform in the y direction, as shown in FIG. 1A, and the polarization of the light was assumed to be the TM mode, which has an electric field component parallel to the y direction. The results in FIG. 2 show that there are enhancement peaks at certain combinations of wavelength and period. In FIG. 2, the magnitude of the enhancement is expressed by different shades of color; a darker color (black) indicates a higher enhancement, whereas a lighter color (white) indicates a lower enhancement.

In the above calculations, the periodic structure was assumed to have a rectangular cross section as shown in FIG. 1B. FIG. 3 is a graph illustrating the conditions for m=1 and m=3 in the inequality (10). A comparison between FIGS. 2 and 3 shows that the peaks in FIG. 2 are located within the regions corresponding to m=1 and m=3. The intensity is higher for m=1 because first-order diffracted light has a higher diffraction efficiency than third- or higher-order diffracted light. There is no peak for m=2 because of low diffraction efficiency in the periodic structure.

In FIG. 2, a plurality of lines are observed in each of the regions corresponding to m=1 and m=3 in FIG. 3. This indicates the presence of a plurality of quasi-guided modes.

### 3-2. Thickness Dependence

FIG. 4 is a graph showing the calculation results of the enhancement of light output in the front direction with varying emission wavelengths and varying thicknesses t of the photoluminescent layer, where the photoluminescent layer was assumed to have a refractive index n_{wav} of 1.8, and the periodic structure was assumed to have a period of 400 nm, a height of 50 nm, and a refractive index of 1.5. FIG. 4 shows that the enhancement of the light peaks at a particular thickness t of the photoluminescent layer.

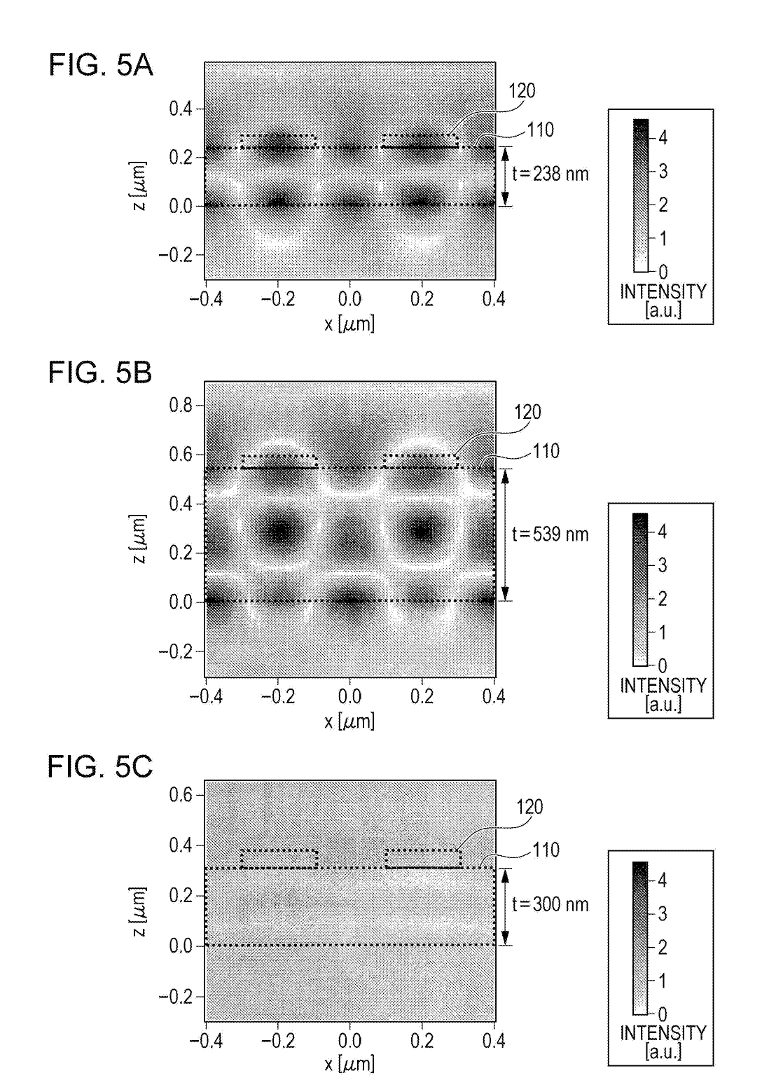

FIGS. 5A and 5B show the calculation results of the electric field distributions of a mode to guide light in the x direction for a wavelength of 600 nm and thicknesses t of 238 nm and 539 nm, respectively, at which there are peaks in FIG. 4. For comparison, FIG. 5C shows the results of similar calculations for a thickness t of 300 nm, at which there is no peak. In these calculations, as in the above calculations, the periodic structure was a one-dimensional periodic structure uniform in the y direction. In each figure, a black region indicates a higher electric field intensity, whereas a white region indicates a lower electric field intensity. Whereas the results for t=238 nm and t=539 nm show high electric field intensity, the results for t=300 nm shows low electric field intensity as a whole. This is because there are guided modes for t=238 nm and t=539 nm so that light is strongly confined. Furthermore, regions with the highest electric field intensity (that is, antinodes) are necessarily present in or directly below the projections, indicating the correlation between the electric field and the periodic structure 120. Thus, the resulting guided mode depends on the arrangement of the periodic structure 120. A comparison between the results for t=238 nm and t=539 nm shows that these modes differ in the number of nodes (white regions) of the electric field in the z direction by one.

### 3-3. Polarization Dependence

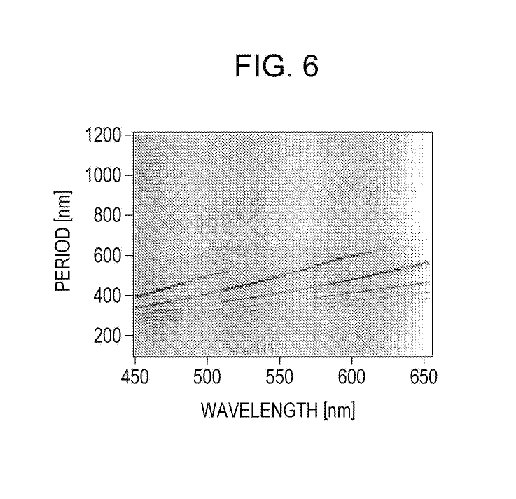

To examine the polarization dependence, the enhancement of light was calculated under the same conditions as in FIG. 2 except that the polarization of the light was assumed to be the TE mode, which has an electric field component perpendicular to the y direction. FIG. 6 shows the results of these calculations. Although the peaks in FIG. 6 differ slightly in position from the peaks for the TM mode (FIG. 2), they are located within the regions shown in FIG. 3. This demonstrates that the structure according to this embodiment is effective for both of the TM mode and the TE mode.

### 3-4. Two-Dimensional Periodic Structure

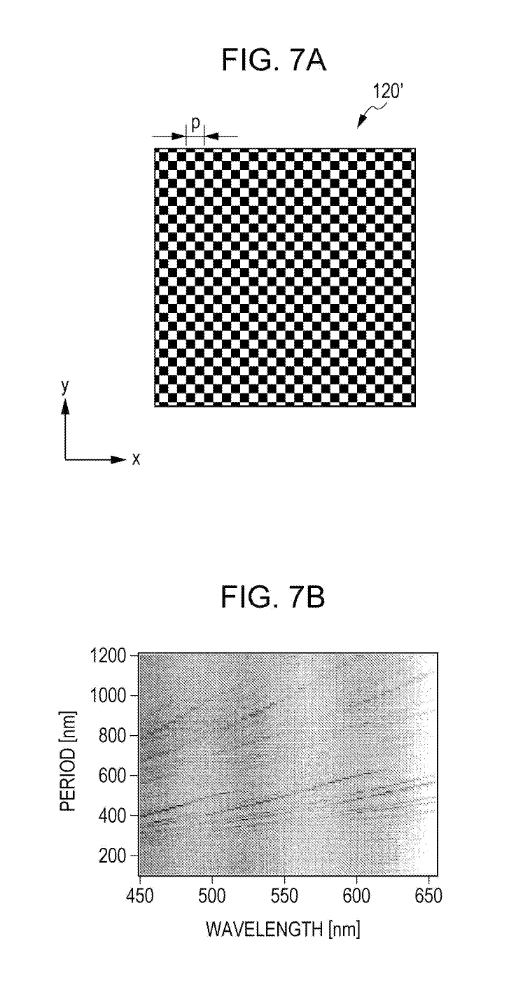

The effect of a two-dimensional periodic structure was also studied. FIG. 7A is a partial plan view of a two-dimensional periodic structure 120′ including recesses and projections arranged in both of the x direction and the y direction. In FIG. 7A, the black regions indicate the projections, and the white regions indicate the recesses. For a two-dimensional periodic structure, both of the diffraction in the x direction and the diffraction in the y direction have to be taken into account. Although the diffraction in only the x direction or the y direction is similar to that in a one-dimensional periodic structure, a two-dimensional periodic structure can be expected to give different results from a one-dimensional periodic structure because diffraction also occurs in a direction containing both of an x component and a y component (for example, a direction inclined at 45 degrees). FIG. 7B shows the calculation results of the enhancement of light for the two-dimensional periodic structure. The calculations were performed under the same conditions as in FIG. 2 except for the type of periodic structure. As shown in FIG. 7B, peaks matching the peaks for the TE mode in FIG. 6 were observed in addition to peaks matching the peaks for the TM mode in FIG. 2. These results demonstrate that the two-dimensional periodic structure also converts and outputs the TE mode by diffraction. For a two-dimensional periodic structure, the diffraction that simultaneously satisfies the first-order diffraction conditions in both of the x direction and the y direction also has to be taken into account. Such diffracted light is output in the direction at the angle corresponding to √2 times (that is, 2^{1/2} times) the period p. Thus, peaks will occur at √2 times the period p in addition to peaks that occur in a one-dimensional periodic structure. Such peaks are observed in FIG. 7B.

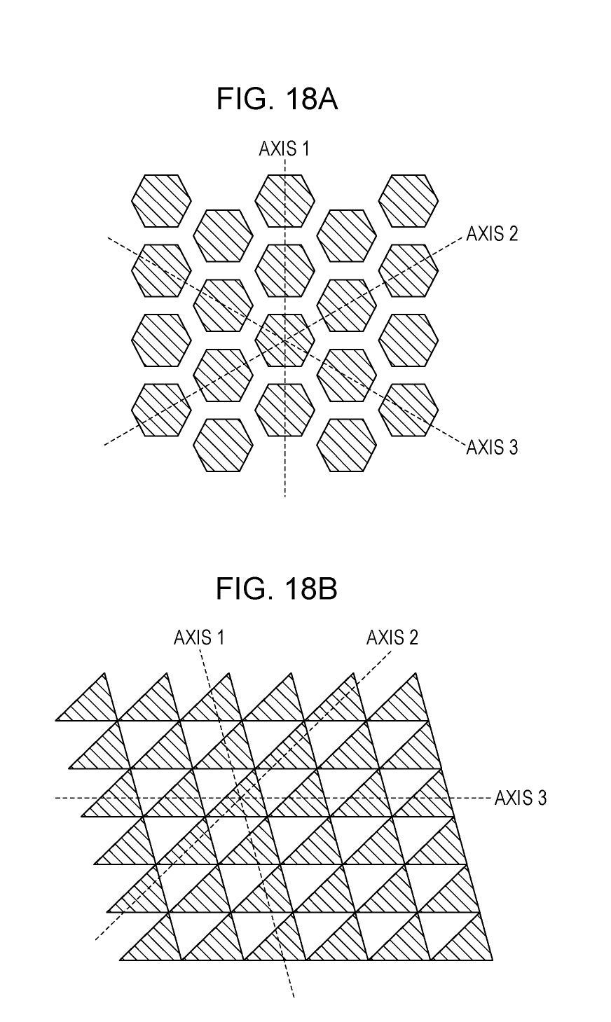

The two-dimensional periodic structure does not have to be a square grid structure having equal periods in the x direction and the y direction, as illustrated in FIG. 7A, but may be a hexagonal grid structure, as illustrated in FIG. 18A, or a triangular grid structure, as illustrated in FIG. 18B. The two-dimensional periodic structure may have different periods in different directions (for example, in the x direction and the y direction for a square grid structure).

In this embodiment, as demonstrated above, light in a characteristic quasi-guided mode formed by the periodic structure and the photoluminescent layer can be selectively output only in the front direction through diffraction by the periodic structure. With this structure, the photoluminescent layer can be excited with excitation light such as ultraviolet light or blue light to output directional light.

### 4. Study on Constructions of Periodic Structure and Photoluminescent Layer

The effects of changes in various conditions such as the constructions and refractive indices of the periodic structure and the photoluminescent layer will now be described.

### 4-1. Refractive Index of Periodic Structure

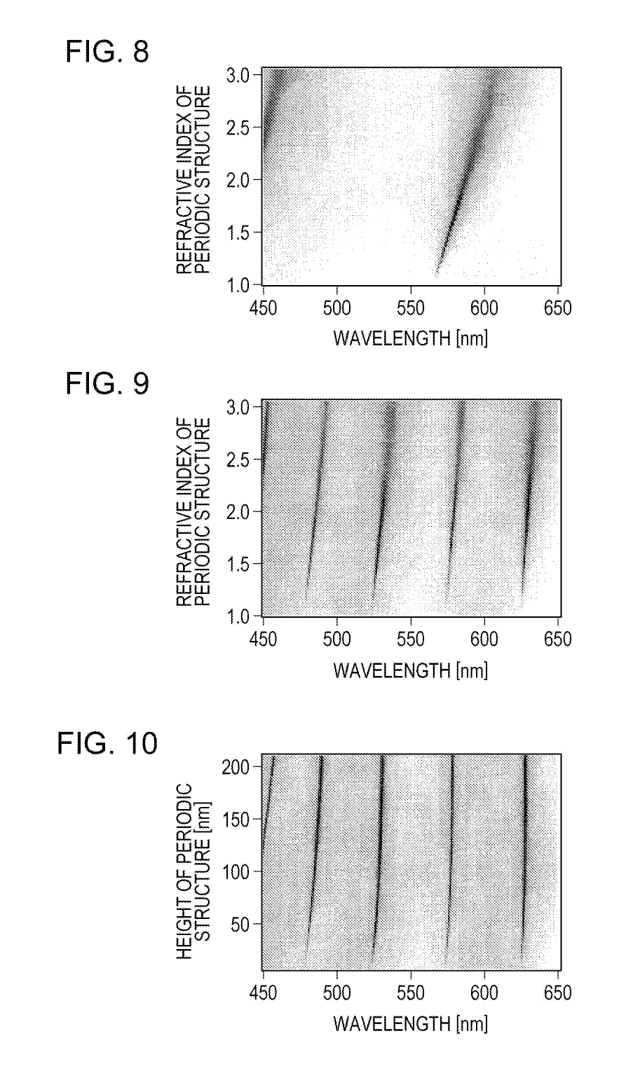

The refractive index of the periodic structure was studied. In the calculations performed herein, the photoluminescent layer was assumed to have a thickness of 200 nm and a refractive index n_{wav} of 1.8, the periodic structure was assumed to be a one-dimensional periodic structure uniform in the y direction, as shown in FIG. 1A, having a height of 50 nm and a period of 400 nm, and the polarization of the light was assumed to be the TM mode, which has an electric field component parallel to the y direction. FIG. 8 shows the calculation results of the enhancement of light output in the front direction with varying emission wavelengths and varying refractive indices of the periodic structure. FIG. 9 shows the results obtained under the same conditions except that the photoluminescent layer was assumed to have a thickness of 1,000 nm.

The results show that a photoluminescent layer having a thickness of 1,000 nm (FIG. 9) results in a smaller shift in the wavelength at which the light intensity peaks (referred to as a peak wavelength) with the change in the refractive index of the periodic structure than a photoluminescent layer having a thickness of 200 nm (FIG. 8). This is because the quasi-guided mode is more affected by the refractive index of the periodic structure as the photoluminescent layer is thinner. Specifically, a periodic structure having a higher refractive index increases the effective refractive index and thus shifts the peak wavelength toward longer wavelengths, and this effect is more noticeable as the photoluminescent layer is thinner. The effective refractive index is determined by the refractive index of the medium present in the region where the electric field of the quasi-guided mode is distributed.

The results also show that a periodic structure having a higher refractive index results in a broader peak and a lower intensity. This is because a periodic structure having a higher refractive index outputs light in the quasi-guided mode at a higher rate and is therefore less effective in confining the light, that is, has a lower value. To maintain a high peak intensity, a structure may be employed in which light is moderately output using a quasi-guided mode that is effective in confining the light (that is, has a high value). This means that it is undesirable to use a periodic structure made of a material having a much higher refractive index than the photoluminescent layer. Thus, in order to increase the peak intensity and Q value, the refractive index of a dielectric material constituting the periodic structure (that is, the light-transmissive layer) can be lower than or similar to the refractive index of the photoluminescent layer. This is also true if the photoluminescent layer contains materials other than photoluminescent materials.

### 4-2. Height of Periodic Structure

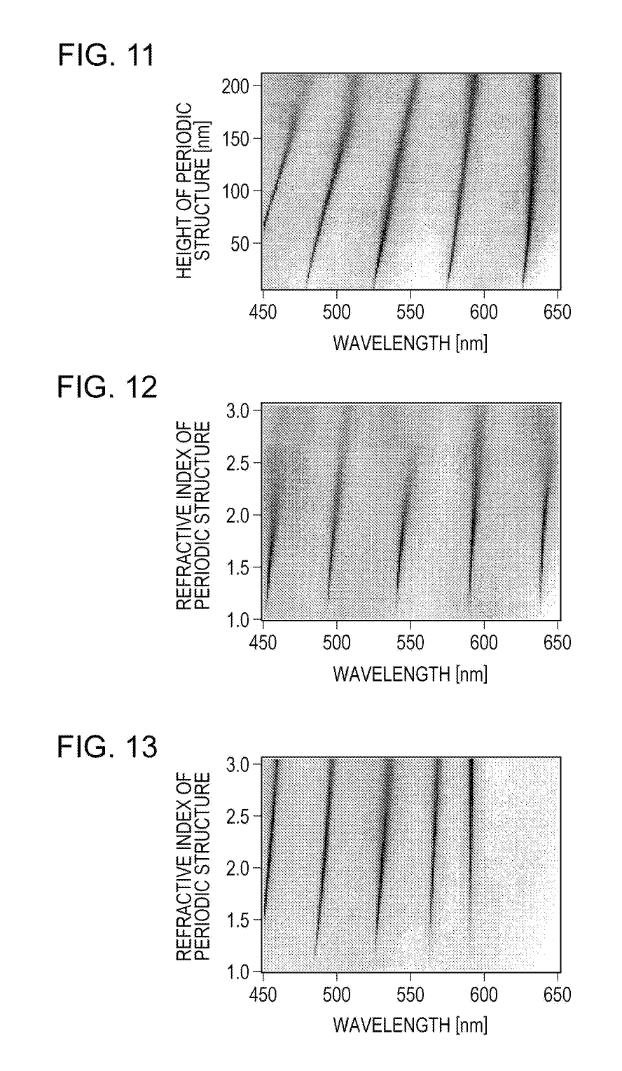

The height of the periodic structure was then studied. In the calculations performed herein, the photoluminescent layer was assumed to have a thickness of 1,000 nm and a refractive index n_{wav} of 1.8, the periodic structure was assumed to be a one-dimensional periodic structure uniform in the y direction, as shown in FIG. 1A, having a refractive index nₚ of 1.5 and a period of 400 nm, and the polarization of the light was assumed to be the TM mode, which has an electric field component parallel to the y direction. FIG. 10 shows the calculation results of the enhancement of light output in the front direction with varying emission wavelengths and varying heights of the periodic structure. FIG. 11 shows the results of calculations performed under the same conditions except that the periodic structure was assumed to have a refractive index nₚ of 2.0. Whereas the results in FIG. 10 show that the peak intensity and the Q value (that is, the peak line width) do not change above a certain height of the periodic structure, the results in FIG. 11 show that the peak intensity and the value decrease with increasing height of the periodic structure. If the refractive index n_{wav} of the photoluminescent layer is higher than the refractive index nₚ of the periodic structure (FIG. 10), the light is totally reflected, and only a leaking (that is, evanescent) portion of the electric field of the quasi-guided mode interacts with the periodic structure. If the periodic structure has a sufficiently large height, the influence of the interaction between the evanescent portion of the electric field and the periodic structure remains constant irrespective of the height. In contrast, if the refractive index n_{wav} of the photoluminescent layer is lower than the refractive index nₚ of the periodic structure (FIG. 11), the light reaches the surface of the periodic structure without being totally reflected and is therefore more influenced by a periodic structure with a larger height. As shown in FIG. 11, a height of approximately 100 nm is sufficient, and the peak intensity and the Q value decrease above a height of 150 nm. Thus, if the refractive index n_{wav} of the photoluminescent layer is lower than the refractive index nₚ of the periodic structure, the periodic structure may have a height of 150 nm or less to achieve a high peak intensity and value.

### 4-3. Polarization Direction

The polarization direction was then studied. FIG. 12 shows the results of calculations performed under the same conditions as in FIG. 9 except that the polarization of the light was assumed to be the TE mode, which has an electric field component perpendicular to the y direction. The TE mode is more influenced by the periodic structure than the TM mode because the electric field of the quasi-guided mode leaks more largely for the TE mode than for the TM mode. Thus, the peak intensity and the Q value decrease more significantly for the TE mode than for the TM mode if the refractive index nₚ of the periodic structure is higher than the refractive index n_{wav} of the photoluminescent layer.

### 4-4. Refractive Index of Photoluminescent Layer

The refractive index of the photoluminescent layer was then studied. FIG. 13 shows the results of calculations performed under the same conditions as in FIG. 9 except that the photoluminescent layer was assumed to have a refractive index n_{wav} of 1.5. The results for the photoluminescent layer having a refractive index n_{wav} of 1.5 are similar to the results in FIG. 9. However, light having a wavelength of 600 nm or more was not output in the front direction. This is because, from the inequality (10), λ₀<n_{wav}×p/m=1.5×400 nm/1=600 nm.

The above analysis demonstrates that a high peak intensity and Q value can be achieved if the periodic structure has a refractive index lower than or similar to the refractive index of the photoluminescent layer or if the periodic structure has a higher refractive index than the photoluminescent layer and a height of 150 nm or less.

### 5. Modified Examples

Modified Examples of the present embodiment will be described below.

### 5-1. Structure Including Substrate

As described above, the light-emitting device may have a structure in which the photoluminescent layer 110 and the periodic structure 120 are formed on the transparent substrate 140, as illustrated in FIGS. 1C and 1D. Such a light-emitting device 100a may be produced by forming a thin film of the photoluminescent material for the photoluminescent layer 110 (optionally containing a matrix material; the same applies hereinafter) on the transparent substrate 140 and then forming the periodic structure 120 thereon. In this structure, the refractive index nₛ of the transparent substrate 140 has to be lower than or equal to the refractive index n_{wav} of the photoluminescent layer 110 so that the photoluminescent layer 110 and the periodic structure 120 function to output light in a particular direction. If the transparent substrate 140 is provided in contact with the photoluminescent layer 110, the period p has to be set so as to satisfy the inequality (15), which is given by replacing the refractive index nₒᵤₜ of the output medium in the inequality (10) by nₛ.

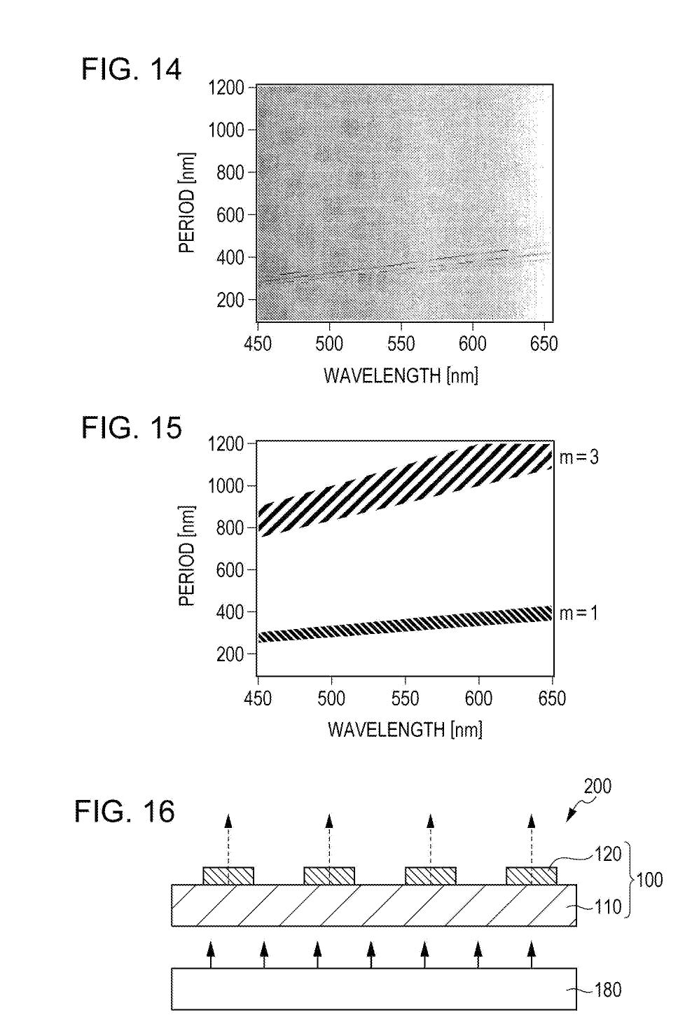

To demonstrate this, calculations were performed under the same conditions as in FIG. 2 except that the photoluminescent layer 110 and the periodic structure 120 were assumed to be located on a transparent substrate 140 having a refractive index of 1.5. FIG. 14 shows the results of these calculations. As in the results in FIG. 2, light intensity peaks are observed at particular periods for each wavelength, although the ranges of periods where peaks appear differ from those in FIG. 2. FIG. 15 is a graph illustrating the condition represented by the inequality (15), which is given by substituting nₒᵤₜ=nₛ into the inequality (10). In FIG. 14, light intensity peaks are observed in the regions corresponding to the ranges shown in FIG. 15.

Thus, for the light-emitting device 100a, in which the photoluminescent layer 110 and the periodic structure 120 are located on the transparent substrate 140, a period p that satisfies the inequality (15) is effective, and a period p that satisfies the inequality (13) is significantly effective.

### 5-2. Light-Emitting Apparatus Including Excitation Light Source

FIG. 16 is a schematic view of a light-emitting apparatus 200 including the light-emitting device 100 illustrated in FIGS. 1A and 1B and a light source 180 that emits excitation light toward the photoluminescent layer 110. In this embodiment, as described above, the photoluminescent layer can be excited with excitation light such as ultraviolet light or blue light to output directional light. The light source 180 can be configured to emit such excitation light to provide a directional light-emitting apparatus 200. Although the wavelength of the excitation light emitted from the light source 180 is typically within the ultraviolet or blue range, it is not necessarily within these ranges, but may be determined depending on the photoluminescent material for the photoluminescent layer 110. Although the light source 180 illustrated in FIG. 16 is configured to direct excitation light into the bottom surface of the photoluminescent layer 110, it may be configured otherwise, for example, to direct excitation light into the top surface of the photoluminescent layer 110.

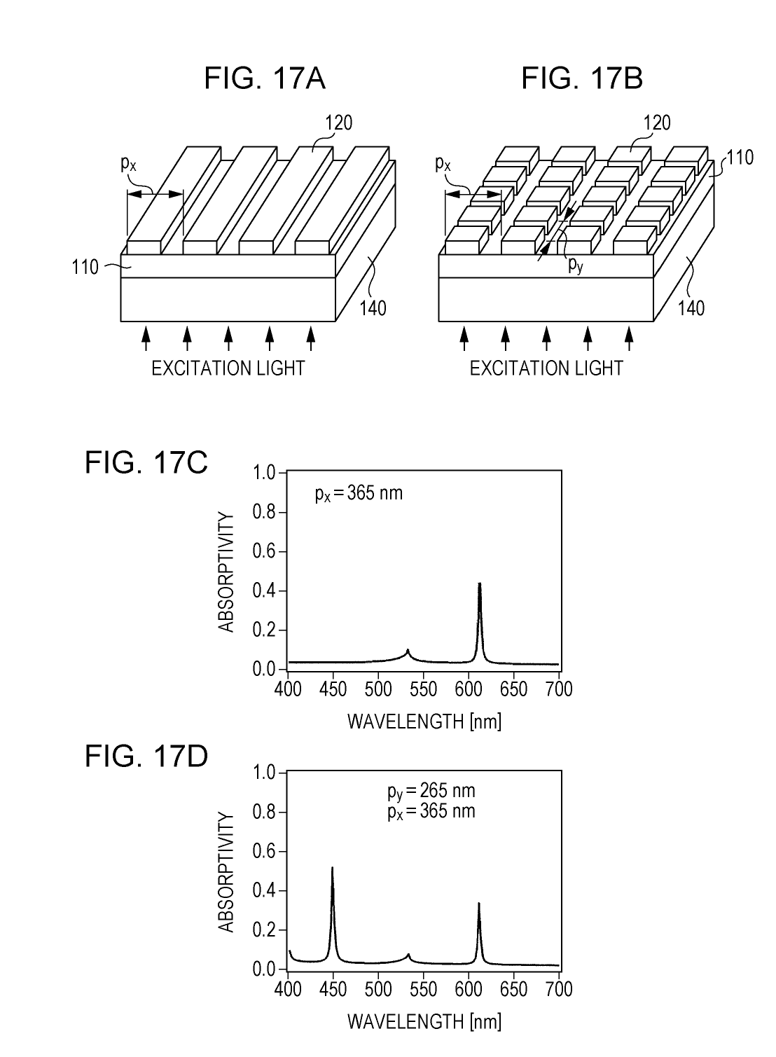

The excitation light may be coupled into a quasi-guided mode to efficiently output light. This method is illustrated in FIGS. 17A to 17D. In this example, as in the structure illustrated in FIGS. 1C and 1D, the photoluminescent layer 110 and the periodic structure 120 are formed on the transparent substrate 140. As shown in FIG. 17A, the period pₓ in the x direction is first determined so as to enhance light emission. As shown in FIG. 17B, the period p_{y} in the y direction is then determined so as to couple the excitation light into a quasi-guided mode. The period pₓ is determined so as to satisfy the condition given by replacing p in the inequality (10) by pₓ. The period p_{y} is determined so as to satisfy the inequality (16):

$$\frac{m {λ}_{ex}}{{n}_{wav}} < {p}_{y} < \frac{m {λ}_{ex}}{{n}_{out}} \qquad ( 16 )$$

wherein m is an integer of 1 or more, λₑₓ denotes the wavelength of the excitation light, and nₒᵤₜ denotes the refractive index of the medium having the highest refractive index of the media in contact with the photoluminescent layer 110 except the periodic structure 120.

In the example in FIGS. 17A to 17D, nₒᵤₜ is the refractive index nₛ of the transparent substrate 140. For a structure including no transparent substrate 140, as illustrated in FIG. 16, nₒᵤₜ denotes the refractive index of air (approximately 1.0).

In particular, the excitation light can be more effectively converted into a quasi-guided mode if m=1, that is, if the period p_{y} is determined so as to satisfy the inequality (17):

$$\frac{{λ}_{ex}}{{n}_{wav}} < {p}_{y} < \frac{{λ}_{ex}}{{n}_{out}} \qquad ( 17 )$$

Thus, the excitation light can be converted into a quasi-guided mode if the period p_{y} is set so as to satisfy the condition represented by the inequality (16) (particularly, the condition represented by the inequality (17)). As a result, the photoluminescent layer 110 can efficiently absorb the excitation light of the wavelength λₑₓ.

FIGS. 17C and 17D are the calculation results of the proportion of absorbed light to light incident on the structures shown in FIGS. 17A and 17B, respectively, for each wavelength. In these calculations, pₓ=365 nm, p_{y}=265 nm, the photoluminescent layer 110 was assumed to have an emission wavelength λ of approximately 600 nm, the excitation light was assumed to have a wavelength λₑₓ of approximately 450 nm, and the photoluminescent layer 110 was assumed to have an extinction coefficient of 0.003. As shown in FIG. 17D, the photoluminescent layer 110 has high absorptivity not only for the light emitted from the photoluminescent layer 110 but also for the excitation light, that is, light having a wavelength of approximately 450 nm. This indicates that the incident light is effectively converted into a quasi-guided mode to increase the proportion of the light absorbed into the photoluminescent layer 110. The photoluminescent layer 110 also has high absorptivity for the emission wavelength, that is, approximately 600 nm. This indicates that light having a wavelength of approximately 600 nm incident on this structure is similarly effectively converted into a quasi-guided mode. The periodic structure 120 shown in FIG. 17B is a two-dimensional periodic structure including structures having different periods (that is, different periodic components) in the x direction and the y direction. Such a two-dimensional periodic structure including periodic components allows for high excitation efficiency and high output intensity. Although the excitation light is incident on the transparent substrate 140 in FIGS. 17A and 17B, the same effect can be achieved even if the excitation light is incident on the periodic structure 120.

Also available are two-dimensional periodic structures including periodic components as shown in FIGS. 18A and 18B. The structure illustrated in FIG. 18A includes periodically arranged projections or recesses having a hexagonal planar shape. The structure illustrated in FIG. 18B includes periodically arranged projections or recesses having a triangular planar shape. These structures have major axes (axes 1 to 3 in the examples in FIGS. 18A and 18B) that can be assumed to be periodic. Thus, the structures can have different periods in different axial directions. These periods may be set so as to increase the directionality of light beams of different wavelengths or to efficiently absorb the excitation light. In any case, each period is set so as to satisfy the condition corresponding to the inequality (10).

### 5-3. Periodic Structure on Transparent Substrate

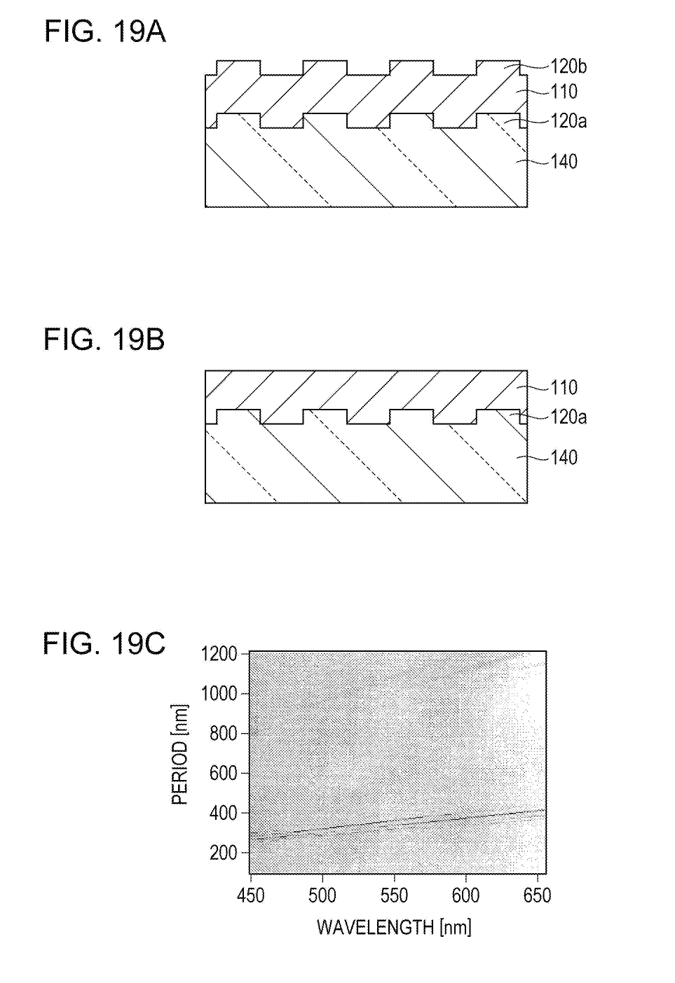

As illustrated in FIGS. 19A and 19B, a periodic structure 120a may be formed on the transparent substrate 140, and the photoluminescent layer 110 may be located thereon. In the example in FIG. 19A, the photoluminescent layer 110 is formed along the texture of the periodic structure 120a on the transparent substrate 140. As a result, a periodic structure 120b with the same period is formed in the surface of the photoluminescent layer 110. In the example in FIG. 19B, the surface of the photoluminescent layer 110 is flattened. In these examples, directional light emission can be achieved by setting the period p of the periodic structure 120a so as to satisfy the inequality (15).

To verify the effect of these structures, the enhancement of light output from the structure in FIG. 19A in the front direction was calculated with varying emission wavelengths and varying periods of the periodic structure. In these calculations, the photoluminescent layer 110 was assumed to have a thickness of 1,000 nm and a refractive index n_{wav} of 1.8, the periodic structure 120a was assumed to be a one-dimensional periodic structure uniform in the y direction having a height of 50 nm, a refractive index nₚ of 1.5, and a period of 400 nm, and the polarization of the light was assumed to be the TM mode, which has an electric field component parallel to the y direction. FIG. 190 shows the results of these calculations. In these calculations, light intensity peaks were observed at the periods that satisfy the condition represented by the inequality (15).

### 5-4. Powder

According to the above embodiment, light of any wavelength can be enhanced by adjusting the period of the periodic structure and the thickness of the photoluminescent layer. For example, if the structure illustrated in FIGS. 1A and 1B is formed using a photoluminescent material that emits light over a wide wavelength range, only light of a certain wavelength can be enhanced. Accordingly, the structure of the light-emitting device 100 as illustrated in FIGS. 1A and 1B may be provided in powder form for use as a fluorescent material. Alternatively, the light-emitting device 100 as illustrated in FIGS. 1A and 1B may be embedded in resin or glass.

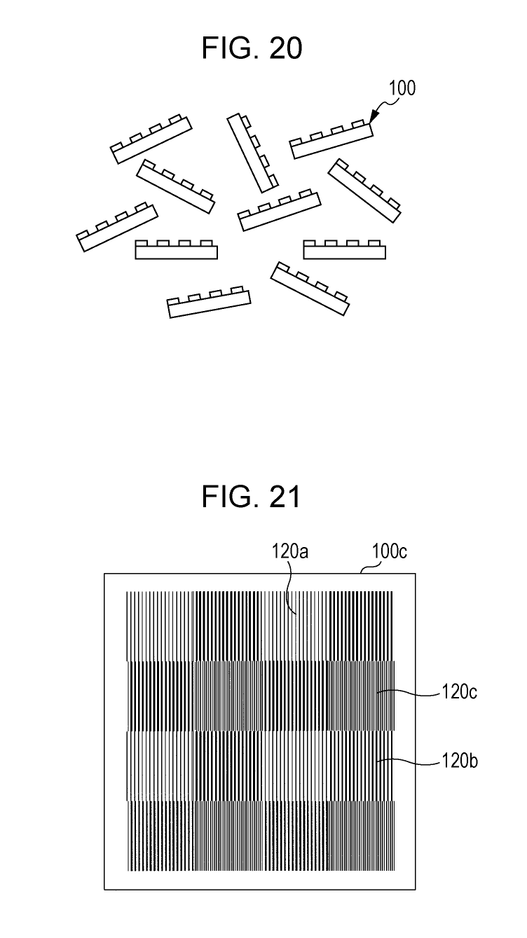

The single structure as illustrated in FIGS. 1A and 1B can output only light of a certain wavelength in a particular direction and is therefore not suitable for outputting, for example, white light, which has a wide wavelength spectrum. Accordingly, as shown in FIG. 20, light-emitting devices 100 that differ in the conditions such as the period of the periodic structure and the thickness of the photoluminescent layer may be mixed in powder form to provide a light-emitting apparatus with a wide wavelength spectrum. In such a case, the individual light-emitting devices 100 have sizes of, for example, several micrometers to several millimeters in one direction and can include, for example, one- or two-dimensional periodic structures with several periods to several hundreds of periods.

### 5-5. Array of Structures Having Different Periods

FIG. 21 is a plan view of a two-dimensional array of periodic structures having different periods on the photoluminescent layer. In this example, three types of periodic structures 120a, 120b, and 120c are arranged without any space therebetween. The periods of the periodic structures 120a, 120b, and 120c are set so as to output, for example, light in the red, green, and blue wavelength ranges, respectively, in the front direction. Thus, structures having different periods can be arranged on the photoluminescent layer to output directional light with a wide wavelength spectrum. The periodic structures are not necessarily configured as described above, but may be configured in any manner.

### 5-6. Layered Structure

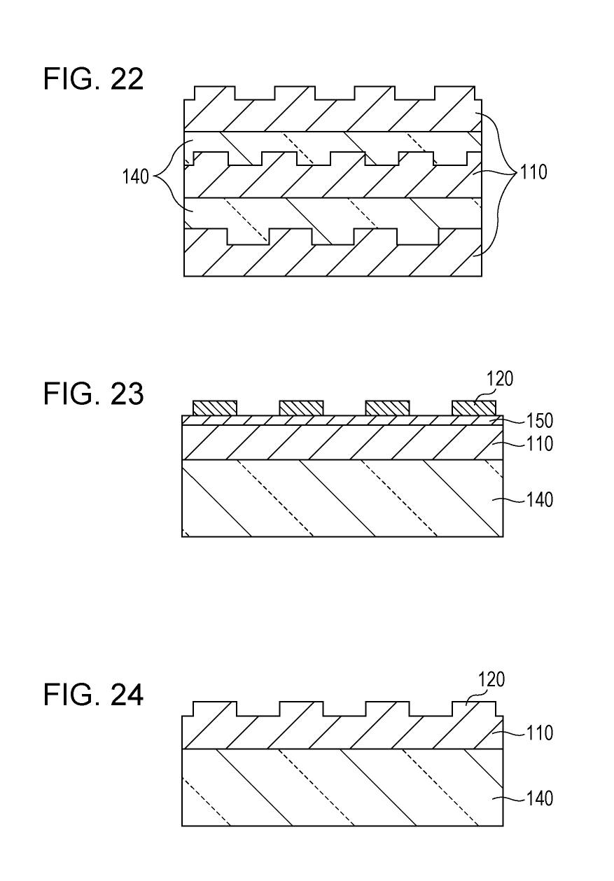

FIG. 22 illustrates a light-emitting device including photoluminescent layers 110 each having a textured surface. A transparent substrate 140 is located between the photoluminescent layers 110. The texture on each of the photoluminescent layers 110 corresponds to the periodic structure or the submicron structure. The example in FIG. 22 includes three periodic structures having different periods. The periods of these periodic structures are set so as to output light in the red, green, and blue wavelength ranges in the front direction. The photoluminescent layer 110 in each layer is made of a material that emits light of the color corresponding to the period of the periodic structure in that layer. Thus, periodic structures having different periods can be stacked on top of each other to output directional light with a wide wavelength spectrum.

The number of layers and the constructions of the photoluminescent layer 110 and the periodic structure in each layer are not limited to those described above, but may be selected as appropriate. For example, for a structure including two layers, first and second photoluminescent layers are formed opposite each other with a light-transmissive substrate therebetween, and first and second periodic structures are formed on the surfaces of the first and second photoluminescent layers, respectively. In such a case, the first photoluminescent layer and the first periodic structure may together satisfy the condition corresponding to the inequality (15), whereas the second photoluminescent layer and the second periodic structure may together satisfy the condition corresponding to the inequality (15). For a structure including three or more layers, the photoluminescent layer and the periodic structure in each layer may satisfy the condition corresponding to the inequality (15). The positional relationship between the photoluminescent layers and the periodic structures in FIG. 22 may be reversed. Although the layers illustrated by the example in FIG. 22 have different periods, they may all have the same period. In such a case, although the spectrum cannot be broadened, the emission intensity can be increased.

### 5-7. Structure Including Protective Layer

FIG. 23 is a cross-sectional view of a structure including a protective layer 150 between the photoluminescent layer 110 and the periodic structure 120. The protective layer 150 may be provided to protect the photoluminescent layer 110. However, if the protective layer 150 has a lower refractive index than the photoluminescent layer 110, the electric field of the light leaks into the protective layer 150 only by about half the wavelength. Thus, if the protective layer 150 is thicker than the wavelength, no light reaches the periodic structure 120. As a result, there is no quasi-guided mode, and the function of outputting light in a particular direction cannot be achieved. If the protective layer 150 has a refractive index higher than or similar to that of the photoluminescent layer 110, the light reaches the interior of the protective layer 150; therefore, there is no limitation on the thickness of the protective layer 150. Nevertheless, a thinner protective layer 150 is desirable because more light is output if most of the portion in which light is guided (this portion is hereinafter referred to as “waveguide layer”) is made of a photoluminescent material. The protective layer 150 may be made of the same material as the periodic structure (light-transmissive layer) 120. In such a case, the light-transmissive layer 120 having the periodic structure functions as a protective layer. The light-transmissive layer 120 desirably has a lower refractive index than the photoluminescent layer 110.

### 6. Materials and Production Methods

Directional light emission can be achieved if the photoluminescent layer (or waveguide layer) and the periodic structure are made of materials that satisfy the above conditions. The periodic structure may be made of any material. However, a photoluminescent layer (or waveguide layer) or a periodic structure made of a medium with high light absorption is less effective in confining light and therefore results in a lower peak intensity and Q value. Thus, the photoluminescent layer (or waveguide layer) and the periodic structure may be made of media with relatively low light absorption.

For example, the periodic structure may be formed of a dielectric material having low light absorptivity. Examples of candidate materials for the periodic structure include magnesium fluoride (MgF₂), lithium fluoride (LiF), calcium fluoride (CaF₂), quartz (SiO₂), glasses, resins, magnesium oxide (MgO), indium tin oxide (ITO), titanium oxide (TiO₂), silicon nitride (SiN), tantalum pentoxide (Ta₂O₅), zirconia (ZrO₂), zinc selenide (ZnSe), and zinc sulfide (ZnS). To form a periodic structure having a lower refractive index than the photoluminescent layer, as described above, MgF₂, LiF, CaF₂, SiO₂, glasses, and resins can be used, which have refractive indices of approximately 1.3 to 1.5.

The term “photoluminescent material” encompasses fluorescent materials and phosphorescent materials in a narrow sense, encompasses inorganic materials and organic materials (for example, dyes), and encompasses quantum dots (that is, tiny semiconductor particles). In general, a fluorescent material containing an inorganic host material tends to have a higher refractive index. Examples of fluorescent materials that emit blue light include M₁₀(PO₄)₆Cl₂:Eu²⁺ (wherein M is at least one element selected from Ba, Sr, and Ca), BaMgAl₁₀O₁₇:Eu²⁺, M₃MgSi₂O₈:Eu²⁺ (wherein M is at least one element selected from Ba, Sr, and Ca), and M₅SiO₄Cl₆:Eu²⁺ (wherein M is at least one element selected from Ba, Sr, and Ca). Examples of fluorescent materials that emit green light include M₂MgSi₂O₇:Eu²⁺ (wherein M is at least one element selected from Ba, Sr, and Ca), SrSi₅AlO₂N₇:Eu²⁺, SrSi₂O₂N₂:Eu²⁺, BaAl₂O₄:Eu²⁺, BaZrSi₃O₉:Eu²⁺, M₂SiO₄:Eu²⁺ (wherein M is at least one element selected from Ba, Sr, and Ca), BaSi₃O₄N₂:Eu²⁺, Ca₈Mg(SiO₄)₄Cl₂:Eu²⁺, Ca₃SiO₄Cl₂:Eu²⁺, CaSi₁₂₋₍ₘ₊ₙ₎Al₍ₘ₊ₙ₎OₙN₁₆₋ₙ:Ce³⁺, and α-SiAlON:Eu²⁺. Examples of fluorescent materials that emit red light include CaAlSiN₃:Eu²⁺, SrAlSi₄O₇:Eu²⁺, M₂Si₅N₈:Eu²⁺ (wherein M is at least one element selected from Ba, Sr, and Ca), MSiN₂:Eu²⁺ (wherein M is at least one element selected from Ba, Sr, and Ca), MSi₂O₂N₂:Yb²⁺ (wherein M is at least one element selected from Sr and Ca), Y₂O₂S:Eu³⁺, Sm³⁺, La₂O₂S:Eu³⁺,Sm³⁺, CaWO₄:Li¹⁺, Eu³⁺,Sm³⁺, M₂SiS₄:Eu²⁺ (wherein M is at least one element selected from Ba, Sr, and Ca), and M₃SiO₅:Eu²⁺ (wherein M is at least one element selected from Ba, Sr, and Ca). Examples of fluorescent materials that emit yellow light include Y₃Al₅O₁₂:Ce³⁺, CaSi₂O₂N₂:Eu²⁺, Ca₃Sc₂Si₃O₁₂:Ce³⁺, CaSc₂O₄:Ce³⁺, α-SiAlON:EU²⁺, MSi₂O₂N₂:Eu²⁺ (wherein M is at least one element selected from Ba, Sr, and Ca), and M₇(SiO₃)₅Cl₂:Eu²⁺ (wherein M is at least one element selected from Ba, Sr, and Ca).

Examples of quantum dots include materials such as CdS, CdSe, core-shell CdSe/ZnS, and alloy CdSSe/ZnS. Light of various wavelengths can be emitted depending on the material. Examples of matrices for quantum dots include glasses and resins.

The transparent substrate 140, as shown in, for example, FIGS. 1C and 1D, is made of a light-transmissive material having a lower refractive index than the photoluminescent layer 110. Examples of such materials include magnesium fluoride (MgF₂), lithium fluoride (LiF), calcium fluoride (CaF₂), quartz (SiO₂), glasses, and resins.

Exemplary production methods will be described below.

A method for forming the structure illustrated in FIGS. 1C and 1D includes forming a thin film of the photoluminescent layer 110 on the transparent substrate 140, for example, by evaporation, sputtering, or coating of a fluorescent material, forming a dielectric film, and then patterning the dielectric film, for example, by photolithography to form the periodic structure 120. Alternatively, the periodic structure 120 may be formed by nanoimprinting. As shown in FIG. 24, the periodic structure 120 may also be formed by partially processing the photoluminescent layer 110. In such a case, the periodic structure 120 is made of the same material as the photoluminescent layer 110.

The light-emitting device 100 illustrated in FIGS. 1A and 1B can be manufactured, for example, by fabricating the light-emitting device 100a illustrated in FIGS. 1C and 1D and then stripping the photoluminescent layer 110 and the periodic structure 120 from the substrate 140.

The structure shown in FIG. 19A can be manufactured, for example, by forming the periodic structure 120a on the transparent substrate 140 by a process such as a semiconductor manufacturing processes or nanoimprinting and then depositing thereon the material for the photoluminescent layer 110 by a process such as evaporation or sputtering. The structure shown in FIG. 19B can be manufactured by filling the recesses in the periodic structure 120a with the photoluminescent layer 110 by a process such as coating.

The above methods of manufacture are for illustrative purposes only, and the light-emitting devices according to the embodiments of the present disclosure may be manufactured by other methods.

### Experimental Examples

Light-emitting devices according to embodiments of the present disclosure are illustrated by the following examples.

A sample light-emitting device having the structure as illustrated in FIG. 19A was prepared and evaluated for its properties. The light-emitting device was prepared as described below.

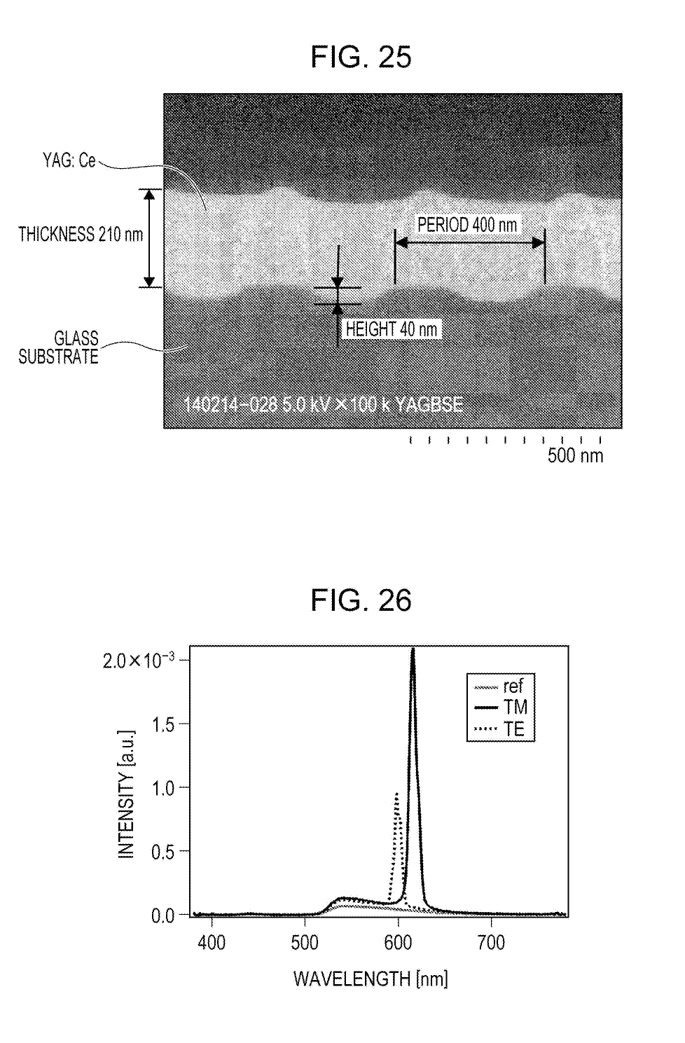

A one-dimensional periodic structure (stripe-shaped projections) having a period of 400 nm and a height of 40 nm was formed on a glass substrate, and a photoluminescent material, that is, YAG:Ce, was deposited thereon to a thickness of 210 nm. FIG. 25 shows a cross-sectional transmission electron microscopy (TEM) image of the resulting light-emitting device. FIG. 26 shows the results of measurements of the spectrum of light emitted from the light-emitting device in the front direction when YAG:Ce was excited with an LED having an emission wavelength of 450 nm. FIG. 26 shows the results (ref) for a light-emitting device including no periodic structure, the results for the TM mode, and the results for the TE mode. The TM mode has a polarization component parallel to the one-dimensional periodic structure. The TE mode has a polarization component perpendicular to the one-dimensional periodic structure. The results show that the intensity of light of a particular wavelength in the case with the periodic structure is significantly higher than without a periodic structure. The results also show that the light enhancement effect is greater for the TM mode, which has a polarization component parallel to the one-dimensional periodic structure.

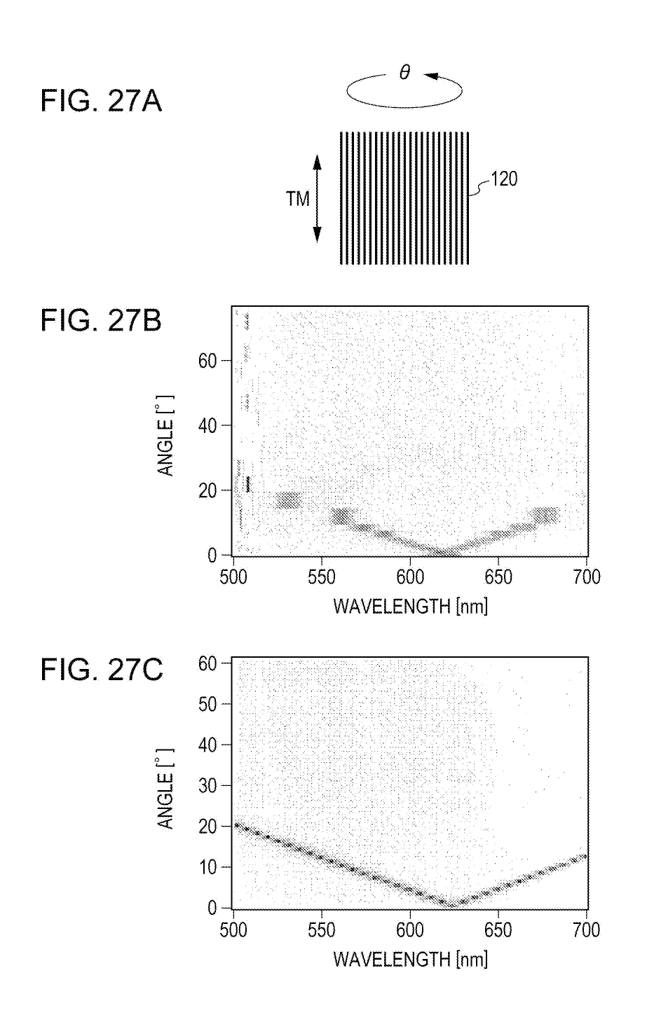

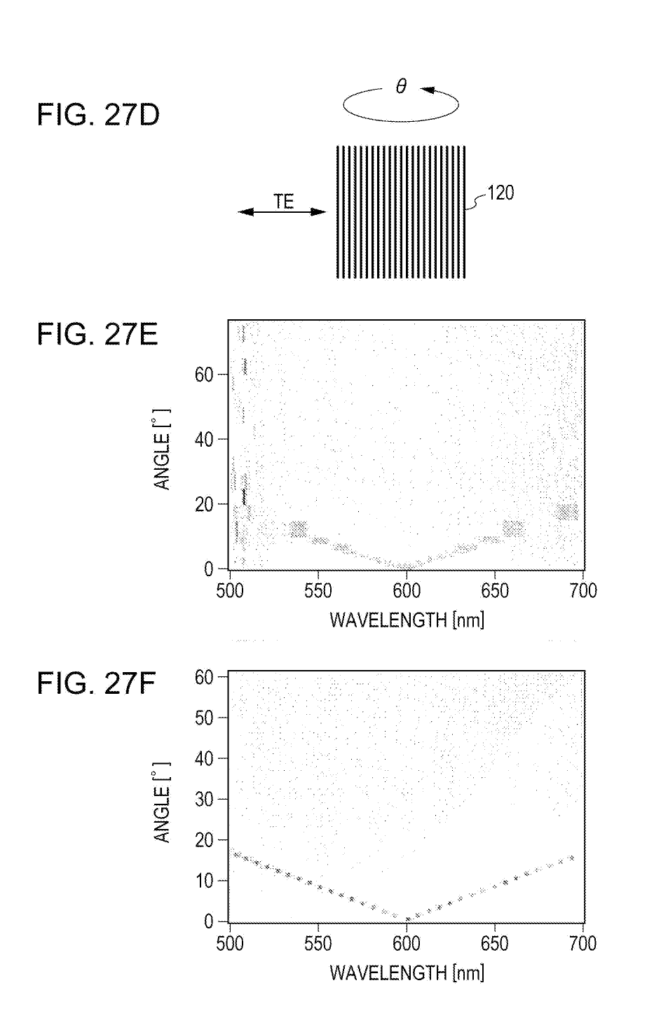

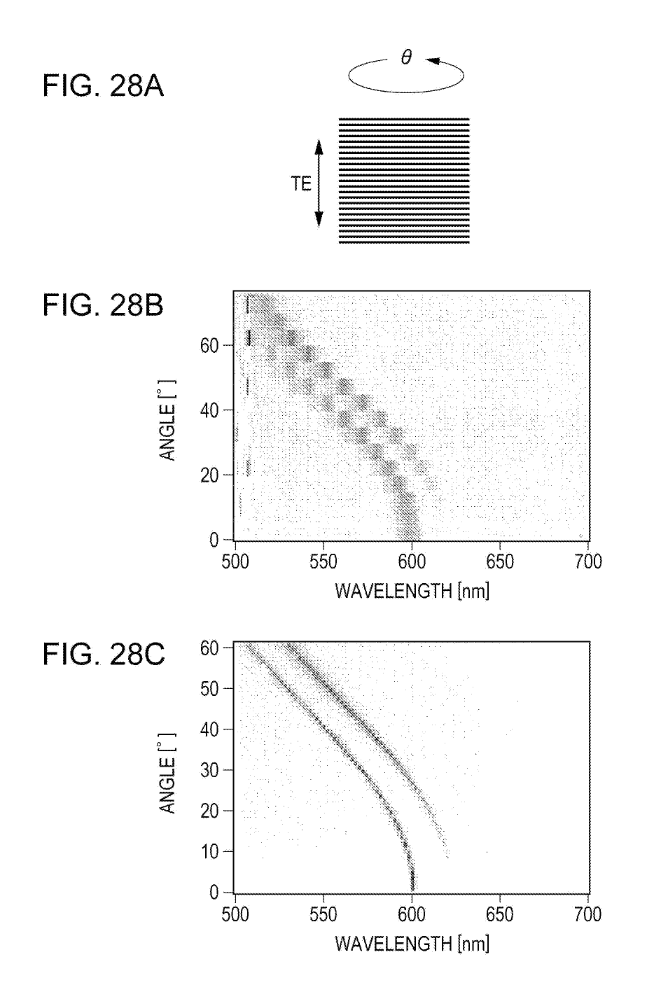

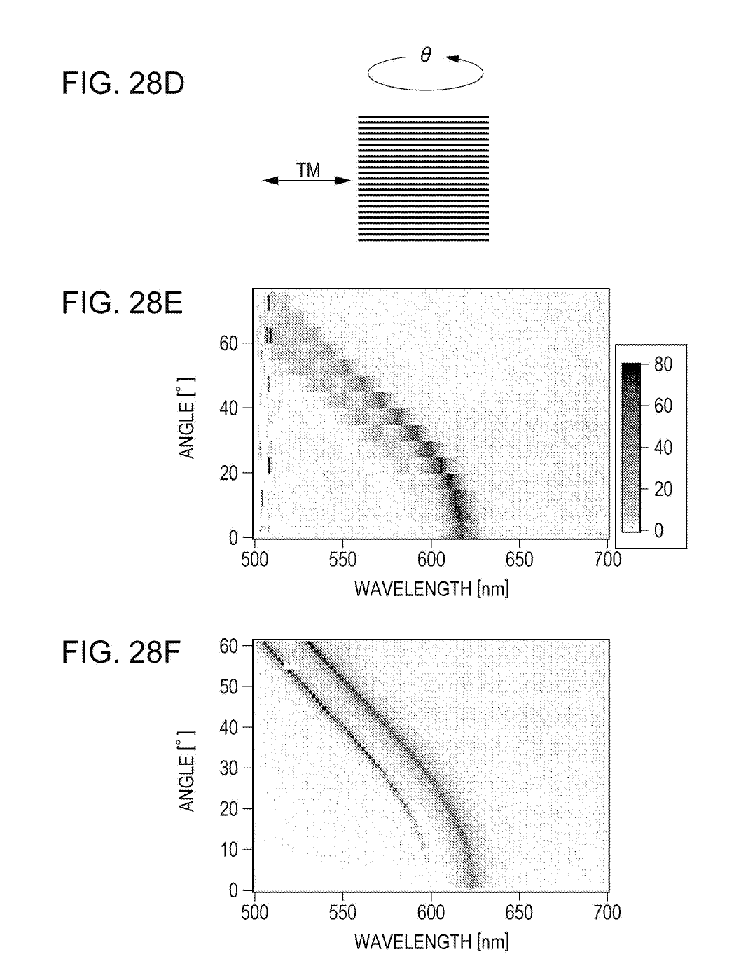

FIGS. 27A to 27F and FIGS. 28A to 28F show the results of measurements and calculations of the angular dependence of the intensity of light output from the same sample. FIGS. 27B and 27E show the results of measurements and FIGS. 27C and 27F show the results of calculations for rotation about an axis parallel to the line direction of the one-dimensional periodic structure (that is, the periodic structure 120). FIGS. 28B and 28E show the results of measurements and FIGS. 28C and 28F show the results of calculations for rotation about an axis perpendicular to the line direction of the one-dimensional periodic structure (that is, the periodic structure 120).

FIGS. 27A to 27F and FIGS. 28A to 28F show the results for linearly polarized light in the TM mode and the TE mode. FIGS. 27A to 27C show the results for linearly polarized light in the TM mode. FIGS. 27D to 27F show the results for linearly polarized light in the TE mode. FIGS. 28A to 28C show the results for linearly polarized light in the TE mode. FIGS. 28D to 28F show the results for linearly polarized light in the TM mode. As can be seen from FIGS. 27A to 27F and FIGS. 28A to 28F, the enhancement effect is greater for the TM mode, and the enhanced wavelength shifts with angle. For example, light having a wavelength of 610 nm is observed only in the TM mode and in the front direction, indicating that the light is directional and polarized. In addition, the top and bottom parts of each figure match each other. Thus, the validity of the above calculations was experimentally demonstrated.

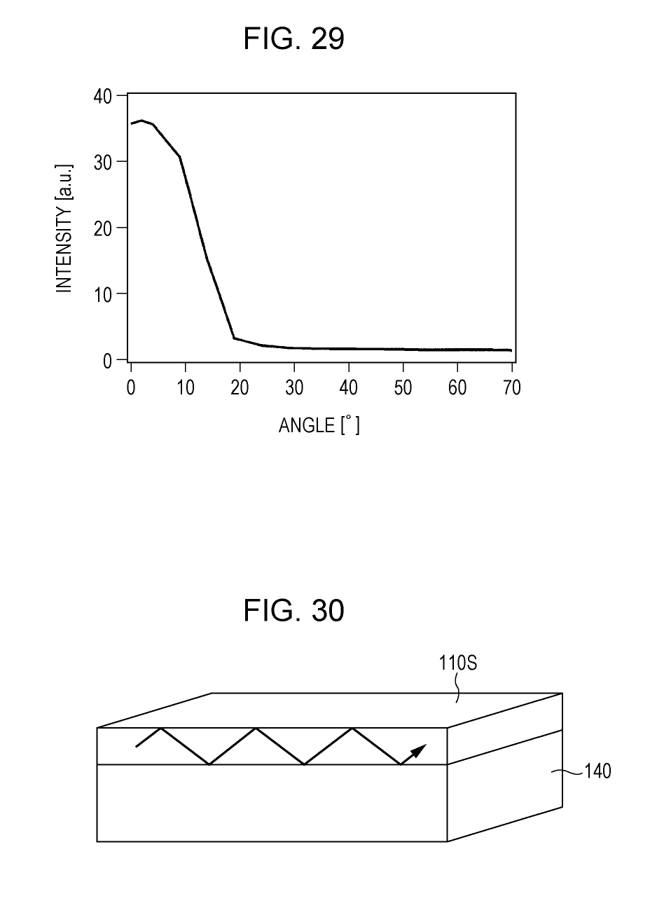

Among the above results of measurements, for example, FIG. 29 shows the angular dependence of the intensity of light having a wavelength of 610 nm for rotation about an axis perpendicular to the line direction. As shown in FIG. 29, the light was significantly enhanced in the front direction and was little enhanced at other angles. The directional angle of the light output in the front direction is less than 15 degrees. The directional angle is the angle at which the intensity is 50% of the maximum intensity and is expressed as the angle of one side with respect to the direction with the maximum intensity. This demonstrates that directional light emission was achieved. In addition, all the light was the TM mode, which demonstrates that polarized light emission was simultaneously achieved.

Although YAG:Ce, which emits light in a wide wavelength range, was used in the above experiment, directional and polarized light emission can also be achieved using a similar structure including a photoluminescent material that emits light in a narrow wavelength range. Such a photoluminescent material does not emit light of other wavelengths and can therefore be used to provide a light source that does not emit light in other directions or in other polarized states.

### 7. Embodiments for Improving Absorption Efficiency of Excitation Light

An embodiment for allowing the photoluminescent layer 110 to efficiently absorb excitation light will be described below.

A structure that allows excitation light to enter the photoluminescent layer 110 may be the structure illustrated in FIG. 16. In the structure illustrated in FIG. 16, excitation light almost perpendicularly enters the photoluminescent layer 110. Thus, most of the excitation light passes through the photoluminescent layer 110, and the absorption efficiency may not be improved. Isolation and utilization of part of excitation light (for example, white light from blue excitation light and yellow fluorescence) causes no problem; otherwise the photoluminescent material should absorb as much excitation light as possible. Thus, an embodiment for improving the absorption efficiency of excitation light will be described below.

### First Embodiment

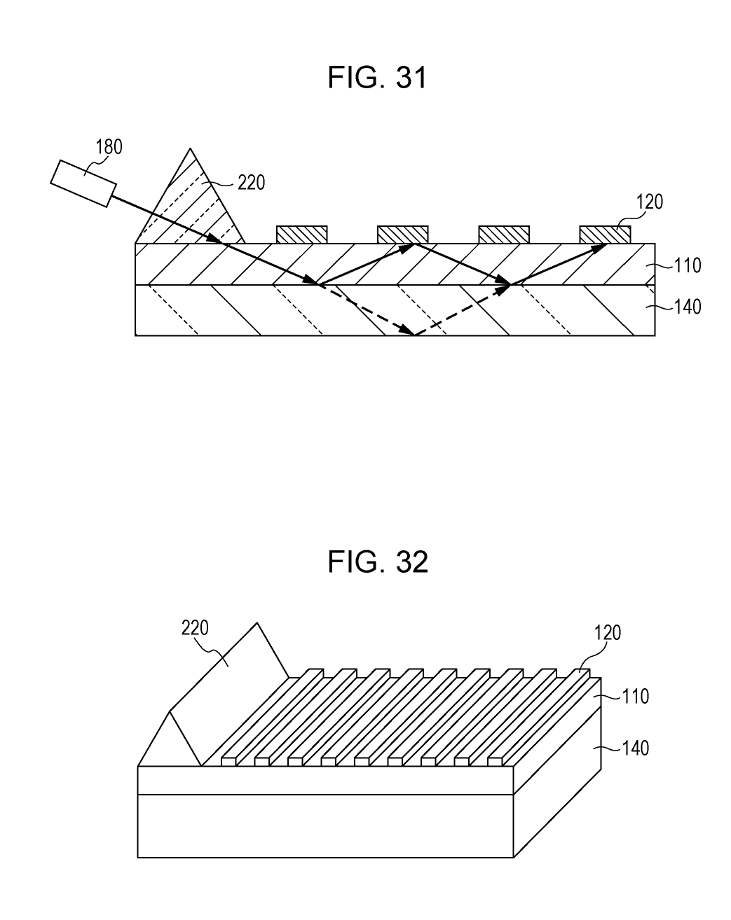

FIG. 31 is a schematic fragmentary cross-sectional view of a light-emitting apparatus according to a first embodiment. FIG. 32 is a schematic perspective view of part of the light-emitting apparatus. In addition to the transparent subs a e 140, the photoluminescent layer 110, and the periodic structure 120, the light-emitting apparatus further includes a light guide 220. The light guide 220 functions as an excitation light guide that directs excitation light from the light source 180 to the photoluminescent layer 110. As indicated by arrows in FIG. 31, excitation light from the light source 180 enters the photoluminescent layer 110 through the light guide 220 and propagates through the photoluminescent layer 110. If light enters the transparent substrate 140, as indicated by a broken line in FIG. 31, light can also propagate through the transparent substrate 140.

The light guide 220 is located on a surface of the photoluminescent layer 110 on which the periodic structure 120 is located. Thus, excitation light can enter the surface of the photoluminescent layer 110 on which the periodic structure 120 is located and can be confined in the photoluminescent layer 110. The light guide 220 is composed of a triangular prismatic light-transmissive member (triangular prism). The light guide 220 in this embodiment extends in a direction parallel to the line direction of the periodic structure 120 (that is, the longitudinal direction of the projections). The material of the light guide 220 may be any of the materials exemplified as the material of the periodic structure 120.

In FIGS. 31 and 32, each component does not necessarily have its actual size. For example, the light guide 220 may have a width of at least 10 times the period of the periodic structure 120. The width of the light guide 220 is the base length of a triangular cross section of the light guide 220 in FIG. 31. For example, the light guide 220 may have a width in the range of micrometers to millimeters.

The light guide 220 allows excitation light from the light source 180 to enter the photoluminescent layer 110 at a predetermined incident angle. The incident angle is determined such that total reflection occurs at the interface between the photoluminescent layer 110 and the transparent substrate 140 or the interface between the transparent substrate 140 and an external air layer. This allows excitation light to be confined in the photoluminescent layer 110 or in the photoluminescent layer 110 and the transparent substrate 140. This can improve the luminous efficiency of the photoluminescent layer 110.

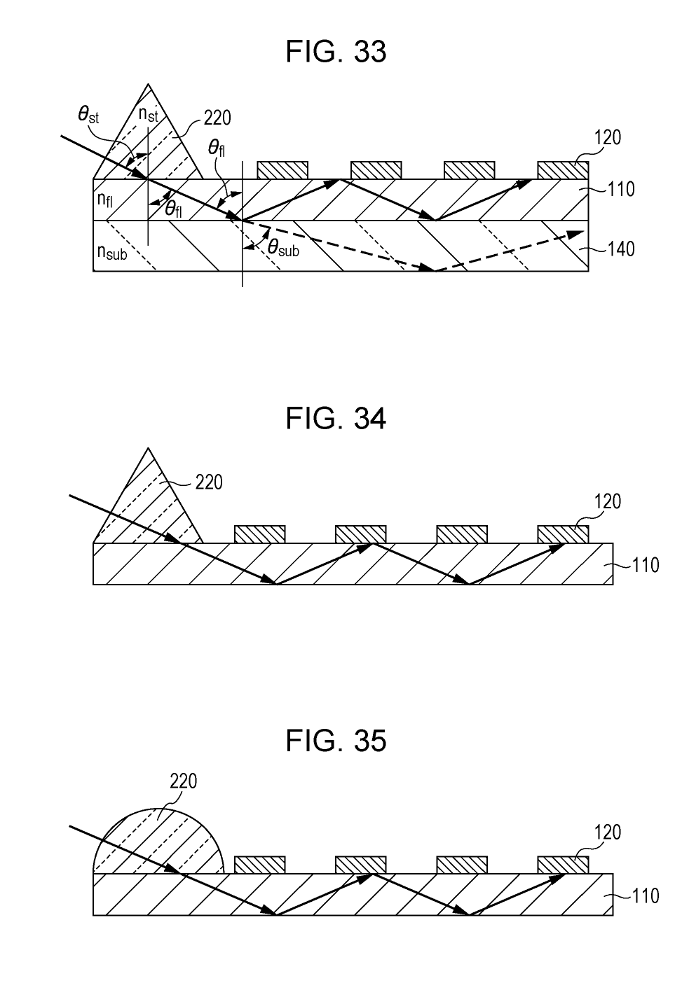

FIG. 33 is an explanatory view of the conditions for confinement of excitation light by total reflection. The light guide 220 has a refractive index nₛₜ, the photoluminescent layer 110 has a refractive index n_{fl}, the transparent substrate 140 has a refractive index n_{sub}, and excitation light from the light guide 220 has an incident angle θₛₜ and an output angle θ_{fl} on the photoluminescent layer 110. Excitation light emitted from the photoluminescent layer 110 has an incident angle θ_{fl} and an output angle θ_{sub} on the transparent substrate 140.

The condition for confinement of excitation light in the photoluminescent layer 110 is represented by the following formula (18).

nₛₜ sin(θₛₜ)=n_{fl} sin(θ_{fl})>n_{sub} (18)

The condition for confinement of excitation light in the photoluminescent layer 110 and the transparent substrate 140 is represented by the following formula (19).

nₛₜ sin(θₛₜ)=n_{fl} sin(θ_{fl})=n_{sub} sin(θ_{sub})>1 (19)

Thus, if the output angle of excitation light from the light source 180 and the refractive index and shape of the light guide 220 are determined so as to satisfy the formula (19), the excitation light can be confined by total reflection in a region including the photoluminescent layer 110. This promotes light emission from the photoluminescent layer 110 and improves emission efficiency.

The structure and position of the light guide 220 are not limited to those described above and may be modified. For example, the light guide 220 is not limited to a single structure and may be an array of prisms. If the light guide 220 is an array of prisms, each prism is not limited to a triangular prism and may be a square, hemispherical, or conical prism. The light guide 220 is not necessarily located on a surface of the photoluminescent layer 110 on which the periodic structure 120 is located, and may be located on the other surface. More specifically, excitation light can enter the surface of the photoluminescent layer 110 opposite the periodic structure 120 and can be confined in the photoluminescent layer 110.

FIGS. 34 to 38 are schematic fragmentary cross-sectional views of other embodiments of the light guide 220. FIG. 34 illustrates the same structure as FIG. 31 except that the transparent substrate 140 is removed. Also in this embodiment, if the refractive index nₛₜ of the light guide 220 and the incident direction of excitation light satisfy nₛₜ sin(θₛₜ)>1 the excitation light can be confined in the photoluminescent layer 110.

In FIG. 35, the light guide 220 is composed of a hemispherical light-transmissive member. In this embodiment, excitation light emitted toward the center of the sphere is not influenced by refraction, thus making it easy to adjust the angle.

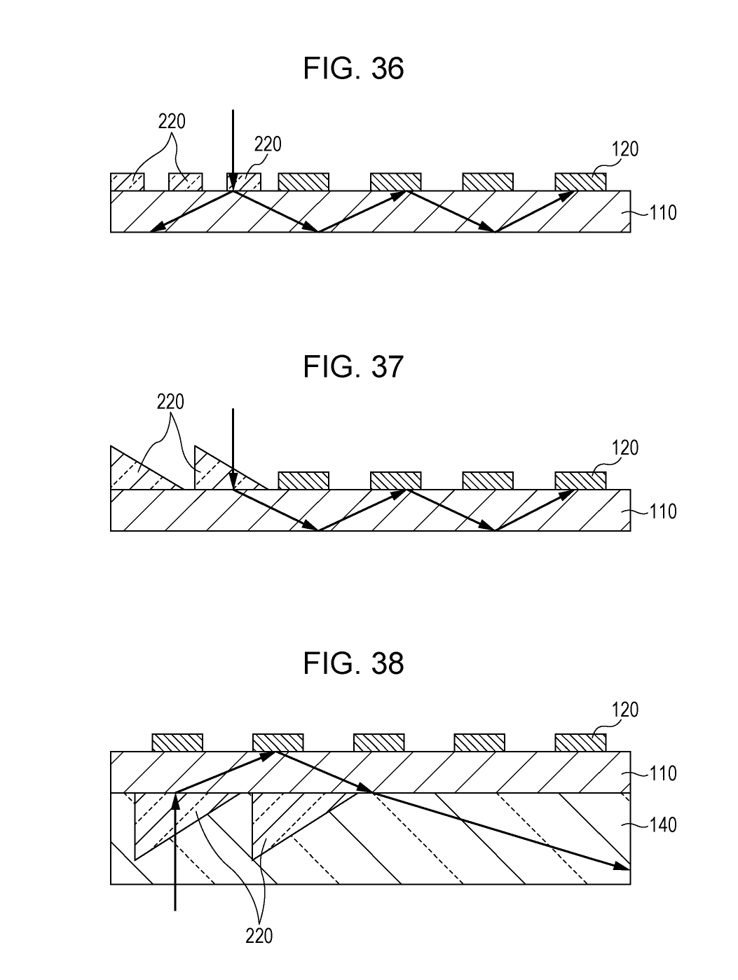

In FIG. 36, the light guide 220 is composed of a diffraction grating. The diffraction grating is composed of light-transmissive members having a textured surface arranged in the array direction of the periodic structure 120 (that is, in the horizontal direction in the figure). In this embodiment, excitation light enters the diffraction grating such that diffracted light propagates through the photoluminescent layer 110. Although excitation light perpendicularly enters the photoluminescent layer 110 in the figure, the incident angle is not limited to this. It is desirable that the diffraction grating have a period that produces resonance with excitation light.

In FIG. 37, the light guide 220 is composed of a blazed diffraction grating. The blazed diffraction grating can enhance the intensity of diffracted light of a certain order. The blazed diffraction grating is composed of triangular prismatic light-transmissive members arranged in the array direction of the periodic structure 120 (that is, in the horizontal direction in the figure). In this embodiment, excitation light enters the blazed diffraction grating such that diffracted light propagates strongly through the photoluminescent layer 110 in the direction of the periodic structure 120. Although excitation light perpendicularly enters the photoluminescent layer 110 in the figure, the incident angle is not limited to this.

In FIG. 38, the light guide 220 composed of a blazed diffraction grating is located on the back side of the photoluminescent layer 110 (opposite the periodic structure 120). In this embodiment, the photoluminescent layer 110 is located on the transparent substrate 140. The light guide 220 is located in the transparent substrate 140. Also in this embodiment, excitation light enters the blazed diffraction grating such that diffracted light propagates through the photoluminescent layer 110 (or the transparent substrate 140). The incident direction of excitation light is not necessarily perpendicular to the photoluminescent layer 110 and may be an inclined direction. Not only the blazed diffraction grating but also the diffraction grating as illustrated in FIG. 36 may be located on the back side of the photoluminescent layer 110.

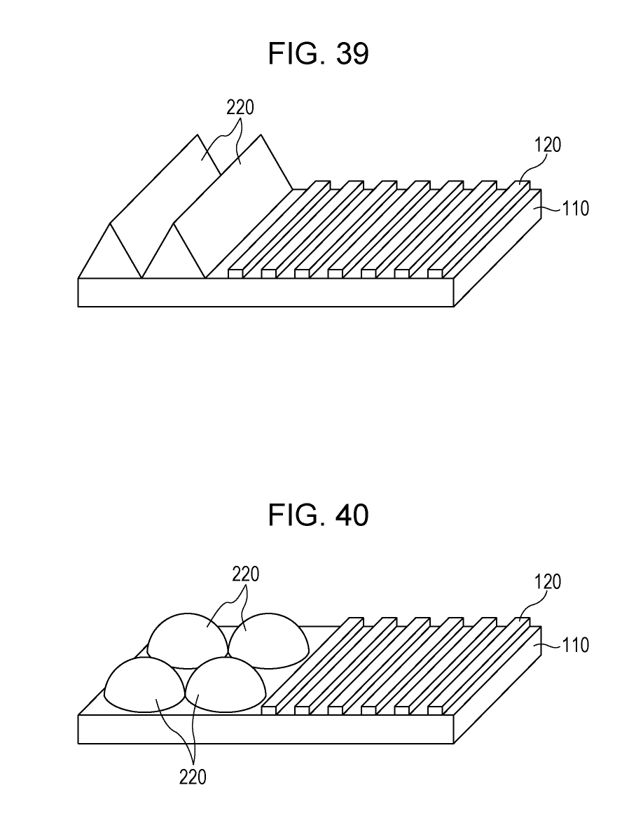

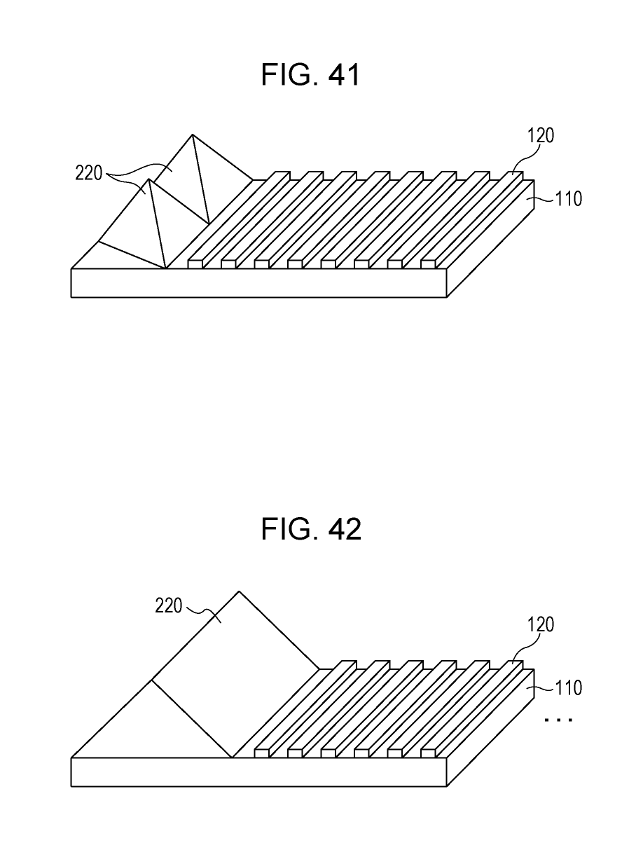

FIGS. 39 to 41 are perspective views of other light guides each composed of light-transmissive members. In FIG. 39, the light guide 220 are composed of an array of triangular prisms arranged in the same direction as the array direction of the periodic structure 120. In FIG. 40, the light guide 220 is composed of an array of two-dimensionally arranged hemispherical prisms. In FIG. 41, the light guide 220 is composed of an array of pyramidal prisms arranged along the projections of the periodic structure 120. In these embodiments, excitation light can efficiently enter the photoluminescent layer 110.

The number of light-transmissive members of the light guide 220 is not limited to and may be greater than the number in the figures. The array direction of the light-transmissive members is not limited to the direction in the figures. However, if the light-transmissive members are evenly arranged parallel to or perpendicular to the array direction of the periodic structure 120, excitation light can be easily absorbed by the entire photoluminescent layer 110, which is a thin film phosphor.

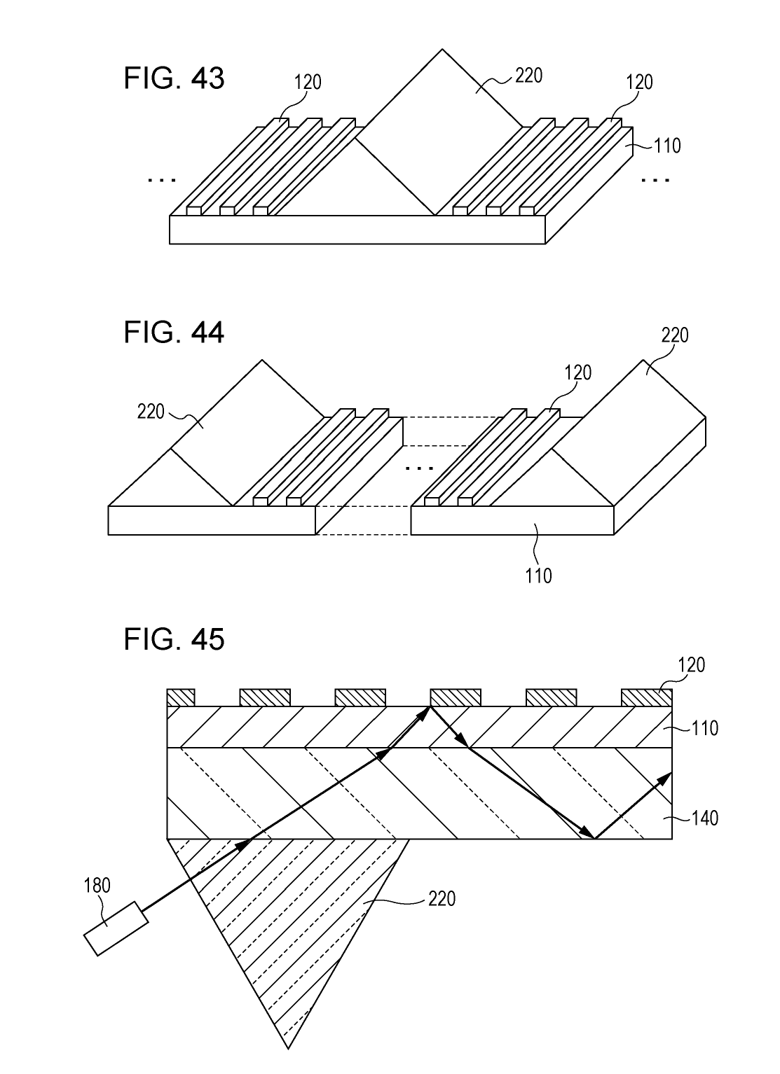

FIGS. 42 to 44 are explanatory views of the position of the light guide 220. The light guide 220 may be located at one end of the photoluminescent layer 110, as illustrated in FIG. 42, or between the projections of the periodic structure 120 (for example, near the center of the photoluminescent layer 110), as illustrated in FIG. 43. The light guide 220 may be located at each end of the photoluminescent layer 110, as illustrated in FIG. 44. In these positions, excitation light can be confined in the photoluminescent layer 110.

### Second Embodiment

FIG. 45 is a schematic fragmentary cross-sectional view of a light-emitting apparatus including a light guide 220 according to a second embodiment. This light-emitting apparatus is different from the first embodiment in that the light guide 220 is located on the transparent substrate 140 opposite the photoluminescent layer 110. Thus, the light guide 220 is located on part of the interface between the transparent substrate 140 and the external medium (for example, air). Thus, excitation light from the light source 180 can enter the photoluminescent layer 110 through the transparent substrate 140 opposite the periodic structure 120 and can be confined in the photoluminescent layer 110.

In the embodiment illustrated in FIG. 45, the light guide 220 is a triangular prism having a triangular prismatic shape. As described in the first embodiment, the light guide 220 may have another structure, such as a hemisphere, pyramid, diffraction grating, or blazed diffraction grating. The light guide 220 may be composed of light-transmissive members.

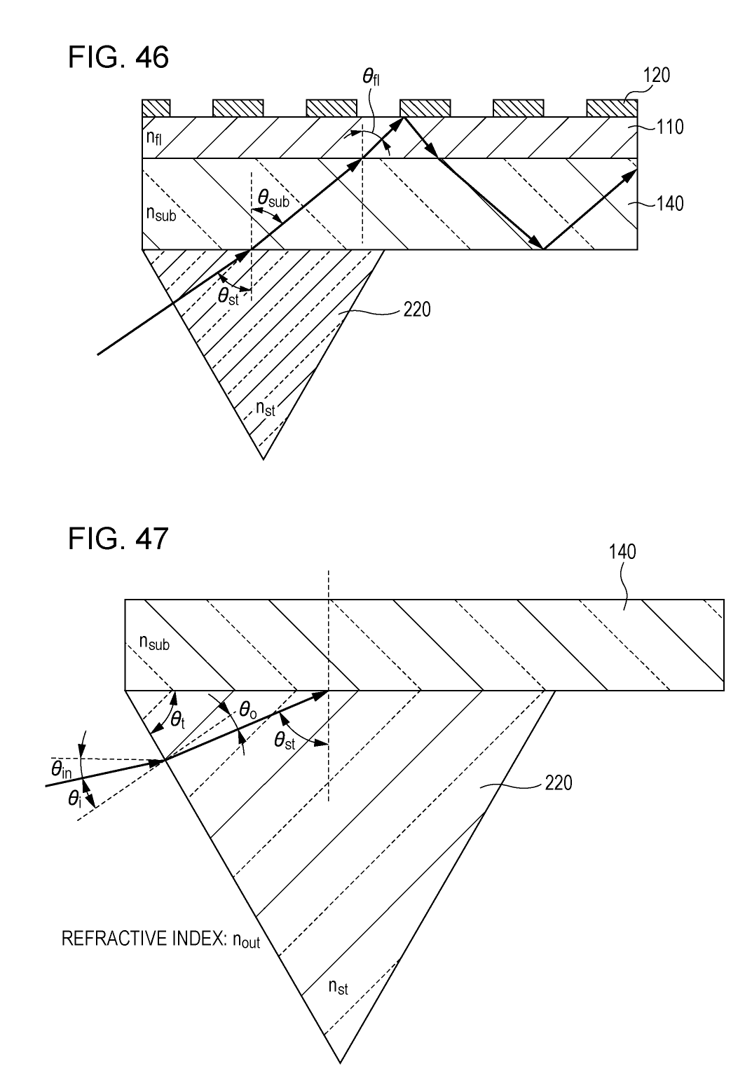

FIG. 46 is an explanatory view of the incident angle of excitation light in the present embodiment. Excitation light has an incident angle θₛₜ and an output angle θ_{sub} at the interface between the light guide 220 and the transparent substrate 140 and an output angle θ_{fl} at the interface between the transparent substrate 140 and the photoluminescent layer 110. As in the first embodiment, the light guide 220 has a refractive index nₛₜ, the transparent substrate 140 has a refractive index n_{sub}, and the photoluminescent layer 110 has a refractive index n_{fl}. The condition for propagation of light through the photoluminescent layer 110 is represented by the following formula (20).

nₛₜ sin(θₛₜ)=n_{sub} sin(θ_{sub})=n_{fl} sin(θ_{fl})>1 (20)

Thus, the light source 180 is configured to emit excitation light toward the light guide 220 in such a manner as to satisfy the formula (20).

FIG. 47 is a detailed explanatory view of the output direction of excitation light from the light source 180. In FIG. 47, for the sake of simplicity, components other than the transparent substrate 140 and the light guide 220 are omitted. Excitation light has an incident angle θᵢ and an output angle θₒ at the interface between the outside atmosphere (for example, air) having a refractive index nₒᵤₜ and the light guide 220. The incident direction of excitation light on the light guide 220 forms an angle θᵢₙ with respect to the transparent substrate 140. A triangular cross-section of the light guide 220 has a vertex angle θₜ.

The following relations hold in this embodiment.

θᵢₙ=90−(θₜ+θᵢ)

θₛₜ=θₜ+θₒ

nₒᵤₜ sin(θᵢ)=nₛₜ sin(θₒ)

The conditions for the angles θᵢ and θᵢₙ are determined from these relations and the condition represented by the formula (20). For example, nₛₜ=1.5 and θₜ=60 degrees result in the condition θᵢₙ<56.8.

If the light guide 220 is a hemispherical light-transmissive member, excitation light emitted toward the center of the sphere is ideally not refracted, and θᵢₙ=θₒ in the formulae described above.

### Third Embodiment

A third embodiment for improving the absorption efficiency of excitation light will be described below. A light-emitting apparatus according to the present embodiment effectively couples excitation light into a quasi-guided mode and thereby improves luminous efficiency.

FIG. 48 is a schematic cross-sectional view illustrating light emitted from the photoluminescent layer 110 coupled into a quasi-guided mode and output. The diffraction phenomenon depends on the wavelength. If light having a particular wavelength is most strongly emitted in the direction normal to the photoluminescent layer 110, light having an her wavelength is most strongly emitted in an inclined direction (oblique direction) relative to the direction normal to the photoluminescent layer 110. In FIG. 48, red light (R) is most strongly emitted in a direction perpendicular to the photoluminescent layer 110, and green light (G) and blue light (B) are emitted in different directions from the red light (R). In this embodiment, light propagating through the photoluminescent layer 110 has an incident angle θᵢₙ and blue light (B) is most strongly emitted at an output angle θₒᵤₜ.

This means that excitation light having the same wavelength as the blue light (B) incident on the photoluminescent layer 110 at the incident angle θₒᵤₜ undergoes resonance absorption in a thin film phosphor of the photoluminescent layer 110. Utilizing this effect, the absorption efficiency of excitation light can be improved without the light guide 220. The resonance condition is represented by the following formula (21), wherein p denotes the period of the periodic structure 120, and λₑₓ denotes the wavelength of excitation light in air.

p nᵢₙ sin(θᵢₙ)−p nₒᵤₜ sin(θₒᵤₜ)=mλₑₓ(m is an integer) (21)

Thus, as illustrated in FIG. 49, the excitation light source 180 in the light-emitting apparatus according to the present embodiment is configured to allow excitation light having a wavelength λₑₓ in air to enter the photoluminescent layer 110 at an incident angle θₒᵤₜ. The excitation light source 180 may allow excitation light to enter not only a surface of the photoluminescent layer 110 on which the periodic structure 120 is located but also the other surface of the photoluminescent layer 110 at an incident angle θₒᵤₜ.

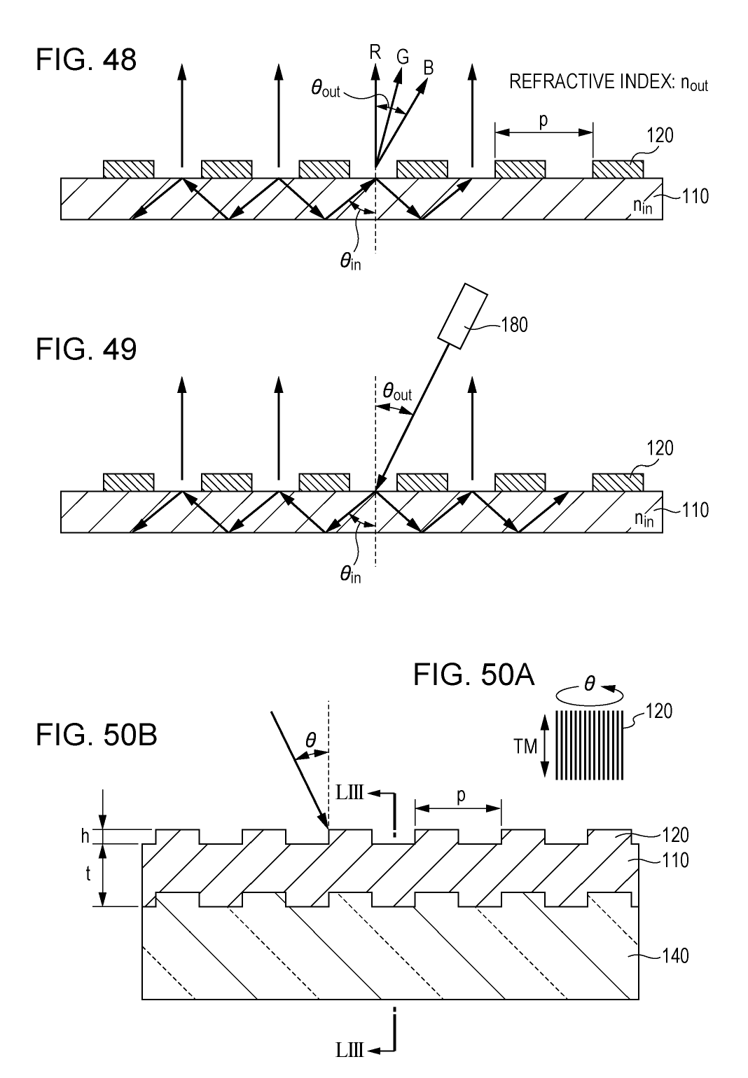

In order to examine the effect of resonance absorption, the present inventors calculated the dependence of the absorptivity of excitation light on the incident angle. FIG. 50B is a fragmentary cross-sectional view of a light-emitting device used for the calculation. This light-emitting device includes a transparent substrate 140 having one-dimensional periodic structure on its surface and a photoluminescent layer 110 containing a phosphor and located on the transparent substrate 140. The photoluminescent layer 110 has a one-dimensional periodic structure 120 on its surface.

In the calculation, the photoluminescent layer 110 had a refractive index of 1.77 and an absorption coefficient of 0.03, and the transparent substrate 140 had a refractive index of 1.5 and an absorption coefficient of 0. The periodic structure 120 had a height h of 40 nm, and the photoluminescent layer 110 had a thickness of 185 nm. The periodic structure 120 had a period p of 400 nm. These conditions were determined such that red light having a wavelength of approximately 620 nm is emitted in the direction normal to the photoluminescent layer 110. The electric field of excitation light was in a TM mode in which the electric field oscillates parallel to the projections of the periodic structure 120 (in the line direction). As illustrated in FIG. 50A, the incident angle θ corresponds to the rotation angle of the periodic structure 120 rotated about an axis parallel to the line direction of the periodic structure 120. This is because, as shown in FIGS. 28A and 28B, rotation about an axis perpendicular to the line direction does not cause resonance at the wavelength of excitation light (for example, 450 or 405 nm). The absorptivity of light in the photoluminescent layer 110 as a function of the incident angle θ and the wavelength λ was calculated for light entering the periodic structure 120 from the air.

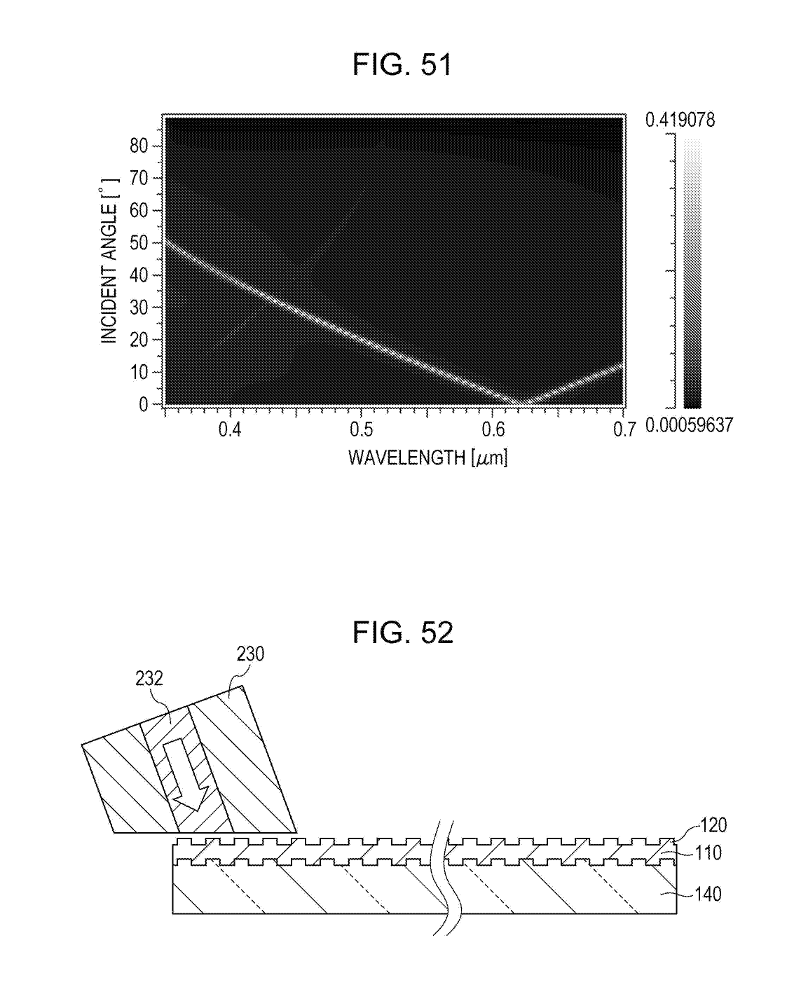

FIG. 51 is a graph of the calculation results. In this graph, a lighter color indicates higher absorptivity. Because the light-emitting device is configured to emit red light of approximately 620 nm in a direction perpendicular to the photoluminescent layer 110, the absorptivity is also high at approximately 620 nm due to resonance. At a wavelength of 450 nm, resonance absorption occurs at an incident angle of approximately 28.5 degrees. Thus, the incident angle of excitation light having a wavelength of 450 nm can be approximately 28.5 degrees. The incident angle of excitation light having a wavelength of 405 nm can be approximately 37 degrees.

A method for allowing excitation light to enter the photoluminescent layer 110 at a particular incident angle may be a method utilizing an optical fiber, for example, as disclosed in F. V. Laere et al., IEEE J. Lightwave Technol. 25, 151 (2007). FIG. 52 is a schematic view of a light-emitting apparatus that includes such an optical fiber 230 as a light guide. In this embodiment, the optical fiber 230 has an oblique end and is placed at an end of a light-emitting device. Excitation light propagating through a core 232 can obliquely enter the photoluminescent layer 110. The optical fiber 230 is not necessarily placed at an end of the photoluminescent layer 110 and may be placed in another position on the photoluminescent layer 110.

Even if the structure described above is employed, most of excitation light still passes through the photoluminescent layer 110 and the transparent substrate 140. Thus, a structure for improving absorption efficiency was studied in which the incident angle on the photoluminescent layer 110 was determined so as to cause resonance absorption while excitation light is confined in the transparent substrate 140.

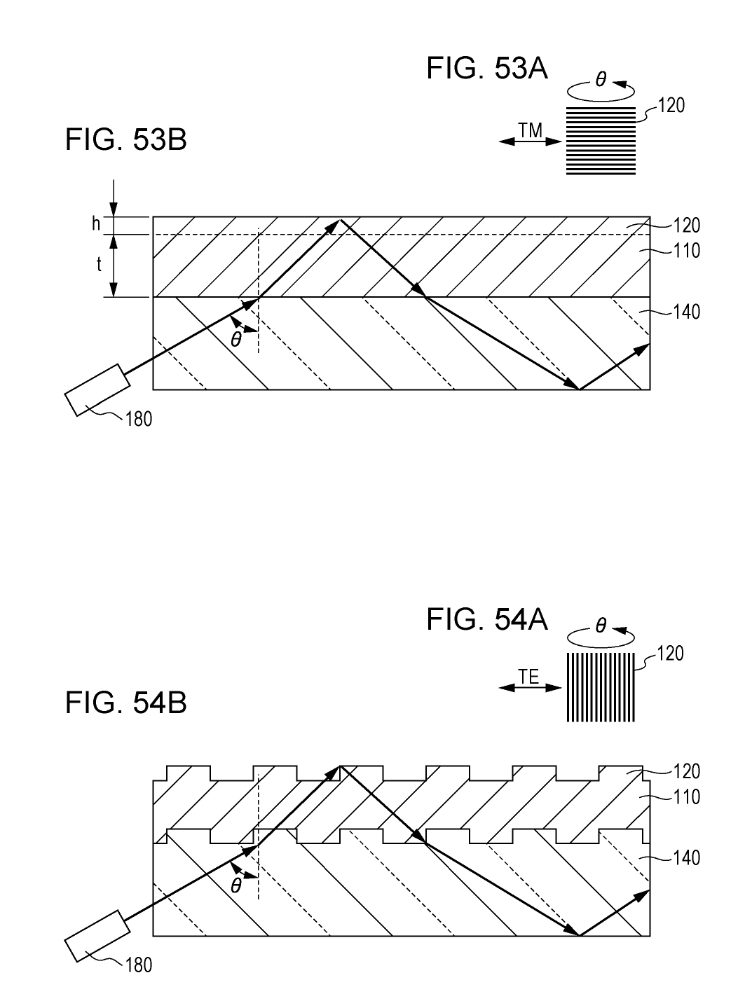

FIG. 53B is a fragmentary cross-sectional view of such a structure. FIG. 53B is a cross-sectional view taken along the line LIII-LIII in FIG. 50B. In this embodiment, the light source 180 emits excitation light toward the transparent substrate 140. The dependence of the absorptivity of excitation light on the incident angle was calculated for the structure. Also in this calculation, the electric field of incident light was in the TM mode in which the electric field oscillates parallel to the line direction of the periodic structure 120. In this embodiment, as illustrated in FIG. 53A, the incident angle θ at the interface between the photoluminescent layer 110 and the transparent substrate 140 corresponds to the rotation angle of the periodic structure 120 rotated about an axis perpendicular to the line direction of the periodic structure 120. This is because rotation about an axis parallel to the line direction results in a resonance angle lower than the total reflection angle at the wavelength of excitation light (for example, 450 or 405 nm), thus failing to confine the excitation light.

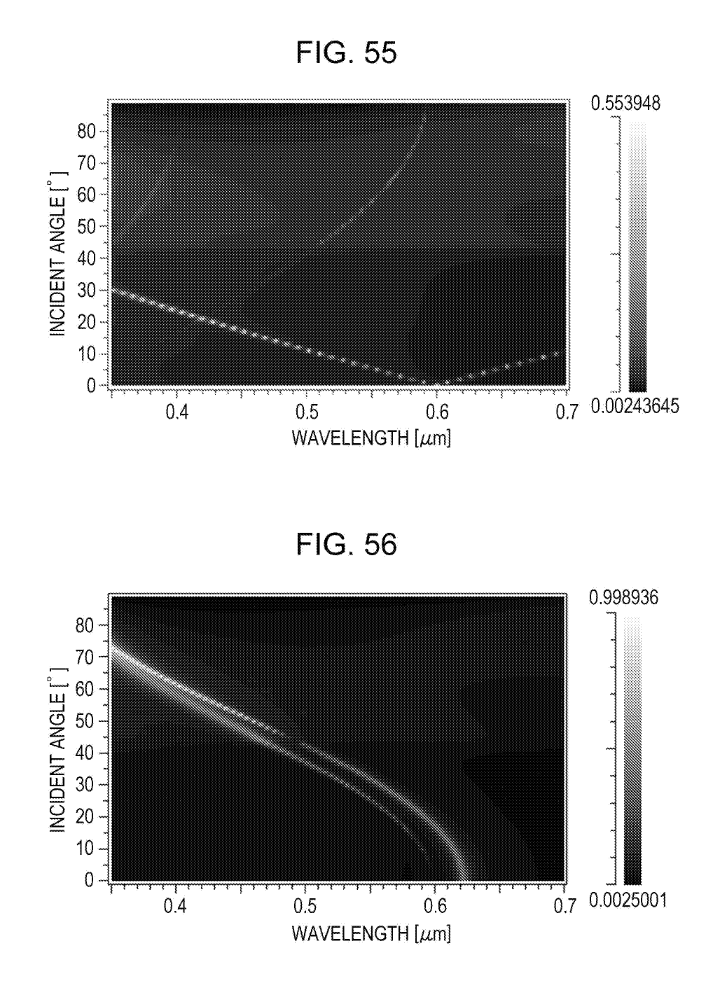

FIG. 54B is a schematic cross-sectional view of a structure in which the incident angle θ is the rotation angle of the periodic structure 120 rotated about an axis parallel to the line direction of the periodic structure 120. FIG. 55 is a graph of the calculation results with respect to the dependence of the absorptivity of excitation light on the incident angle θ and wavelength λ in air. The calculation conditions of FIG. 55 are the same as the calculation conditions of FIGS. 50A and 50B and FIG. 51 except that the incident light was in the TE mode. The results of FIG. 55 show that the angle for resonance absorption is lower than the total reflection angle (approximately 42 degrees in this embodiment).

In the embodiment illustrated in FIGS. 53A and 53B, therefore, the rotation angle of the one-dimensional periodic structure 120 rotated about an axis perpendicular to the line direction of the one-dimensional periodic structure 120 is assumed to be the incident angle θ. In the structure illustrated in FIG. 53B, the absorptivity of excitation light was calculated as a function of the incident angle θ and the wavelength λ in air. The calculation conditions were the same as the calculation conditions of FIGS. 50A and 50B and FIG. 51.

FIG. 56 is a graph of the calculation results. At a wavelength of 450 nm, resonance absorption occurs at an incident angle θ of approximately 52 degrees. Thus, when the excitation light has a wavelength of 450 nm, excitation light can be emitted parallel to the line direction of the periodic structure 120 and at an incident angle θ of approximately 52 degrees. When the excitation light source has a wavelength of 405 nm, excitation light can be emitted parallel to the line direction of the periodic structure 120 and at an incident angle θ of approximately 61.6 degrees. The results of FIG. 56 show that the structure can further improve the absorption efficiency of excitation light.

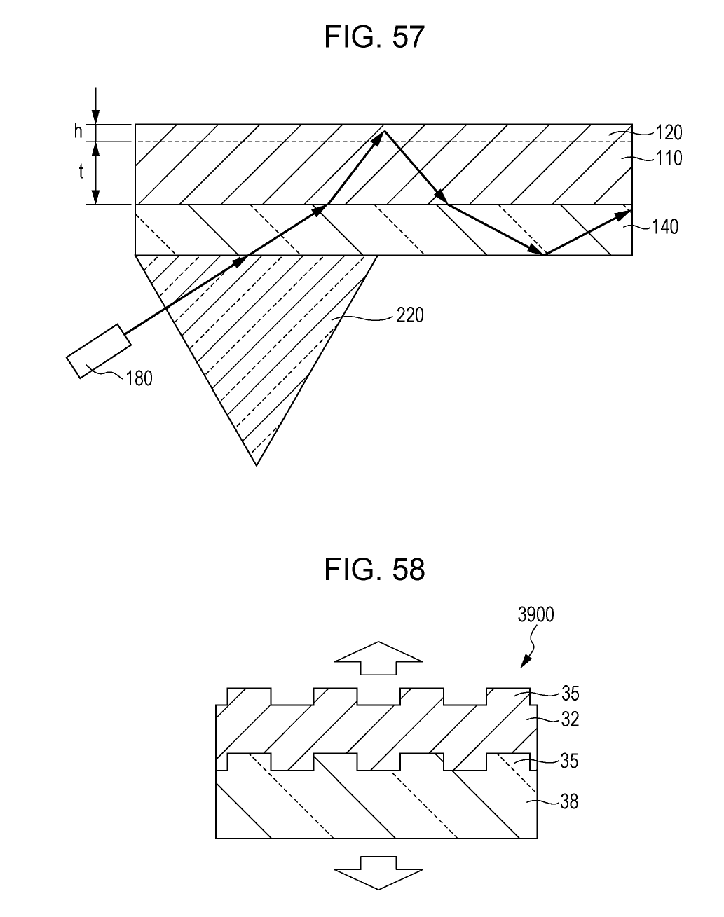

In the present embodiment, excitation light may enter the transparent substrate 140 through the light guide 220 as described in the first embodiment or the second embodiment. In the structure illustrated in FIG. 53B, in order to make the incident angle θ for resonance absorption higher than the total reflection angle, it is effective to provide the light guide 220 as described in the second embodiment. More specifically, as illustrated in FIG. 57, the light guide 220 that allows excitation light to enter the transparent substrate 140 may be provided such that the excitation light contains no component propagating in a direction perpendicular to both the line direction of the periodic structure 120 and the thickness direction of the photoluminescent layer 110 (perpendicular to the drawing in FIG. 57). In such a case, the light guide 220 extends in a direction perpendicular to both the line direction of the periodic structure 120 and the thickness direction of the layer 110. This can improve the absorptivity of excitation light in the photoluminescent layer 110 and allows excitation light to be confined in the photoluminescent layer 110 and the transparent substrate 140. The light guide 220 is not necessarily a triangular prism and may have another shape. Also in the structures according to the first and second embodiments, the light guide 220 may extend in a direction perpendicular to both the line direction of the periodic structure 120 and the thickness direction of the layer 110.

As described above, in the periodic structure (submicron structure) 120 according to the present embodiment, first light having a wavelength λₐ in air is most strongly emitted in the direction normal to the photoluminescent layer 110, and second light having a wavelength λₑₓ propagating through the photoluminescent layer 110 is most strongly emitted at an angle θₒᵤₜ with respect to the direction normal to the photoluminescent layer 110. The light source 180 and/or the light guide 220 is configured to allow excitation light to enter the photoluminescent layer 110 at the incident angle θₒᵤₜ. Such a structure allows resonance absorption of excitation light in the photoluminescent layer 110 and can further improve luminous efficiency.

8. Embodiments in which Reflective Layer is Located on One Side of Light-Emitting Device

FIG. 58 is a cross-sectional view of a light-emitting apparatus 3900 including a photoluminescent layer 32. As illustrated in FIG. 58, the light-emitting apparatus 3900 includes a periodic structure 35 on a surface of the photoluminescent layer 32 and at the interface between the photoluminescent layer 32 and a transparent substrate 38. By the action of the periodic structure 35, directional light is emitted in a particular direction (for example, in the direction normal to the photoluminescent layer 32). The directional light is emitted from both the front side and the back side of the light-emitting apparatus 3900.

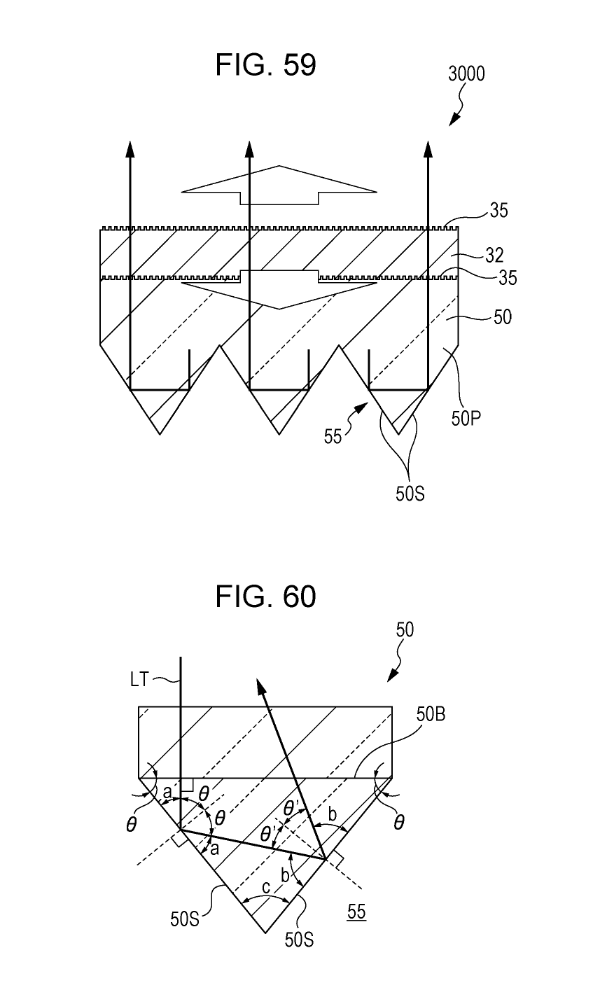

In general applications, it is often desirable to emit light only from one of the light output sides of the light-emitting device including the photoluminescent layer 32. As illustrated in FIG. 59, therefore, a light-emitting apparatus 3000 according to the present embodiment includes a reflective layer 50 for reflecting light emitted from the photoluminescent layer 32 on one side (the back side) of the photoluminescent layer 32.

In the light-emitting apparatus 3000, the reflective layer 50 is formed of a light-transmissive material and may include a horizontally placed triangular prism 50P having a triangular cross section as illustrated in the figure. The triangular prism 50P may be parallel to striped periodic structure 35 or may extend in another direction (for example, in an orthogonal direction). In the present specification, the side of the light-emitting device (or the photoluminescent layer 32) on which the reflective layer 50 is located is sometimes referred to as the back side, and the opposite side of the light-emitting device (or the photoluminescent layer 32) is sometimes referred to as the front side.

Although the periodic structure 35 is located on the front surface of the photoluminescent layer 32 and at the interface between the photoluminescent layer 32 and the reflective layer 50 in FIG. 59, the periodic structure 35 may be located in the form as described above. For example, the periodic structure 35 may be located only on the front side of the photoluminescent layer 32. In order to appropriately form a quasi-guided mode, the refractive index of the reflective layer 50 may be smaller than the refractive index of the photoluminescent layer 32. In the present embodiment, the reflective layer 50 may function as a substrate for supporting the photoluminescent layer 32.

The triangular prism 50P includes two belt-like inclined surfaces 50S exposed to the external medium (for example, air) 55. These inclined surfaces 50S are differently inclined and cross at a refracting edge. The refractive index n1 of the triangular prism 50P is greater than the refractive index n2 of the external medium 55. Thus, light emitted from the photoluminescent layer 32 toward the back side and propagating through the triangular prism 50P can be totally reflected from the two inclined surfaces 50S.

In this structure, at least part of light emitted toward the back side of the photoluminescent layer 32 is reflected from the reflective layer 50 toward the photoluminescent layer 32. This can increase the amount of light emitted from the front side of the light-emitting device including the photoluminescent layer 32.

In the structure illustrated in FIG. 59, excitation light may enter the photoluminescent layer 32 from the back side of the reflective layer 50 through the reflective layer 50. As described in [7. Embodiments for Improving Absorption Efficiency of Excitation Light], the absorption efficiency of excitation light can be improved by irradiating the prism 50P with the excitation light at an appropriate incident angle in an oblique direction with respect to a surface of the photoluminescent layer 32. In such a structure, the reflective layer 50 also functions as a “light guide”.

The reflective layer 50 is not limited to the triangular prism 50P and may have a lenticular lens. The reflective layer 50 may have pyramid-like (pyramidal) or conical projections or fine projections and/or recesses, such as a microlens array or a corner cube array (a retroreflection structure having a projection and a recess as unit structures, each of the projection and recess having three orthogonal planes). In the reflective layer 50, the pitch of the striped or dotted texture may be much greater than the pitch of the periodic structure and may range from approximately 10 to 1000 The texture of the reflective layer 50 may be formed of an organic material, such as an acrylic resin, a polyimide resin, or an epoxy resin, or an inorganic material, such as SiO₂ or TiO₂. The texture of the reflective layer 50 may be formed of another material.

The texture may be directly formed on the back side of a transparent substrate used as the reflective layer 50. The transparent substrate may be a glass substrate or a plastic substrate. The material of the glass substrate may be quartz glass, soda-lime glass, or non-alkali glass. The material of the plastic substrate may be poly(ethylene terephthalate), poly(ethylene naphthalate), polyethersulfone, or polycarbonate. When a plastic substrate is used, a SiON film or a SiN film may be formed on the plastic substrate. Such a film can effectively suppress moisture permeation. The transparent substrate may be rigid or flexible. A texture, such as a prism or lens, may be formed on the back side of these transparent substrates by a known surface machining method.

In the embodiment illustrated in FIG. 59, although the reflective layer 50 includes a base (thickness portion) for supporting the triangular prism 50P, the reflective layer 50 may not include a base. The reflective layer 50 may include substantially no base and may be composed of projections in contact with the photoluminescent layer 32. A transparent buffer layer may be located between the reflective layer 50 and the photoluminescent layer 32.

FIG. 60 is an explanatory view of the inclination angle θ of inclined surfaces (reflective surfaces) 50S of the triangular prism of the reflective layer 50. As illustrated in the figure, the inclination angle θ of the inclined surfaces 50S is defined as the angle of the inclined surfaces 50S with respect to the bottom 50B of the prism (or a surface of the photoluminescent layer). In this embodiment, the two inclined surfaces 50S have the same inclination angle θ. If the two inclined surfaces 50S have the same inclination angle, the cross section of the triangular prism is an isosceles triangle.

The reflectance of light LT emitted from the back side of the photoluminescent layer 32 depends on the inclination angle θ of the prism. In order to achieve high reflectance, it is desirable that the inclination angle θ satisfy θ>arcsin(n2/n1) according to Snell's law, wherein n1 denotes the refractive index of the reflective layer 50, and n2 denotes the refractive index of a medium 55 outside the reflective layer 50 (for example, air). This formula represents the condition under which incident light LT emitted from the photoluminescent layer 32 in a direction perpendicular to the bottom 50B of the prism is incident on the inclined surfaces 50S at an angle greater than or equal to the critical angle and is totally reflected from the interface between the inclined surfaces 50S and the external medium 55.

As illustrated in FIG. 60, light LT totally reflected from one of the inclined surfaces 50S is totally reflected from the other inclined surface 50S at an incident angle θ′. In the figure, the sum of the interior angles of a tetragon defined by the path of the light LT and a horizontal line of the bottom 50B is 90 degrees+2θ+2θ′+(θ+b)=360 degrees, that is, 3θ+2θ′+b=270 degrees, Because b+θ′=90 degrees, the above equation yields 3θ+θ′=180 degrees or θ′=180 degrees−3θ.

For total reflection from the other inclined surface 50S, the incident angle θ′ must be greater than the critical angle, that is, θ′>arcsin(n2/n1). Substituting θ′=180 degrees−3θ into the formula yields 180 degrees−arcsin(n2/n1)>3θ. Under this condition, total reflection also occurs on the other inclined surface 50S. Thus, in order to return the light LT emitted from the light-emitting device by total reflection from the two inclined surfaces 50S of the prism, it is desirable that 0 satisfy arcsin(n2/n1)<θ<60 degrees−(⅓)×arcsin(n2/n1). If the inclination angle θ of the inclined surfaces of the prism satisfies the formula depending on the refractive index n1 of the material of the prism and the refractive index n2 of the external medium, light LT having high directionality particularly in a perpendicular direction emitted from the light-emitting device can be reflected from the reflective layer 50 toward the light-emitting device. For example, if the prism has a refractive index n1 of 1.5, and the external medium has a refractive index n2 of 1.0, the inclination angle θ should satisfy approximately 41 degrees<θ<approximately 46 degrees on the basis of the formula. Thus, if the prism on the back side of the glass substrate is exposed to air, light in a perpendicular direction can be efficiently reflected when the prism has an inclination angle θ of more than 41 degrees and less than 46 degrees. In particular, the inclination angle θ may be approximately 45 degrees.

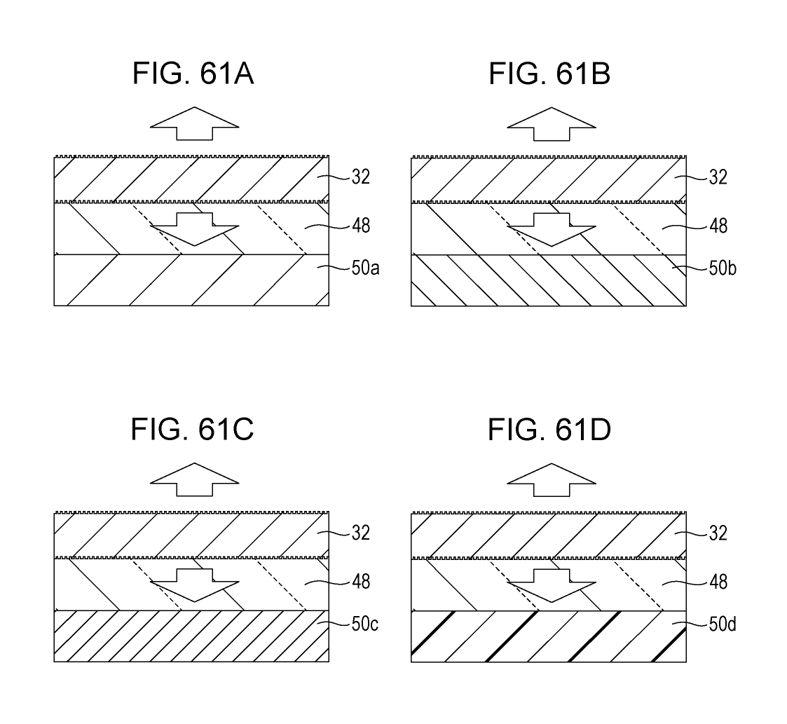

Various embodiments in which the reflective layer 50 has another structure will be described below with reference to FIGS. 61A to 61D.

In FIG. 61A, a reflective metal film 50a is located as a reflective layer on the back side of the photoluminescent layer 32 with a transparent substrate 48 interposed therebetween. The reflective metal film 50a reflects light emitted from the back side of the photoluminescent layer 32. This can increase the amount of light emitted from the front side of the photoluminescent layer 32. The reflective metal film 50a may be formed from a metallic material, such as silver or aluminum, by a film-forming method, such as a vacuum film-forming method or a wet film-forming method. In the presence of the reflective metal film 50a, excitation light may be directed from a side surface of the photoluminescent layer 32 and the transparent substrate 48 or from the front side of the photoluminescent layer 32.

In FIG. 61B, a dielectric multilayer film 50b is located as a reflective layer on the back side of the photoluminescent layer 32 with the transparent substrate 48 interposed therebetween. The dielectric multilayer film 50b reflects light emitted from the back side of the photoluminescent layer 32. This can increase the amount of light emitted from the front side of the photoluminescent layer 32.

The dielectric multilayer film 50b is formed by alternately stacking a dielectric layer having a high refractive index and a dielectric layer having a low refractive index. Light entering the dielectric multilayer film 50b is reflected at each interface of the dielectric layers. When each of the dielectric layers has a thickness of one fourth the wavelength of incident light or reflected light, the phases of light reflected at each interface can be matched, and reflected light can be enhanced.

It is desirable that the material of the dielectric multilayer film 50b have low absorptivity in the wavelength region of light to be reflected. In general, the material of the dielectric multilayer film 50b may be, but is not limited to, an inorganic material, such as titanium oxide, silicon oxide, magnesium fluoride, niobium, or aluminum oxide, or an organic material, such as an acrylic resin, an epoxy resin, or a polyimide resin, or a mixture of the organic material and a refractive index adjusting material. The dielectric multilayer film 50b may be formed by a vacuum film-forming method, such as a vacuum evaporation method, a molecular beam epitaxy (MBE) method, an ion plating method, a sputtering method, a thermal CVD method, or a plasma CVD method, or a wet film-forming method, such as a spin coating method, a slot die coating method, or a bar coating method. The dielectric multilayer film 50b may be formed by another method.

In FIG. 61C, a dichroic mirror 50c is located as a reflective layer on the back side of the photoluminescent layer 32 with the transparent substrate 48 interposed therebetween. The dichroic mirror 50c reflects light emitted from the back side of the photoluminescent layer 32. This can increase the amount of light emitted from the front side of the photoluminescent layer 32.

In the structure illustrated in FIG. 61C, excitation light can enter the back side of the photoluminescent layer 32 through the dichroic mirror 50c. The dichroic mirror 50c can transmit light having a particular wavelength and reflect light having the other wavelengths. Thus, when excitation light enters the photoluminescent layer 32 through the dichroic mirror 50c, the dichroic mirror 50c is configured to selectively transmit the excitation light and reflect light having the other wavelengths. This allows light emitted from the back side of the photoluminescent layer 32 to be appropriately reflected without blocking the entrance of excitation light into the photoluminescent layer 32.

As in the dielectric multilayer film 50b, the dichroic mirror 50c can be composed of a dielectric multilayer film. The dichroic mirror 50c can be formed by alternately stacking two thin films having different refractive indices. The materials of a film having a high refractive index and a film having a low refractive index may be, but are not limited to, titanium oxide, silicon oxide, magnesium fluoride, niobium, or aluminum oxide.

In FIG. 61D, a diffuse reflective layer 50d is located as a reflective layer on the back side of the photoluminescent layer 32 with the transparent substrate 48 interposed therebetween. The diffuse reflective layer 50d reflects light emitted from the back side of the photoluminescent layer 32. This can increase the amount of light emitted from the front side of the photoluminescent layer 32. The diffuse reflective layer 50d may be formed of a mixture of fine particles and a binder for holding the fine particles. The fine particles may be composed of an inorganic material, such as silica or titanium oxide, or an organic material, such as an acrylic resin, a methacrylate resin, or polystyrene. The binder may be a resin. The diffuse reflective layer 50d may be formed of a deposited film, such as barium titanate or zinc oxide. The diffuse reflective layer 50d may be formed of another material.

Although the reflective layer 50a, 50b, 50c, or 50d is located on the back side of the photoluminescent layer 32 with the transparent substrate 48 interposed therebetween in FIGS. 61A to 61D, another structure is also possible. The reflective layer 50a, 50b, 50c, or 50d and the transparent substrate 48 may be formed in an integrated manner. The reflective layer 50a, 50b, 50c, or 50d may be in contact with the back side of the photoluminescent layer 32 without the transparent substrate 48.

As described in [7. Embodiments for Improving Absorption Efficiency of Excitation Light], in the embodiments illustrated in FIGS. 61A to 61D, a prism or lens may be provided on a side of or within the transparent substrate 48, and excitation light may be incident on the back side of the photoluminescent layer 32 in an oblique direction with respect to the photoluminescent layer 32.

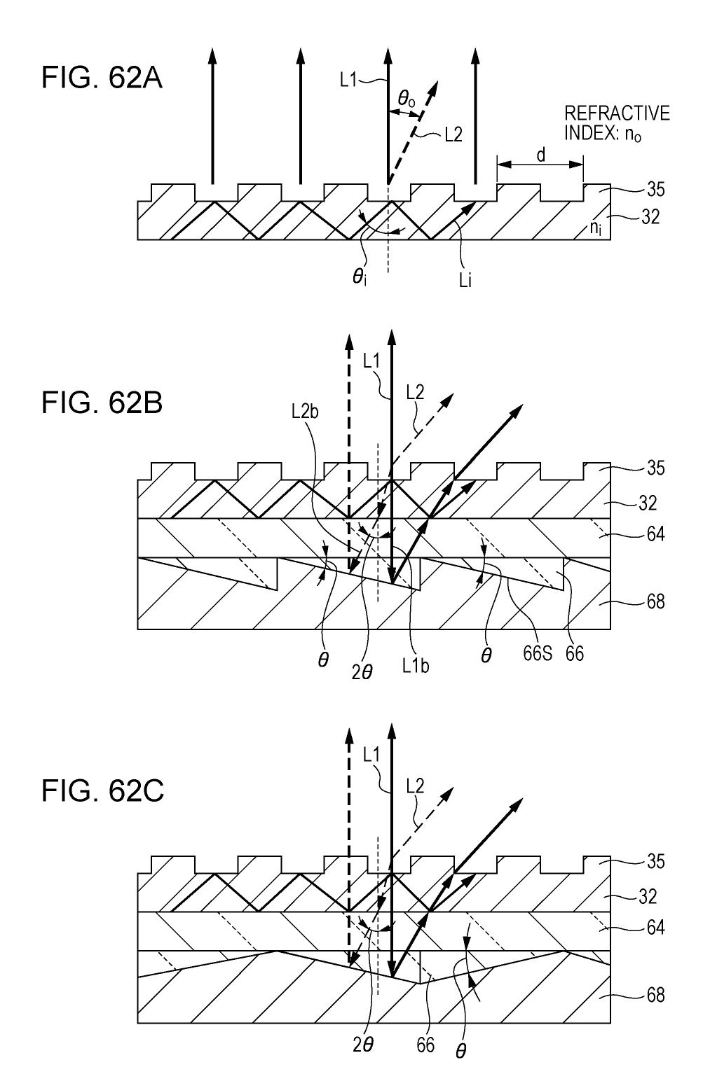

Formation of a reflective layer suitable for the reflection of polychromatic light will be described below with reference to FIGS. 62A to 62C.

FIG. 62A illustrates the difference in output angle between light beams L1 and L2 having different colors (or wavelengths) in a light-emitting device. A periodic structure 35 is located on a photoluminescent layer 32. The photoluminescent layer 32 emits the light beams L1 and L2 having at least two different colors. The light beams L1 and L2 having different colors may be a combination of fluorescence and excitation light.

As illustrated in FIG. 62A, the photoluminescent layer 32 has a refractive index ni, a medium on the light output side has a refractive index no, and the periodic structure has a period d (nm). Light Li propagating through the photoluminescent layer 32 along a periodic structure having a period d has an incident angle (diffraction angle) θi on the interface and an output angle θo on the external medium. The resonance condition is represented by d×ni×sin θi−d×no×sin θo=mλ, wherein m denotes the order, and λ denotes the wavelength of light emitted from the photoluminescent layer 32. This formula shows that if the period d of the periodic structure matches the wavelength λ of emitted light (for example, d×ni×sin θi=mλ), the light beam L1 having a wavelength λ is selectively emitted in the normal direction (θo=0). When the period d matches the wavelength λ, the light beam L2 having another wavelength λ′ is emitted in a direction different from the normal direction.

In this case, light emitted in the normal direction is rich in the light beam L1 having the particular wavelength λ, and light emitted in a given direction different from the front direction is rich in the light beam L2 having the different wavelength λ′. Consequently, the color of light may depend on the output angle on the light-emitting device.

Thus, in the case that polychromatic light is emitted, an inclined surface portion 66 is formed on the back side of the transparent substrate 64, as illustrated in FIG. 62B. The inclined surface portion 66 has an inclined surface 66S at a predetermined inclination angle θ with respect to a surface of the photoluminescent layer 32. The inclined surface 66S functions as a reflective surface, for example, by being provided with a reflective member (for example, a metal film or a dielectric multilayer film) in contact with the inclined surface 66S.

The inclination angle θ of the inclined surface 66S is half the angle 2θ, as illustrated in FIGS. 62B and 62C. More specifically, when the light beam L2 having the different wavelength λ′ is emitted in a direction different from the normal direction due to the periodic structure having the period d, the angle 2θ is the output angle (the output angle on the transparent substrate 64) of the light having the wavelength λ′ emitted toward the back side and refracted at the interface between the photoluminescent layer 32 and the transparent substrate 64.

In this structure, a light beam L1b out of the light beam L1 having the wavelength λ emitted in the normal direction by the action of the periodic structure 35 propagates in the normal direction toward the back side of the photoluminescent layer 32 and is reflected from the inclined surface 66S. Because the inclined surface 66S has the inclination angle θ corresponding to half the angle 20 (the light beam L1b enters the inclined surface 66S at the incident angle θ), the light beam L1b is reflected from the inclined surface 66S at another angle θ.

A light beam L2b out of the light beam L2 having the other wavelength λ′ emitted in a direction different from the normal direction propagates toward the back side of the photoluminescent layer 32, is refracted at the interface between the photoluminescent layer 32 and the transparent substrate 64, propagates toward the inclined surface 66S at an angle 2θ with respect to the normal direction, and reflected from the inclined surface 66S. Because the inclined surface 66S has the inclination angle θ, the light beam L2b is incident on the inclined surface 66S at an incident angle θ. The reflected light deviates by another angle θ and therefore propagates in the normal direction. Consequently, the light beams L1 and L2 having different wavelengths have the same directionality. This can suppress the phenomenon in which light having a particular color is enhanced depending on the output angle.

The inclined surfaces 66S do not necessarily have the serrated cross section, or the adjacent parallel inclined surfaces 66S are not necessarily joined via a vertical surface, as illustrated in FIG. 62B. For example, as illustrated in FIG. 62C, adjacent symmetrical inclined surfaces 66S (having the same inclination angle) may continuously form roofs. The structure having the serrated cross section illustrated in FIG. 62B and the structure having the roofs illustrated in FIG. 62C may be combined.

Thus, the reflective surface can have an inclination angle appropriately determined on the basis of the array pitch of the periodic structure 35 and the angle depending on the emission wavelength, and thereby output light beams having different wavelengths can have the same directionality. Thus, when light beams having multiple colors are emitted to emit white light, homogeneous white light can be emitted at any angle without enhancing a particular color.

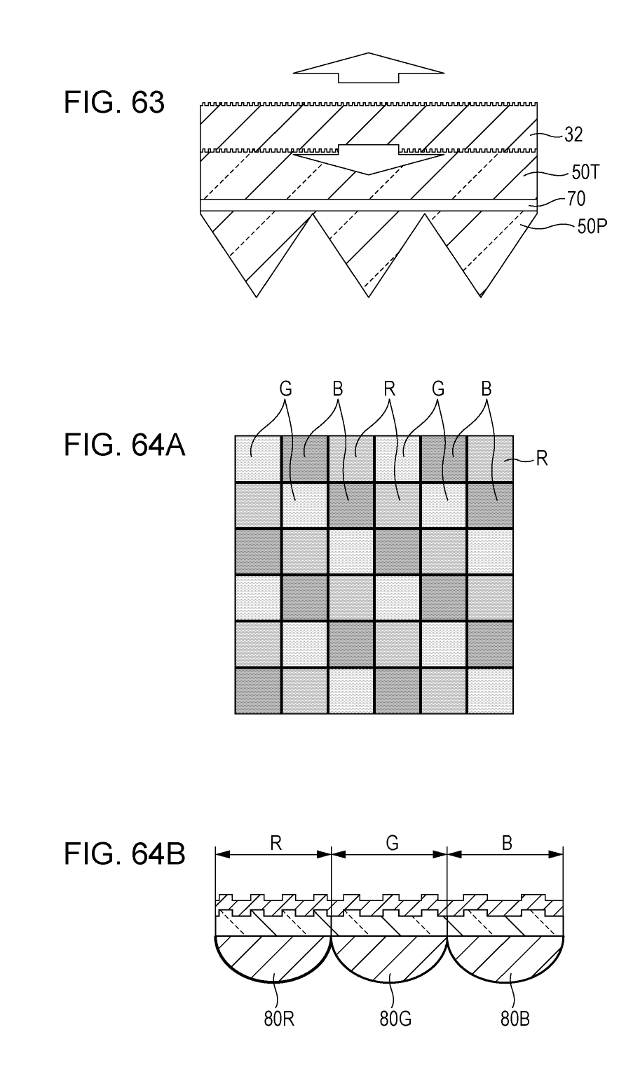

Formation of another reflective layer will be described below with reference to FIG. 63. Like components are denoted by like reference numerals in the embodiment illustrated in FIG. 59 and the following embodiments and may not be further described.

A light-emitting apparatus illustrated in FIG. 63 includes a low-refractive-index layer 70 between a base 50T and a prism 50P of a reflective layer 50. The low-refractive-index layer 70 has a refractive index n3 that is smaller than the refractive index n1 of the reflective layer 50 and may be an air layer.

In the presence of the low-refractive-index layer (air layer) 70, light propagating at a large angle with respect to the direction normal to the photoluminescent layer 32 out of light propagating through the base 50T can be reflected at the interface between the base 50T and the low-refractive-index layer 70. Thus, for example, even light not reflected from an inclined surface 50S of the prism 50P having an inclination angle of 45 degrees (light having a relatively small incident angle with respect to the inclined surface 50S) can be reflected at the interface between the base 50T and the low-refractive-index layer 70 and can be directed to the front side of the photoluminescent layer 32.

The interface between the base 50T and the low-refractive-index layer 70 is typically parallel to a surface of the photoluminescent layer 32. Alternatively, the interface between the base 50T and the low-refractive-index layer 70 may have an inclined surface intersecting a surface of the photoluminescent layer 32 at an angle smaller than the inclination angle θ of the inclined surface 50S of the prism. The low-refractive-index layers 70 may be located between the photoluminescent layer 32 and the prism 50P. If the low-refractive-index layer 70 can transmit excitation light, the excitation light can enter the photoluminescent layer 32 from the back side of the reflective layer 50 through the reflective layer 50 and the low-refractive-index layer 70.

Tiling of RGB light-emitting devices will be described below with reference to FIGS. 64A and 64B. As illustrated in FIG. 64A, light-emitting devices that emit light of red R, green G, and blue B can be closely arranged vertically and horizontally or tiled to emit white light. Light-emitting devices of each color can be provided with the periodic structure as described above to form a quasi-guided mode and can thereby emit directional white light in a predetermined direction. Although light-emitting devices of red R, green G, and blue B are arranged such that the same color is aligned in an oblique direction in the figure, another arrangement is also possible.

As illustrated in FIG. 64B, the light-emitting devices of different colors may have different pitches of the periodic structure. This allows directional light of a desired color to be efficiently emitted. The light-emitting devices may have reflective layers 80R, 80G, and 80B on the back side thereof. The reflective layers 80R, 80G, and 80B may be integral with or separated from their respective light-emitting devices. The reflective layers 80R, 80G, and 80B may have the same convex shape.

Light-emitting apparatuses according to the present disclosure can be applied to various optical devices, such as lighting fixtures, displays, and projectors.

What is claimed is:

1. A light-emitting apparatus comprising:
a photoluminescent layer that has a first surface perpendicular to a thickness direction thereof and emits light in response to excitation light, an area of the first surface being larger than a sectional area of the photoluminescent layer perpendicular to the first surface;
a light-transmissive layer located on the photoluminescent layer; and
a light guide guiding the excitation light to the photoluminescent layer, wherein
at least one of the photoluminescent layer and the light-transmissive layer has a submicron structure having at least projections or recesses arranged perpendicular to the thickness direction of the photoluminescent layer,
the light emitted from the photoluminescent layer includes first light having a wavelength λₐ in air,
at least one of the photoluminescent layer and the light-transmissive layer has a light emitting surface perpendicular to the thickness direction of the photoluminescent layer, the first light being emitted from the light emitting surface,
a distance Dᵢₙₜ between adjacent projections or recesses and a refractive index n_{wav-a} of the photoluminescent layer for the first light satisfy λₐ/n_{wav-a}<Dᵢₙₜ<λₐ, and
a thickness of the photoluminescent layer, the refractive index n_{wav-a}, and the distance Dᵢₙₜ are set to limit a directional angle of the first light emitted from the light emitting surface.

2. The light-emitting apparatus according to claim 1, wherein the light guide is located on a surface of the photoluminescent layer on which the submicron structure is located.

3. The light-emitting apparatus according to claim 1, wherein the light guide is located on a surface of the photoluminescent layer opposite the submicron structure.

4. The light-emitting apparatus according to claim 2, further comprising
a light source for emitting the excitation light toward the light guide,
wherein an incident angle θₛₜ of the excitation light incident on the photoluminescent layer through the light guide and a refractive index nₛₜ of the light guide satisfy nₛₜ sin(θₛₜ)>1.

5. The light-emitting apparatus according to claim 1, further comprising
a transparent substrate for supporting the photoluminescent layer,
wherein the light guide is located on a surface of the transparent substrate opposite the photoluminescent layer.

6. The light-emitting apparatus according to claim 5, further comprising
a light source for emitting the excitation light toward the light guide,
wherein an incident angle θₛₜ of the excitation light incident on the transparent substrate through the light guide and a refractive index nₛₜ of the light guide satisfy nₛₜ sin(θₛₜ)>1.

7. The light-emitting apparatus according to claim 1, wherein the light guide includes at least one prismatic light-transmissive member.

8. The light-emitting apparatus according to claim 1, wherein the light guide includes at least one hemispherical light-transmissive member.

9. The light-emitting apparatus according to claim 1, wherein the light guide includes at least one pyramidal light-transmissive member.

10. The light-emitting apparatus according to claim 1, wherein
the excitation light has a wavelength λₑₓ in air,
the submicron structure is formed such that the first light is most strongly emitted in a direction normal to the photoluminescent layer and such that second light having a wavelength λₑₓ propagating through the photoluminescent layer is most strongly emitted at an angle θₒᵤₜ with respect to the direction normal to the photoluminescent layer, and
the light guide allows the excitation light to enter the photoluminescent layer at an incident angle θₒᵤₜ.

11. The light-emitting apparatus according to claim 1, wherein
the submicron structure has a one-dimensional periodic structure, and
the light guide extends perpendicularly to a line direction of the one-dimensional periodic structure and to a thickness direction of the photoluminescent layer.

12. A light-emitting apparatus comprising:
a photoluminescent layer that has a first surface perpendicular to a thickness direction thereof and emits light in response to excitation light having a wavelength λₑₓ in air, an area of the first surface being larger than a sectional area of the photoluminescent layer perpendicular to the first surface;
a light-transmissive layer located on the photoluminescent layer; and
a light source emitting the excitation light, wherein
at least one of the photoluminescent layer and the light-transmissive layer has a submicron structure having at least projections or recesses arranged perpendicular to the thickness direction of the photoluminescent layer,
the light emitted from the photoluminescent layer includes first light having a wavelength λₐ in air,
at least one of the photoluminescent layer and the light-transmissive layer has a light emitting surface perpendicular to the thickness direction of the photoluminescent layer, the first light being emitted from the light emitting surface,
a distance Dᵢₙₜ between adjacent projections or recesses and a refractive index n_{wav-a} of the photoluminescent layer for the first light satisfy λₐ/n_{wav-a}<Dᵢₙₜ<λₐ,
the submicron structure causes the first light to be most strongly emitted in a direction normal to the photoluminescent layer and causes second light having a wavelength λₑₓ propagating through the photoluminescent layer to be most strongly emitted at an angle θₒᵤₜ with respect to the direction normal to the photoluminescent layer, and
the light source allows the excitation light to enter the photoluminescent layer at an incident angle θₒᵤₜ.

13. A light-emitting apparatus comprising:
a light-transmissive layer having a submicron structure;
a photoluminescent layer that is located on the submicron structure and emits light in response to excitation light; and
a light guide guiding the excitation light to the photoluminescent layer, wherein
the submicron structure includes at least one periodic structure having at least projections or recesses arranged perpendicular to the thickness direction of the photoluminescent layer,
the light emitted from the photoluminescent layer includes first light having a wavelength λₐ in air,
at least one of the photoluminescent layer and the light-transmissive layer has a light emitting surface perpendicular to the thickness direction of the photoluminescent layer, the first light being emitted from the light emitting surface,
a refractive index n_{wav-a} of the photoluminescent layer for the first light and a period pₐ of the at least one periodic structure satisfy λₐ/n_{wav-a}<pₐ<λₐ, and
a thickness of the photoluminescent layer, the refractive index n_{wav-a}, the and the period pₐ are set to limit a directional angle of the first light emitted from light emitting surface.

14. A light-emitting apparatus comprising:
a photoluminescent layer that has a first surface perpendicular to a thickness direction thereof and emits light in response to excitation light;
a light-transmissive layer that has a higher refractive index than the photoluminescent layer and has a submicron structure; and
a light guide guiding the excitation light to the photoluminescent layer, wherein
the submicron structure includes at least one periodic structure having at least projections or recesses arranged perpendicular to the thickness direction of the photoluminescent layer,
the light emitted from the photoluminescent layer includes first light having a wavelength λₐ in air,
at least one of the photoluminescent layer and the light-transmissive layer has a light emitting surface perpendicular to the thickness direction of the photoluminescent layer, the first light being emitted from the light emitting surface,
a refractive index n_{wav-a} of the photoluminescent layer for the first light and a period pₐ of the at least one periodic structure satisfy λₐ/n_{wav-a}<pₐ<λₐ, and
a thickness of the photoluminescent layer, the refractive index n_{wav-a}, and the period pₐ are set to limit a directional angle of the first light emitted from the light emitting surface.

15. The light-emitting apparatus according to claim 1, wherein the photoluminescent layer is in contact with the light-transmissive layer.

16. A light-emitting apparatus comprising:
a photoluminescent layer that has a first surface perpendicular to a thickness direction thereof and emits light in response to excitation light; and
a light guide guiding the excitation light to the photoluminescent layer, wherein
the photoluminescent layer has a submicron structure,
the light emitted from the photoluminescent layer includes first light having a wavelength λₐ in air,
the photoluminescent layer has a light emitting surface perpendicular to the thickness direction of the photoluminescent layer, the first light being emitted from the light emitting surface,
the submicron structure includes at least one periodic structure having at least projections or the recesses arranged perpendicular to the thickness direction of the photoluminescent layer,
a refractive index n_{wav-a} of the photoluminescent layer for the first light and a period pₐ of the at least one periodic structure satisfy λₐ/n_{wav-a}<pₐ<λₐ, and
a thickness of the photoluminescent layer, the refractive index n_{wav-a}, and the period pₐ are set to limit a directional angle of the first light emitted from the light emitting surface.

17. The light-emitting apparatus according to claim 1, wherein the submicron structure has both the projections and the recesses.

18. The light-emitting device according to claim 1, wherein the photoluminescent layer includes a phosphor.

19. The light-emitting device according to claim 1, wherein 380 nm≦λₐ≦780 nm is satisfied.

20. The light-emitting device according to claim 1, wherein the thickness of the photoluminescent layer, the refractive index n_{wav-a}, and the distance Dᵢₙₜ are set to allow an electric field to be formed in the photoluminescent layer, in which antinodes of the electric field are located in areas, the areas each corresponding to respective one of the projections and/or recesses.

21. The light-emitting device according to claim 1, wherein the light-transmissive layer is located indirectly on the photoluminescent layer.

22. The light-emitting device according to claim 1, wherein the thickness of the photoluminescent layer, the refractive index n_{wav-a}, and the distance Dᵢₙₜ are set to allow an electric field to be formed in the photoluminescent layer, in which antinodes of the electric field are located at, or adjacent to, at least the projections or recesses.
